(19) United States
(12) Patent Application Publication
(10) Pub. No.: US 2026/0196729 A1
(43) Pub. Date: Jul. 9, 2026

(54) ANTENNA STRUCTURE AND ELECTRONIC DEVICE THEREOF

(71) Applicant: Huawei Technologies Co., Ltd., Shenzhen (CN)

(72) Inventors: Pengfei Wu, Shanghai (CN); Hanyang Wang, Reading (GB)

(21) Appl. No.: 19/462,390

(22) Filed: Jan. 28, 2026

Related U.S. Application Data
(63) Continuation of application No. PCT/CN2024/115886, filed on Aug. 30, 2024.

(30) Foreign Application Priority Data
Aug. 31, 2023 (CN) 202311129261.9
Aug. 28, 2024 (CN) 202411194733.3

(51) Int. Cl. H01Q 5/40; H01Q 1/22; H01Q 5/20

(52) U.S. Cl. CPC H01Q 5/40; H01Q 1/22; H01Q 5/20

(57) ABSTRACT

This application provides an antenna structure and an electronic device thereof. The antenna structure uses a conductive part of a side frame as a radiator. Feed members are spaced from each other on one side of the radiator, and the antenna structure feeds an electrical signal into the radiator through indirect coupling. The feed member and the radiator are configured to generate a first resonance and a second resonance.

### CROSS-REFERENCE TO RELATED APPLICATIONS

This application is a continuation of International Application No. PCT/CN2024/115886, filed on Aug. 30, 2024, which claims priority to Chinese Patent Application No. 202311129261.9, filed on Aug. 31, 2023, and Chinese Patent Application No. 202411194733.3, filed on Aug. 28, 2024. All of the aforementioned patent applications are hereby incorporated by reference in their entireties.

### TECHNICAL FIELD

This application relates to the field of wireless communication, and in particular, to an antenna structure and an electronic device thereof.

### BACKGROUND

As people have an increasing requirement for high-speed data transmission, a development trend of an industrial design (ID) of an electronic device is to have a large screen-to-body ratio and a plurality of cameras. Consequently, antenna clearance is greatly reduced, and space for layout is increasingly limited.

In this context, frequency bands of a 3rd mobile communication technology (a3G), a 4th mobile communication technology (4G), and a 5th mobile communication technology (5G) will coexist as communication frequency bands of the electronic device for a long time. This leads to an increasing quantity of antennas.

However, a conventional method like increasing a size of a radiator of an antenna to expand an efficiency bandwidth of the antenna has reached a bottleneck. Therefore, when the size of the radiator remains unchanged, it is urgent to improve the efficiency bandwidth of the antenna.

### SUMMARY

This application provides an electronic device, including an antenna. The antenna uses a conductive part of a side frame of the electronic device as a radiator. Feed members are spaced from each other on one side of the radiator, and the antenna feeds an electrical signal into the radiator through indirect coupling. The antenna may generate a first resonance and a second resonance. The antenna uses the two resonances to jointly form a resonance frequency band to expand a bandwidth.

According to a first aspect, an electronic device is provided, including: a ground plane; a first side frame, where the first side frame is at least partially spaced from the ground plane, the first side frame includes a first position and a second position, the first side frame is coupled to the ground plane at the first position and the second position, the first side frame is provided with a first slot between the first position and the second position, and the first slot is located in a central area between the first position and the second position; and an antenna. The antenna includes: a first radiator, where the first radiator includes a conductive part of the first side frame between the first position and the second position; a first feed member, where a first end of the first feed member is an open end, the first radiator and the first feed member are spaced from each other, the first radiator and the first feed member at least partially overlap in a first direction, the first direction is perpendicular to an extension direction of the radiator or perpendicular to an extension direction of the feed member; and a first feed circuit, where the first feed member includes a first feed point, and the first feed circuit is coupled to the first feed point. The first feed member and the first radiator are configured to generate a first resonance and a second resonance, and the first resonance and the second resonance are used to jointly support an operating frequency band of the electronic device.

According to this embodiment of this application, the first radiator may form a radiator structure that conforms to a slot antenna. When the first feed circuit feeds an electrical signal, the antenna may generate the first resonance and the second resonance, to expand an operating bandwidth of the antenna. Both the first resonance and the second resonance may be considered as being generated in a slot CM mode. Because the slot CM mode has higher radiation efficiency and total efficiency, the antenna has better radiation efficiency and total efficiency in the operating frequency band formed by the first resonance and the second resonance.

With reference to the first aspect, in some implementations of the first aspect, at a resonance point of the first resonance, currents on the first radiator are co-directional; and at a resonance point of the second resonance, the currents on the first radiator are co-directional.

With reference to the first aspect, in some implementations of the first aspect, at a resonance point of the first resonance, currents on the first feed member are co-directional; and at a resonance point of the second resonance, the currents on the first feed member are co-directional.

With reference to the first aspect, in some implementations of the first aspect, the first side frame further includes a third position. The first position, the second position, and the third position are sequentially disposed, and the first side frame is provided with a second slot at the third position. The first radiator is a conductive part of the first side frame between the first position and the third position.

With reference to the first aspect, in some implementations of the first aspect, the first radiator is further configured to generate a third resonance. At a resonance point of the third resonance, currents on first radiators on two sides of the first slot are reverse in direction.

With reference to the first aspect, in some implementations of the first aspect, a second end of the first feed member is an open end.

With reference to the first aspect, in some implementations of the first aspect, the second end of the first feed member is grounded through a capacitive component.

With reference to the first aspect, in some implementations of the first aspect, the first feed member further includes a ground point, the ground point is coupled to the ground plane, and lengths of first feed member on two sides of the ground point are different.

With reference to the first aspect, in some implementations of the first aspect, the electronic device includes: a first housing and a second housing, where the first housing includes the first side frame, the second housing includes a second side frame, the second side frame is at least partially spaced from the ground plane, the second side frame includes a third position and a fourth position, and the second side frame is provided with a second slot and a third slot respectively at the third position and the fourth position; and a first rotating shaft, where the first rotating shaft is located between the first housing and the second housing, and the first rotating shaft is rotatably connected to the first housing and the second housing separately. The antenna includes: a second radiator, where the second radiator is a conductive part of the second side frame between the third position and the fourth position; a second feed member, where a first end and a second end of the second feed member are ground ends, the second radiator and the second feed member are spaced from each other, and the second radiator and the second feed member at least partially overlap in a second direction, where the second direction is a direction perpendicular to an extension direction of the second radiator; and a second feed circuit, where the second feed member includes a second feed point, and the second feed circuit is coupled to the second feed point. The second radiator is configured to generate a third resonance and a fourth resonance, and the third resonance and the fourth resonance are used to jointly support an operating frequency band of the electronic device.

With reference to the first aspect, in some implementations of the first aspect, the electronic device includes: a first housing and a second housing, where the first housing includes the first side frame, the second housing includes a second side frame, the second side frame is at least partially spaced from the ground plane, the second side frame includes a third position and a fourth position, and the second side frame is coupled to the ground plane at the third position and the fourth position; and a first rotating shaft, where the first rotating shaft is located between the first housing and the second housing, and the first rotating shaft is rotatably connected to the first housing and the second housing separately. The antenna includes: a second radiator, where a first end and a second end of the second radiator are open ends; a second feed member, where the second feed member is a conductive part of the second side frame between the third position and the fourth position, the second radiator and the second feed member are spaced from each other, the second radiator and the second feed member at least partially overlap in a second direction, and the second direction is a direction perpendicular to an extension direction of the second radiator; and a second feed circuit, where the second feed member includes a second feed point, and the second feed circuit is coupled to the second feed point. The second radiator is configured to generate a third resonance and a fourth resonance, and the third resonance and the fourth resonance are used to jointly support an operating frequency band of the electronic device.

With reference to the first aspect, in some implementations of the first aspect, the antenna includes a second feed member and a second feed circuit. The second feed member, the first feed member, and the first radiator are spaced from each other. The first end and a second end of the first feed member are open ends, and a first end and a second end of the second feed member are ground ends. The second feed member includes a second feed point, and the second feed circuit is coupled to the second feed point. The first radiator is configured to generate a third resonance and a fourth resonance, and the third resonance and the fourth resonance are used to jointly support an operating frequency band of the electronic device.

With reference to the first aspect, in some implementations of the first aspect, a second end of the first feed member is an open end, and a physical length L1 of the first radiator and a physical length L2 of the first feed member satisfy: L1×70%≤L2≤L1×130%.

With reference to the first aspect, in some implementations of the first aspect, a second end of the first feed member is a ground end, and a physical length L1 of the first radiator and a physical length L2 of the first feed member satisfy: L1×35%≤L2≤L1×65%.

With reference to the first aspect, in some implementations of the first aspect, a distance D between the first feed member and the first radiator is less than or equal to 5 mm.

With reference to the first aspect, in some implementations of the first aspect, the electronic device further includes a bracket, a rear cover, and a printed circuit board PCB, where at least a part of the bracket is located between the rear cover and the PCB; and the feed member is disposed on a surface of the bracket.

According to a second aspect, an electronic device is provided, including: a ground plane; a first side frame, where at least a part of the first side frame and the ground plane are spaced from each other, the first side frame includes a ground point, a first position, and a second position, the first side frame is provided with a first slot and a second slot respectively at the first position and the second position, the ground point is located in a central area between the first position and the second position, and the first side frame is coupled to the ground plane at the ground point; and an antenna. The antenna includes: a first radiator, where the first radiator includes a conductive part of the first side frame between the first position and the second position; a first feed member, where a first end of the first feed member is a ground end, the first radiator and the first feed member are spaced from each other, and the first radiator and the first feed member at least partially overlap in a first direction, where the first direction is a direction perpendicular to an extension direction of the first radiator; and a first feed circuit, where the first feed member includes a first feed point, and the first feed circuit is coupled to the first feed point. The first feed member and the first radiator are configured to generate a first resonance and a second resonance, and the first resonance and the second resonance are used to jointly support an operating frequency band of the electronic device.

According to this embodiment of this application, the first radiator may form a radiator structure that conforms to a wire antenna. When the first feed circuit feeds an electrical signal, the antenna may generate the first resonance and the second resonance, to expand an operating bandwidth of the antenna. Both the first resonance and the second resonance may be considered as being generated in a wire CM mode. Because the wire CM mode has higher radiation efficiency and total efficiency, the antenna has better radiation efficiency and total efficiency in the operating frequency band formed by the first resonance and the second resonance.

With reference to the second aspect, in some implementations of the second aspect, at a resonance point of the first resonance, currents on first radiators on two sides of the ground point are reverse in direction; and at a resonance point of the second resonance, the currents on the first radiators on the two sides of the ground point are reverse in direction.

With reference to the second aspect, in some implementations of the second aspect, at a resonance point of the first resonance, currents on two sides of a center of the first feed member are reverse in direction; and at a resonance point of the second resonance, the currents on the two sides of the center of the first feed member are reverse in direction.

With reference to the second aspect, in some implementations of the second aspect, the first side frame further includes a third position. The first position, the second position, and the third position are sequentially disposed, and the first side frame coupled to the ground plane at the third position. The first radiator is a conductive part of the first side frame between the first position and the third position.

With reference to the second aspect, in some implementations of the second aspect, the first radiator is further configured to generate a third resonance. At a resonance point of the third resonance, currents on the first radiator are reverse in direction.

With reference to the second aspect, in some implementations of the second aspect, a second end of the first feed member is a ground end.

With reference to the second aspect, in some implementations of the second aspect, the second end of the first feed member is physically grounded or grounded through an inductive component.

With reference to the second aspect, in some implementations of the second aspect, the electronic device includes: a first housing and a second housing, where the first housing includes the first side frame, the second housing includes a second side frame, at least a part of the second side frame and the ground plane are spaced from each other, the second side frame includes a third position and a fourth position, the second side frame is coupled to the ground plane at the third position and the fourth position, the second side frame is provided with a third slot between the first position and the second position, and the third slot is located in the central area between the first position and the second position; and a first rotating shaft, where the first rotating shaft is located between the first housing and the second housing, and the first rotating shaft is rotatably connected to the first housing and the second housing separately. The antenna includes: a second radiator, where the second radiator is a conductive part of the second side frame between the third position and the fourth position; a second feed member, where a first end and a second end of the second feed member are open ends, the second radiator and the second feed member are spaced from each other, and the second radiator and the second feed member at least partially overlap in a second direction, where the second direction is a direction perpendicular to an extension direction of the second radiator; and a second feed circuit, where the second feed member includes a second feed point, and the second feed circuit is coupled to the second feed point. The second radiator is configured to generate a third resonance and a fourth resonance, and the third resonance and the fourth resonance are used to jointly support an operating frequency band of the electronic device.

With reference to the second aspect, in some implementations of the second aspect, the electronic device includes: a first housing and a second housing, where the first housing includes the first side frame, the second housing includes a second side frame, at least a part of the second side frame and the ground plane are spaced from each other, the second side frame includes a third position and a fourth position, and the second side frame is provided with a third slot and a fourth slot respectively at the third position and the fourth position; and a first rotating shaft, where the first rotating shaft is located between the first housing and the second housing, and the first rotating shaft is rotatably connected to the first housing and the second housing separately. The antenna includes: a second radiator, where a first end and a second end of the second radiator are ground ends; a second feed member, where the second feed member is a conductive part of the second side frame between the third position and the fourth position, the second radiator and the second feed member are spaced from each other, and the second radiator and the second feed member at least partially overlap in a second direction, where the second direction is a direction perpendicular to an extension direction of the second radiator; and a second feed circuit, where the second feed member includes a second feed point, and the second feed circuit is coupled to the second feed point. The second radiator is configured to generate a third resonance and a fourth resonance, and the third resonance and the fourth resonance are used to jointly support an operating frequency band of the electronic device.

With reference to the second aspect, in some implementations of the second aspect, the antenna includes a second feed member and a second feed circuit. The second feed member, the first feed member, and the first radiator are spaced from each other. The first end and a second end of the first feed member are ground ends, and a first end and a second end of the second feed member are open ends. The second feed member includes a second feed point, and the second feed circuit is coupled to the second feed point. The first radiator is configured to generate a third resonance and a fourth resonance, and the third resonance and the fourth resonance are used to jointly support an operating frequency band of the electronic device.

With reference to the second aspect, in some implementations of the second aspect, a second end of the first feed member is a ground end, and a physical length L1 of the first radiator and a physical length L2 of the first feed member satisfy: L1×70%≤L2≤L1×130%.

With reference to the second aspect, in some implementations of the second aspect, a second end of the first feed member is an open end, and a physical length L1 of the first radiator and a physical length L2 of the first feed member satisfy: L1×35%≤L2≤L1×65%.

With reference to the second aspect, in some implementations of the second aspect, a distance D between the first feed member and the first radiator is less than or equal to 5 mm.

With reference to the second aspect, in some implementations of the second aspect, the electronic device further includes a bracket, a rear cover, and a printed circuit board PCB, where at least a part of the bracket is located between the rear cover and the PCB; and the feed member is disposed on a surface of the bracket.

### BRIEF DESCRIPTION OF THE DRAWINGS

FIG. 1 is a diagram of an electronic device 10 according to an embodiment of this application;

FIG. 2 shows diagrams of a structure in a common mode of an antenna and distribution of corresponding currents and electric fields according to this application;

FIG. 3 shows diagrams of a structure in a differential mode of an antenna and distribution of corresponding currents and electric fields according to this application;

FIG. 4 shows diagrams of a structure in a common mode of an antenna and distribution of corresponding currents, electric fields, and magnetic currents according to this application;

FIG. 5 shows diagrams of a structure in a differential mode of an antenna and distribution of corresponding currents, electric fields, and magnetic currents according to this application;

FIG. 6 is a diagram of an electronic device 10 according to an embodiment of this application;

FIG. 7 shows a simulation result of an S parameter of an antenna 100 in the electronic device 10 shown in FIG. 6;

FIG. 8 shows simulation results of total efficiency and radiation efficiency of an antenna 100 in the electronic device 10 shown in FIG. 6;

FIG. 9 is a diagram of another electronic device 10 according to an embodiment of this application;

FIG. 10 is a partial cross-sectional view of an electronic device 10 in a first direction according to an embodiment of this application;

FIG. 11 shows a simulation result of an S parameter of an antenna 200 in the electronic device 10 shown in FIG. 9;

FIG. 12 shows simulation results of total efficiency and radiation efficiency of an antenna 200 in the electronic device 10 shown in FIG. 9;

FIG. 13 is a diagram of current distribution of an antenna shown in FIG. 9 at a resonance point (1.87 GHz) of a first resonance;

FIG. 14 is a diagram of current distribution of an antenna shown in FIG. 9 at a resonance point (2.23 GHz) of a second resonance;

FIG. 15 is a diagram of current distribution of an antenna shown in FIG. 9 at 3.19 GHz;

FIG. 16 is a diagram of electric field distribution of an antenna shown in FIG. 9 at a resonance point (1.87 GHz) of a first resonance;

FIG. 17 is a diagram of electric field distribution of an antenna shown in FIG. 9 at a resonance point (2.23 GHz) of a second resonance;

FIG. 18 is a diagram of electric field distribution of an antenna shown in FIG. 9 at 3.19 GHz;

FIG. 19 is a diagram of another electronic device 10 according to an embodiment of this application;

FIG. 20 shows simulation results of an S parameter of an antenna 200 in the electronic device 10 shown in FIG. 19 in different cases;

FIG. 21 shows simulation results of total efficiency and radiation efficiency of an antenna 200 in the electronic device 10 shown in FIG. 19 in different cases;

FIG. 22 shows simulation results of an S parameter of an antenna in the electronic device 10 shown in FIG. 19 when a feed member is disposed at different positions;

FIG. 23 shows simulation results of total efficiency and radiation efficiency of an antenna in the electronic device 10 shown in FIG. 19 when a feed member is disposed at different positions;

FIG. 24 is a diagram of another electronic device 10 according to an embodiment of this application;

FIG. 25 shows a simulation result of an S parameter of an antenna 200 in the electronic device 10 shown in FIG. 24;

FIG. 26 shows simulation results of total efficiency and radiation efficiency of an antenna 200 in the electronic device 10 shown in FIG. 24;

FIG. 27 is a diagram of another electronic device 10 according to an embodiment of this application;

FIG. 28 shows a simulation result of an S parameter of an antenna 200 in the electronic device 10 shown in FIG. 27;

FIG. 29 shows simulation results of total efficiency and radiation efficiency of an antenna 200 in the electronic device 10 shown in FIG. 27;

FIG. 30 is a diagram of another electronic device 10 according to an embodiment of this application;

FIG. 31 shows a simulation result of an S parameter of an antenna 200 in the electronic device 10 shown in FIG. 9;

FIG. 32 shows simulation results of total efficiency and radiation efficiency of an antenna 200 in the electronic device 10 shown in FIG. 30;

FIG. 33 is a diagram of current distribution of an antenna shown in FIG. 30 at a resonance point (2.12 GHz) of a first resonance;

FIG. 34 is a diagram of current distribution of an antenna shown in FIG. 30 at a resonance point (2.45 GHz) of a second resonance;

FIG. 35 is a diagram of current distribution of an antenna shown in FIG. 30 at a resonance point (3.43 GHz) of a third resonance;

FIG. 36 is a diagram of current distribution of an antenna shown in FIG. 30 at a resonance point (3.54 GHz) of a fourth resonance;

FIG. 37 is a diagram of electric field distribution of an antenna shown in FIG. 30 at a resonance point (2.12 GHz) of a first resonance;

FIG. 38 is a diagram of electric field distribution of an antenna shown in FIG. 30 at a resonance point (2.45 GHz) of a second resonance;

FIG. 39 is a diagram of electric field distribution of an antenna shown in FIG. 30 at a resonance point (3.43 GHz) of a third resonance.

FIG. 40 is a diagram of electric field distribution of an antenna shown in FIG. 30 at a resonance point (3.54 GHz) of a fourth resonance.

FIG. 41 is a diagram of another electronic device 10 according to an embodiment of this application;

FIG. 42 shows a simulation result of an S parameter of an antenna 200 in the electronic device 10 shown in FIG. 41;

FIG. 43 shows simulation results of total efficiency and radiation efficiency of an antenna 200 in the electronic device 10 shown in FIG. 41;

FIG. 44 is a diagram of current distribution of an antenna shown in FIG. 41 at a resonance point (1.79 GHz) of a first resonance;

FIG. 45 is a diagram of current distribution of an antenna shown in FIG. 30 at a resonance point (2.01 GHz) of a second resonance;

FIG. 46 is a diagram of current distribution of an antenna shown in FIG. 30 at a resonance point (2.24 GHz) of a fifth resonance;

FIG. 47 is a diagram of another electronic device 10 according to an embodiment of this application;

FIG. 48 is a diagram of an electronic device 10 according to an embodiment of this application;

FIG. 49 is a diagram of an electronic device 10 according to an embodiment of this application;

FIG. 50 shows a simulation result of an S parameter of an antenna 200 in the electronic device 10 shown in FIG. 49;

FIG. 51 shows simulation results of total efficiency and radiation efficiency of an antenna 200 in the electronic device 10 shown in FIG. 49;

FIG. 52 is a diagram of another electronic device 10 according to an embodiment of this application;

FIG. 53 shows a simulation result of an S parameter of an antenna 200 in the electronic device 10 shown in FIG. 52;

FIG. 54 shows simulation results of total efficiency and radiation efficiency of an antenna 200 in the electronic device 10 shown in FIG. 52;

FIG. 55 is a diagram of current distribution of an antenna shown in FIG. 52 at a resonance point (1.88 GHz) of a first resonance;

FIG. 56 is a diagram of current distribution of an antenna shown in FIG. 52 at a resonance point (2.16 GHz) of a second resonance;

FIG. 57 is a diagram of an electronic device 10 according to an embodiment of this application;

FIG. 58 is a diagram of another electronic device 10 according to an embodiment of this application;

FIG. 59 shows a simulation result of an S parameter of an antenna 200 in the electronic device 10 shown in FIG. 58;

FIG. 60 shows simulation results of total efficiency and radiation efficiency of an antenna 200 in the electronic device 10 shown in FIG. 58;

FIG. 61(a) to FIG. 61(c) are a diagram of an electronic device 10 according to an embodiment of this application;

FIG. 62 is a diagram of another electronic device 10 according to an embodiment of this application;

FIG. 63 is a diagram of an electronic device 10 according to an embodiment of this application;

FIG. 64 shows a simulation result of an S parameter of an antenna 200 in the electronic device 10 shown in FIG. 62;

FIG. 65 shows simulation results of total efficiency and radiation efficiency of an antenna 200 in the electronic device 10 shown in FIG. 62;

FIG. 66 is a diagram of an electronic device 10 according to an embodiment of this application;

FIG. 67 is a diagram of an electronic device 10 according to an embodiment of this application;

FIG. 68 shows a simulation result of an S parameter of an antenna 200 in the electronic device 10 shown in FIG. 67;

FIG. 69 shows simulation results of total efficiency and radiation efficiency of an antenna 200 in the electronic device 10 shown in FIG. 67;

FIG. 70 shows a simulation result of an S parameter of an antenna 200 in the electronic device 10 shown in FIG. 67;

FIG. 71 shows simulation results of total efficiency and radiation efficiency of an antenna 200 in the electronic device 10 shown in FIG. 67;

FIG. 72 is a diagram of an electronic device 10 according to an embodiment of this application;

FIG. 73 shows a simulation result of an S parameter of an antenna 200 in the electronic device 10 shown in FIG. 72;

FIG. 74 shows simulation results of total efficiency and radiation efficiency of an antenna 200 in the electronic device 10 shown in FIG. 72;

FIG. 75 is a diagram of an electronic device 10 according to an embodiment of this application;

FIG. 76 is a diagram of an electronic device 10 according to an embodiment of this application;

FIG. 77 is a diagram of an electronic device 10 according to an embodiment of this application;

FIG. 78 shows a simulation result of an S parameter of an antenna 200 when the electronic device 10 shown in FIG. 76 is in an unfolded state;

FIG. 79 shows a simulation result of an S parameter of an antenna 200 when the electronic device 10 shown in FIG. 76 is in a folded state;

FIG. 80 shows simulation results of total efficiency and radiation efficiency of an antenna 200 when the electronic device 10 shown in FIG. 76 is in an unfolded state;

FIG. 81 shows simulation results of total efficiency and radiation efficiency of an antenna 200 when the electronic device 10 shown in FIG. 76 is in a folded state;

FIG. 82 is a diagram of an electronic device 10 according to an embodiment of this application;

FIG. 83 shows a simulation result of an S parameter of an antenna 200 when the electronic device 10 shown in FIG. 82 is in an unfolded state;

FIG. 84 shows a simulation result of an S parameter of an antenna 200 when the electronic device 10 shown in FIG. 82 is in a folded state;

FIG. 85 shows simulation results of total efficiency and radiation efficiency of an antenna 200 when the electronic device 10 shown in FIG. 82 is in an unfolded state;

FIG. 86 shows simulation results of total efficiency and radiation efficiency of an antenna 200 when the electronic device 10 shown in FIG. 82 is in a folded state;

FIG. 87(a) and FIG. 87(b) show a simulation result of a directivity of an antenna 200 when the electronic device 10 shown in FIG. 82 is in an unfolded state;

FIG. 88 is a diagram of an electronic device 10 according to an embodiment of this application;

FIG. 89 is a diagram of an electronic device 10 according to an embodiment of this application;

FIG. 90(a) to FIG. 90(c) are a diagram of an electronic device 10 according to an embodiment of this application; and

FIG. 91 is a diagram of an electronic device 10 according to an embodiment of this application.

### DETAILED DESCRIPTION OF ILLUSTRATIVE EMBODIMENTS

The following describes technical solutions of this application with reference to accompanying drawings.

It should be understood that the term “and/or” used in this specification describes only a same field for describing associated objects, and indicates that three relationships may exist. For example, A and/or B may indicate the following three cases: Only A exists, both A and B exist, and only B exists. In addition, the character “/” in this specification generally indicates an “or” relationship between the associated objects.

In this application, “within a range of . . . ” is used, except when it is separately specified that no end value is included, end values at both ends of the range are included by default. For example, within a range from 1 to 5, two values 1 and 5 are included.

Coupling: The coupling may be understood as direct coupling and/or indirect coupling, and a “coupling connection” may be understood as a direct coupling connection and/or an indirect coupling connection. The direct coupling may also be referred to as an “electrical connection”, and may be understood as physical contact and electrical conduction of components; or may be understood as a form in which different components in a line structure are connected through a physical line that may transmit an electrical signal, for example, a copper foil or a conductive wire of a printed circuit board (PCB). The “indirect coupling” may be understood as electrical conduction of two conductors through air or without contact. In an embodiment, the indirect coupling may also be referred to as capacitive coupling. For example, signal transmission is implemented by forming an equivalent capacitor through coupling in a gap between two spaced conductive members.

Element/component: The element/component includes at least one of a lumped element/component, and a distributed element/component.

Lumped element/component: The lumped element/component is a general name of all elements whose sizes are far less than a wavelength corresponding to an operating frequency of a circuit. For a signal, a characteristic of the element is always constant at any time, regardless of a frequency.

Distributed element/component: A difference between the distributed element and the lumped element lies in that if a size of an element is close to or greater than a wavelength corresponding to an operating frequency of a circuit, a characteristic of each point of the element varies with a signal when the signal passes through the element. In this case, the element cannot be considered as a single body with a constant characteristic, but should be referred to as a distributed element.

Capacitor: The capacitor may be understood as a lumped capacitor and/or a distributed capacitor. The lumped capacitor is a capacitive component, for example, a capacitive element. The distributed capacitor (or a distributed type capacitor) is an equivalent capacitor including two conductive members that are spaced from each other by a specific gap.

Inductor: The inductor may be understood as a lumped inductor and/or a distributed inductor. The lumped inductor is an inductive component, for example, an inductive element. The distributed inductor (or distributed type inductor) is an equivalent inductor including a conductive member with a specific length.

Inductive component: The inductive component may be understood as a combination of one or more inductors, or a combination of one or more inductors and one or more capacitors, or may further include a combination of another component (for example, a resistor). The inductive component should be integrally inductive.

Capacitive component: The capacitive component may be understood as a combination of one or more capacitors, or a combination of one or more capacitors and one or more inductors, or may further include a combination of another component (for example, a resistor). The capacitive component should be integrally capacitive.

Radiator: The radiator is an apparatus configured to receive/send electromagnetic wave radiation in an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator via a feed line. The radiator converts the energy into specific polarized electromagnetic wave energy and radiates the energy in a required direction. A receive radiator converts specific polarized electromagnetic wave energy from a specific direction of space into modulated high-frequency current energy, and transmits the modulated high-frequency current energy to an input end of a receiver through a feed line.

The radiator may include a conductor with a specific shape and size, for example, a linear radiator or a sheet-like radiator. A specific shape is not limited in this application. In an embodiment, the linear radiator may be referred to as a wire antenna for short. In an embodiment, the linear radiator may be implemented by a conductive side frame, and may also be referred to as a side frame antenna. In an embodiment, the linear radiator may be implemented by a bracketed conductor, and may also be referred to as a bracketed antenna. In an embodiment, a wire diameter (for example, including a thickness and a width) of the linear radiator or a radiator of a wire antenna is much less than a wavelength (for example, a dielectric wavelength) (for example, is less than 1/16 of the wavelength), and a length may be compared with the wavelength (for example, the dielectric wavelength) (for example, the length is approximately ⅛ of the wavelength, or ⅛ to ¼ of the wavelength, or ¼ to ½ of the wavelength, or greater). Main forms of the wire antenna include a dipole antenna, a half-wave dipole antenna, a monopole antenna, a loop antenna, and an inverted F antenna (also referred to as an IFA, Inverted F Antenna). For example, for the dipole antenna, each dipole antenna usually includes two radiation stubs, and each stub is fed by a feed part from a feed end of the radiation stub. For example, the inverted F antenna (IFA) may be considered as being obtained by adding a ground path to a monopole antenna. The IFA antenna has a feed point and a ground point. A side view of the IFA antenna is inverted F-shaped, and therefore, the IFA antenna is referred to an inverted F antenna. In an embodiment, a sheet-like radiator may include a microstrip disk antenna, or a patch antenna, for example, a planar inverted F antenna (also referred to as a PIFA, Planar Inverted F Antenna). In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. A shape of the sheet-like radiator includes a circular shape, a rectangular shape, a ring shape, and the like. A specific shape is not limited in this application. A structure of the microstrip disk antenna generally includes a dielectric substrate, a radiator, and a ground plane, where the dielectric substrate is disposed between the radiator and the ground plane.

The radiator may also include a slot or a slit formed on a conductor, for example, a closed or semi-closed slot or slit formed on a grounded conductor surface. In an embodiment, a radiator with a slot or a slit may be referred to as a slot antenna or a slotted antenna for short. In an embodiment, a radial size (for example, including a width) of the slot or slit of the slot antenna/slotted antenna is much less than a wavelength (for example, a dielectric wavelength) (for example, is less than 1/16 of the wavelength), and a length size may be compared with the wavelength (for example, the dielectric wavelength) (for example, the length is approximately ⅛ of the wavelength, or ⅛ to ¼ of the wavelength, or ¼ to ½ of the wavelength, or greater). In an embodiment, a radiator having a closed slot or slit may be referred to as a closed slot antenna for short. In an embodiment, a radiator having a semi-closed slot or slit (for example, an opening is additionally provided on the closed slot or slit) may be referred to as an open slot antenna for short. In some embodiments, the slit is long-bar-shaped. In some embodiments, a length of the slit is approximately half a wavelength (for example, the dielectric wavelength). In some embodiments, a length of the slit is approximately an integer multiple of a wavelength (for example, a one-fold dielectric wavelength). In some embodiments, the slit may be used for feeding through a transmission line bridged on one side or two sides of the slit. In this way, a radio frequency electromagnetic field is excited on the slit, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced from the ground plane and is grounded at two ends of the radiator, to form a closed or semi-closed slot or slit. In an embodiment, the radiator of the slot antenna or the slotted antenna may be implemented by a bracketed conductor that is grounded at both ends, and may also be referred to as a bracketed antenna.

A feed circuit is a combination of all circuits configured to: receive and transmit radio frequency signals. The feed circuit may include a transceiver and a radio frequency front end circuit (RF front end). In some cases, in a narrow sense, the “feed circuit” is a radio frequency integrated circuit (RFIC), and the RFIC may be considered to include a radio frequency front end chip and the transceiver. The feed circuit has a function of converting a radio wave (for example, a radio frequency signal) and an electrical signal (for example, a digital signal). Generally, the feed circuit is considered as a part of radio frequency.

In some embodiments, an electronic device may further include a test base (which is also referred to as a radio frequency base or a radio frequency test base). A coaxial cable may be inserted into the test base, to test a characteristic of the radio frequency front end circuit or the radiator of the antenna through the cable. The radio frequency front end circuit may be considered as a circuit part coupled between the test base and the transceiver.

In some embodiments, the radio frequency front end circuit may be integrated into the radio frequency front end chip of the electronic device, or the radio frequency front end circuit and the transceiver may be integrated into the radio frequency integrated circuit of the electronic device.

It should be understood that any two of a first feed circuit, a second feed circuit, . . . , and an N^{th} feed circuit in this application may share a same transceiver, for example, transmit a signal through a radio frequency channel in the transceiver (for example, a pin of the radio frequency integrated circuit); and may further share a radio frequency front end circuit, for example, process the signal via a switch or an amplifier in the radio frequency front end.

It should be further understood that two of the first feed circuit, the second feed circuit, . . . , and the N^{th} feed circuit in this application usually correspond to two radio frequency test bases of the electronic device.

A matching circuit is a circuit configured to adjust a radiation characteristic of the antenna. In an embodiment, the matching circuit is coupled between the feed circuit and a corresponding radiator. In an embodiment, the matching circuit is coupled between the test base and the radiator. Generally, the matching circuit is a combination of circuits coupled between the radiator and the ground plane. In an embodiment, the matching circuit may include a switch and/or an electronic element. The switch may be an electronic element configured to switch a coupling connection of the radiator. The matching circuit has a function of impedance matching and/or frequency tuning. Generally, the matching circuit is considered as a part of the antenna.

Ground structure/feed structure: The ground structure/feed structure may include a connection member, for example, a metal spring. The radiator is coupled to the ground plane through the ground structure/coupled to the feed circuit through the feed structure. In some embodiments, the feed structure may include a transmission line/feed line, and the ground structure may include a ground cable.

End/point: The “end/point” in a first end/second end/feed end/ground end/feed point/ground point/connection point of a radiator of antenna cannot be understood in a narrow sense as an endpoint or an end part that is physically disconnected from another radiator, and may also be considered as a point or a section on a continuous radiator. In an embodiment, the “end/point” may include a connection/coupling area that is on the radiator of the antenna and that is coupled to another conductive structure. For example, the feed end/feed point may be a coupling area that is on the radiator of the antenna and that is coupled to a feed structure (for example, an area opposite to a part of the feed structure). For another example, the ground end/ground point may be a connection/coupling area that is on the radiator of the antenna and that is coupled to the ground structure.

Open end and closed end: In some embodiments, the open end and the closed end are defined based on whether the open end and the closed end are grounded, for example, the closed end is grounded, and the open end is not grounded. In an embodiment, the open end may also be referred to as a floating end, a free end, an opening end or an open-circuit end. In an embodiment, the closed end may also be referred to as a ground end or a short-circuit end. It should be understood that, in some embodiments, another conductor may be connected through the open end, to transfer coupling energy (which may be understood as transferring a current).

In some embodiments, the open end and the closed end are defined based on another conductor, for example, the closed end is electrically connected to the another conductor, and the open end is not electrically connected to the another conductor.

Simply, an “open end” of the radiator may be understood as follows: If one end of the radiator is spaced from the ground plane or is coupled to the ground plane through a capacitive component, the one end may be considered as the open end of the radiator.

Simply, a “ground end” of the radiator may be understood as follows: If one end of the radiator is directly connected to the ground plane or is coupled to the ground plane through an inductive component, the one end may be considered as the ground end of the radiator.

In some embodiments, the “closed end” may also be understood from a perspective of current distribution. The closed end, the ground end, or the like may be understood as a current strong point on a radiator, or may be understood as an electric field weak point on a radiator. In an embodiment, the closed end is coupled to an electronic component (for example, an inductive component), so that a current distribution characteristic of the current strong point/electric field weak point on the radiator may not be changed. In an embodiment, a slit (for example, a slot filled with an insulation material) at or near the closed end may not change a current distribution characteristic of the current strong point/electric field weak point on the radiator.

In some embodiments, the “open end” may also be understood from a perspective of current distribution. The open end, the floating end, or the like may be understood as a current weak point on a radiator, or may be understood as an electric field strong point on a radiator. In an embodiment, the open end is coupled to an electronic component (for example, a capacitive component), so that a current distribution characteristic of the current weak point/electric field strong point on the radiator may not be changed.

It should be understood that a radiator end (similar to a radiator at an opening of the open end or the floating end from a perspective of a radiator structure) in a slot is coupled to the electronic component (for example, a capacitor or an inductor), so that the radiator end is a current strong point/an electric field weak point. In this case, it should be understood that the radiator end in the slot is actually a closed end, a ground end, or the like.

A “floating radiator” in embodiments of this application means that the radiator is not directly connected to a feed line/feed stub and/or a ground cable/ground stub, but is fed and/or grounded through indirect coupling.

It should be understood that “floating” in the “floating end” and the “floating radiator” does not mean that there is no structure around the radiator to support the radiator. In an embodiment, the floating radiator may be, for example, a radiator provided on an inner surface of an insulation rear cover.

That currents are co-directional/reverse in direction in embodiments of this application should be understood as that directions of main currents on conductors on a same side are the same or reverse. For example, when a co-directionally distributed current is excited on a bent radiator or an annular radiator (for example, a current path is also bent or annular), it should be understood that, for example, although main currents excited on conductors on two sides of the annular conductor (for example, for conductors around a slot, on conductors on two sides of the slot) are reverse in direction, the main currents still satisfy a definition of the co-directionally distributed current in embodiments of this application. In an embodiment, that currents on a conductor are co-directional may mean that the currents on the conductor have no reversal point. In an embodiment, that currents on a conductor are reverse in direction may mean that the currents on the conductor have at least one reversal point. In an embodiment, that currents on two conductors are co-directional may mean that none of the currents on the two conductors has a reversal point and the currents flow in the same direction. In an embodiment, that currents on two conductors are reverse in direction may mean that none of the currents on the two conductors has a reversal point and the currents flow in the reverse directions. It may be correspondingly understood that directions of currents on a plurality of conductors are co-directional/reverse in direction.

That electric fields are co-directional/reverse in direction in embodiments of this application should be understood as that directions of main electric fields (for example, electric fields between the conductor and the ground plane) generated by the conductor in the space are the same/reverse. For example, when a co-directionally distributed electric field is excited on a bent conductor or an annular conductor (for example, a gap formed between the ground plane and the conductor is also bent or annular), it should be understood that, for example, directions of electric fields in the gap are from the ground plane to the conductor or from the conductor to the ground plane, and although main electric fields excited in the gap on two sides of the annular conductor (for example, for conductors around a slot, or in a gap on two sides of a slot) are reverse in direction, the main electric fields still meet a definition of the co-directionally distributed electric field in embodiments of this application. In an embodiment, that electric fields between a conductor and the ground plane are co-directional may mean that the electric fields between the conductor and the ground plane have no reversal point. In an embodiment, that electric fields between a conductor and the ground plane are reverse may mean that the electric fields between the conductor and the ground plane have at least one reversal point. In an embodiment, that electric fields between two conductors and the ground plane are co-directional may mean that none of the electric fields between the two conductors and the ground plane has a reversal point and the electric fields radiate in a same direction (for example, a forward direction of a z-axis). In an embodiment, that electric fields between two conductors and the ground plane are reverse in direction may mean that none of the electric fields between the two conductors and the ground plane has a reversal point and the electric fields flow in reverse directions. It may be correspondingly understood that electric fields between a plurality of conductors and the ground plane are co-directional/reverse in direction.

Resonance/resonance frequency: The resonance frequency is also referred to as a resonant frequency. The resonance frequency may have a frequency range, namely, a frequency range in which a resonance occurs. A frequency corresponding to a strongest resonance point is a center frequency or a point frequency. A return loss of the center frequency may be less than −20 dB. It should be understood that, unless otherwise specified, an antenna/a radiator generates a “first/second . . . resonance” in this application, where the first resonance should be a fundamental mode resonance generated by the antenna/radiator, or a resonance that is generated by the antenna/radiator and that has a lowest frequency. It should be understood that the antenna or the radiator may generate one or more antenna modes based on a specific design, and one fundamental mode resonance may be correspondingly generated in each antenna mode.

Resonance frequency band: A range of a resonance frequency is a resonance frequency band, and a return loss of any frequency on the resonance frequency band may be less than −6 dB or −5 dB.

Communication frequency band/operating frequency band: Regardless of a type of antenna, the antenna constantly operates in a specific frequency range (a frequency bandwidth). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna.

The resonance frequency band and the operating frequency band may be the same, or may partially overlap. In an embodiment, one or more resonance frequency bands of an antenna may cover one or more operating frequency bands of the antenna.

Electrical length: The electrical length may be a ratio of a physical length (namely, a mechanical length or a geometric length) to a wavelength of a transmitted electromagnetic wave, and the electrical length may satisfy the following formula:

$$\overline{L} = \frac{L}{λ} ,$$

where

L is the physical length, and λ is the wavelength of the electromagnetic wave.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz. In this case, an operating wavelength may be a wavelength calculated based on the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiation signal in air may be calculated as follows: (air wavelength or vacuum wavelength)=speed of light/frequency, where the frequency is a frequency (MHz) of the radiation signal, and the speed of light may be 3×10⁸ m/s. A wavelength of the radiation signal in a medium may be calculated as follows: dielectric wavelength=(speed of light/\sqrt{ε})/frequency, where ε is a relative dielectric constant of the medium. The wavelength in embodiments of this application is usually a dielectric wavelength, and may be a dielectric wavelength corresponding to a center frequency of a resonance frequency, or a dielectric wavelength corresponding to a center frequency of an operating frequency band supported by an antenna. For example, it is assumed that a center frequency of a B1 uplink frequency band (with a resonance frequency ranging from 1920 MHz to 1980 MHz) is 1955 MHz. In this case, a wavelength may be a dielectric wavelength calculated based on the frequency of 1955 MHz. The “dielectric wavelength” is not limited to the center frequency, and may alternatively be a dielectric wavelength corresponding to a non-center frequency of the resonance frequency or the operating frequency band. For ease of understanding, the dielectric wavelength mentioned in embodiments of this application may be simply calculated based on a relative dielectric constant of a dielectric filled in one or more sides of a radiator.

Length: The length refers to a physical length or a measured length. It should be understood that the “length” mentioned in embodiments of this application is different from an “electrical length”. A “length of a radiator” should be understood as being equivalent to a “physical length of the radiator”, and a length of another structure in embodiments of this application should also be understood in the same way.

A person skilled in the art may understand that efficiency is generally indicated by a percentage, and there is a corresponding conversion relationship between the efficiency and dB. Efficiency closer to 0 dB indicates better efficiency of the antenna.

Antenna pattern: The antenna pattern is also referred to as a radiation pattern, is a pattern in which relative field strength (a normalized modulus value) of a radiation field of an antenna changes with a direction at a specific distance from the antenna (a far field), and is generally represented by two plane patterns that are perpendicular to each other in a maximum radiation direction of the antenna.

The antenna pattern usually includes a plurality of radiation beams. A radiation beam with highest radiation intensity is referred to as a main lobe, and the other radiation beams are referred to as minor lobes or side lobes. In the minor lobes, a minor lobe in an opposite direction of the main lobe is also referred to as a back lobe.

Directivity: The directivity is also referred to as directionality of an antenna. The directivity is a ratio of a maximum power density to an average value in an antenna pattern at a specific distance from the antenna (a far field), is a dimensionless ratio greater than or equal to 1, and may indicate an energy radiation characteristic of the antenna. Higher directivity indicates a larger ratio of energy radiated by the antenna in a direction, and more concentrated energy radiation.

Total efficiency of an antenna: The total efficiency of the antenna is a ratio of input power to output power at an antenna port.

Radiation efficiency of an antenna: The radiation efficiency of the antenna is a ratio of power radiated by the antenna to space (namely, power that is effectively converted into an electromagnetic wave) to active power input to the antenna. Herein, active power input to the antenna=input power of the antenna-loss power. The loss power mainly includes return loss power and metal ohmic loss power and/or dielectric loss power. The radiation efficiency is a value for measuring a radiation capability of the antenna. Both a metal loss and a dielectric loss are factors that affect the radiation efficiency.

A person skilled in the art may understand that efficiency is generally indicated by a percentage, and there is a corresponding conversion relationship between the efficiency and dB. Efficiency closer to 0 dB indicates better efficiency of the antenna.

Antenna return loss: The antenna return loss may be understood as a ratio of power of a signal reflected back to an antenna port through an antenna circuit to transmit power of the antenna port. A smaller reflected signal indicates a greater signal radiated by an antenna to space and higher radiation efficiency of the antenna. A greater reflected signal indicates a smaller signal radiated by the antenna to space and lower radiation efficiency of the antenna.

The antenna return loss may be represented by an S11 parameter, and S11 is one of S parameters. S11 indicates a reflection coefficient, and the parameter can indicate transmit efficiency of the antenna. The S11 parameter is generally a negative number. A smaller S11 parameter indicates a smaller antenna return loss, less energy reflected back by the antenna, namely, more energy that actually enters the antenna, and higher total efficiency of the antenna. A greater S11 parameter indicates a greater antenna return loss and lower total efficiency of the antenna.

It should be noted that, an S11 value of −6 dB is usually used as a standard in engineering. When an S11 value of the antenna is less than −6 dB, it may be considered that the antenna can operate normally, or it may be considered that transmit efficiency of the antenna is high.

It should be understood that, as mentioned in embodiments of this application, that a first frequency band and a second frequency band are the same (also referred to as having a same frequency) may be understood as any one of the following cases.

The first frequency band and the second frequency band include a same communication frequency band. In an embodiment, the first frequency band and the second frequency band may be applied to a MIMO antenna system. For example, if the first frequency band and the second frequency band each include a sub-6G frequency band in 5G, it may be considered that the first frequency band and the second frequency band have a same frequency.

The first frequency band and the second frequency band at least partially overlap. For example, the first frequency band includes B35 (1.85 GHz to 1.91 GHz) in LTE, the second frequency band includes B39 (1.88 GHz to 1.92 GHz) in LTE, and a frequency of the first frequency band and a frequency of the second frequency band partially overlap. In this case, it may be considered that the first frequency band and the second frequency band have a same frequency.

It should be understood that, in embodiments of this application, that a first frequency band and a second frequency band are adjacent may be understood as follows:

In the first frequency band and the second frequency band, a spacing between a start frequency of a higher frequency band and an end frequency of a lower frequency band is less than 10% of a center frequency of the higher frequency band (or the spacing is less than or equal to 200 MHz). For example, the first frequency band includes B3 (1.71 GHz to 1.785 GHz) in LTE, the second frequency band includes L1 (1578.42 MHz±1.023 MHz) in GPS, and B3 (1.71 GHz to 1.785 GHz) and L1 (1578.42 MHz±1.023 MHz) are adjacent frequency bands. In this case, it may be considered that the first frequency band and the second frequency band are adjacent. Alternatively, for example, the first frequency band includes B40 (2.3 GHz to 2.4 GHz) or B41 (2.496 GHz to 2.69 GHz) in LTE, the second frequency band includes a Wi-Fi/BT band (2.4 GHz to 2.485 GHz), and B40 (2.3 GHz to 2.4 GHz) or B41 (2.496 GHz to 2.69 GHz) and the Wi-Fi/BT band (2.4 GHz to 2.485 GHz) are adjacent frequency bands. In this case, it may be considered that the first frequency band and the second frequency band are adjacent.

Ground (Ground plane) (GND): The ground may generally be at least a part of any grounding plane, grounding plate, ground metal layer, or the like in an electronic device (like a mobile phone), or at least a part of any combination of the foregoing grounding plane, grounding plate, ground component, or the like. The “ground” may be used to ground components in the electronic device. In an embodiment, the “ground” may be a grounding plane of a circuit board of the electronic device, or may be a grounding plate formed by a middle frame of the electronic device or a ground metal layer formed by a metal film below a display of the electronic device. In an embodiment, the circuit board may be a printed circuit board (printed circuit board, PCB), for example, an 8-layer board, a 10-layer board, a 12-layer board, a 13-layer board, or a 14-layer board respectively having 8, 10, 12, 13, or 14 layers of conductive materials, or an element that is separated and electrically insulated by a dielectric layer or an insulation layer, for example, glass fiber, polymer, or the like. In an embodiment, the circuit board includes a dielectric substrate, a grounding plane, and a routing layer. The routing layer and the grounding plane are electrically connected through a via. In an embodiment, components such as a display, a touchscreen, an input button, a transmitter, a processor, a memory, a battery, a charging circuit, and a system-on-chip (SoC) structure may be mounted on or connected to the circuit board, or electrically connected to the routing layer and/or the grounding plane in the circuit board. For example, a radio frequency source is disposed on the routing layer.

Any of the foregoing grounding plane, or grounding plate, or ground metal layer is made of a conductive material. In an embodiment, the conductive material may be any one of the following materials: copper, aluminum, stainless steel, brass and an alloy thereof, copper foil on an insulation substrate, aluminum foil on the insulation substrate, gold foil on the insulation substrate, silver-plated copper, silver-plated copper foil on the insulation substrate, silver foil on the insulation substrate, tin-plated copper, cloth impregnated with graphite powder, a graphite-coated substrate, a copper-plated substrate, a brass-plated substrate, and an aluminum-plated substrate. A person skilled in the art may understand that the grounding plane/grounding plate/ground metal layer may alternatively be made of another conductive material.

Grounding: The grounding is coupling with the ground/ground plane in any manner. In an embodiment, the grounding may be direct grounding, for example, grounding via an entity (or referred to as entity grounding) at a specific position on a side frame is implemented through some mechanical parts of a middle frame. In an embodiment, the grounding may be grounding through a component, for example, grounding through a component (or referred to as component grounding) like a capacitor/inductor/resistor connected in series or in parallel.

The following describes technical solutions of embodiments in this application with reference to accompanying drawings.

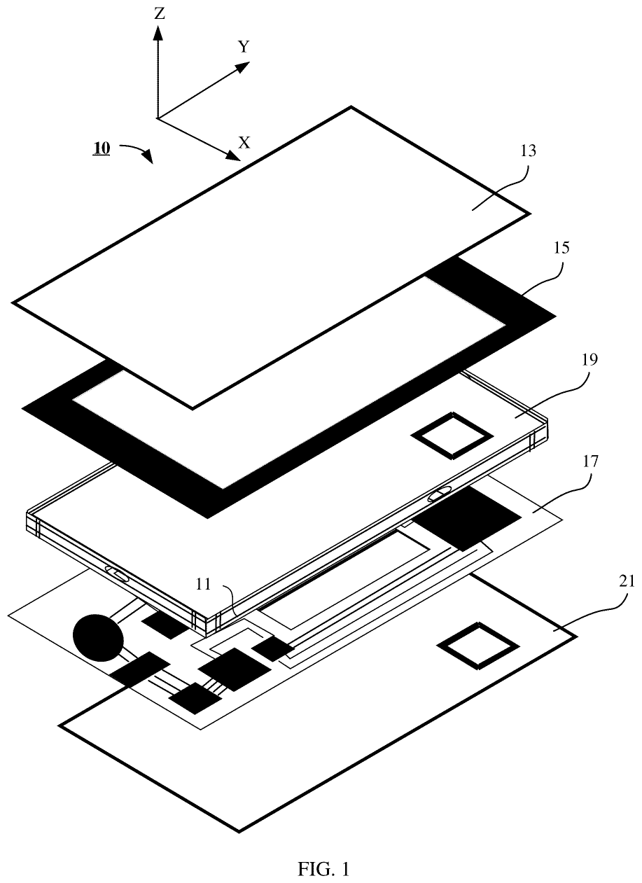

As shown in FIG. 1, an electronic device 10 may include a cover 13, a display/module (display) 15, a printed circuit board (PCB) 17, a middle frame 19, and a rear cover 21. It should be understood that, in some embodiments, the cover 13 may be cover glass, or may be replaced with a cover made of another material, for example, a cover made of a polyethylene terephthalate (PET) material.

The cover 13 may be tightly attached to the display module 15, and may be mainly configured to protect the display module 15 for dust resistance.

In an embodiment, the display module 15 may include a liquid crystal display (LCD) panel, a light-emitting diode (LED) display panel, an organic light-emitting semiconductor (OLED) display panel, or the like. This is not limited in embodiments of this application.

The middle frame 19 is mainly used to support the entire electronic device. FIG. 1 shows that the PCB 17 is disposed between the middle frame 19 and the rear cover 21. It should be understood that, in an embodiment, the PCB 17 may alternatively be disposed between the middle frame 19 and the display module 15. This is not limited in embodiments of this application. The printed circuit board PCB 17 may be a flame-resistant material (FR-4) dielectric board, or may be a Rogers dielectric board, or may be a hybrid dielectric board of Rogers and FR-4, or the like. Herein, FR-4 is a grade designation of a flame-resistant material, and the Rogers dielectric board is a high-frequency board. An electronic element, for example, a radio frequency integrated circuit, is carried on the PCB 17. In an embodiment, a metal layer may be disposed on the printed circuit board PCB 17. The metal layer may be configured to ground the electronic element carried on the printed circuit board PCB 17, or may be configured to ground another element, for example, a bracketed antenna or a side frame antenna. The metal layer may be referred to as a ground plane, a grounding plate, or a grounding plane. In an embodiment, the metal layer may be formed by etching metal on a surface of any dielectric board in the PCB 17. In an embodiment, the metal layer for grounding may be disposed on a side that is of the printed circuit board PCB 17 that is close to the middle frame 19. In an embodiment, an edge of the printed circuit board PCB 17 may be considered as an edge of the grounding plane of the PCB 17. In an embodiment, the metal middle frame 19 may also be configured to ground the foregoing element. The electronic device 10 may further have another ground plane/grounding plate/grounding plane. As described above, details are not described herein again.

The electronic device 10 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a mainboard and a sub-board. The battery may be disposed between the mainboard and the sub-board. The mainboard may be disposed between the middle frame 19 and an upper edge of the battery, and the sub-board may be disposed between the middle frame 19 and a lower edge of the battery.

The electronic device 10 may further include a side frame 11. The side frame 11 may be made of a conductive material like metal. The side frame 11 may be disposed between the display module 15 and the rear cover 21, and circumferentially extends around a periphery of the electronic device 10. The side frame 11 may have four sides surrounding the display module 15, to help fasten the display module 15. In an implementation, the side frame 11 made of a metal material may be directly used as a metal side frame of the electronic device 10 to form an appearance of the metal side frame, and is applicable to a metal industrial design (ID). In another implementation, an outer surface of the side frame 11 may alternatively be made of a non-metal material, for example, may be a plastic side frame, to form an appearance of a non-metal side frame, and is applicable to a non-metal ID.

The middle frame 19 may include the side frame 11, and the middle frame 19 including the side frame 11 is used as an integrated part, and may support an electronic component in the entire device. The cover 13 and the rear cover 21 respectively fit upper edges and lower edges of the side frame, to enclose a casing or a housing of the electronic device. In an embodiment, the cover 13, the rear cover 21, the side frame 11, and/or the middle frame 19 may be collectively referred to as a casing or a housing of the electronic device 10. It should be understood that the “casing or housing” may mean a part or all of any one of the cover 13, the rear cover 21, the side frame 11, and the middle frame 19, or mean a part or all of any combination of the cover 13, the rear cover 21, the side frame 11, and the middle frame 19.

At least a part of the side frame 11 on the middle frame 19 may serve as a radiator of an antenna to transmit/receive a radio frequency signal. A gap may exist between the part of the side frame that serves as the radiator and another part of the middle frame 19, to ensure that the radiator of the antenna has a good radiation environment. In an embodiment, the middle frame 19 may be provided with an aperture at the part of the side frame that serves as the radiator, to facilitate radiation of the antenna.

Alternatively, the side frame 11 may not be considered as a part of the middle frame 19. In an embodiment, the side frame 11 may be connected to and integrally formed with the middle frame 19. In another embodiment, the side frame 11 may include a protruding part extending inward, to be connected to the middle frame 19, for example, connected by using a spring or a screw, or connected through welding. The protruding part of the side frame 11 may be further configured to receive a feed signal, so that at least a part of the side frame 11 serves as a radiator of an antenna to receive/transmit a radio frequency signal. A gap 42 may exist between the middle frame 19 and the part of the side frame that serves as the radiator, to ensure that the radiator of the antenna has a good radiation environment, and the antenna has a good signal transmission function.

The rear cover 21 may be a rear cover made of a metal material, or may be a rear cover made of a non-conductive material, for example, may be a non-metal rear cover like a glass rear cover and a plastic rear cover, or may be a rear cover made of both a conductive material and a non-conductive material. In an embodiment, the rear cover 21 including the conductive material may replace the middle frame 19, and serves as an integrated part with the side frame 11, to support an electronic component in the entire device.

It should be understood that the side frame 11 may have an insulation slot. For example, the insulation slot may form an open end of a radiator of an antenna, so that the radiator of the antenna is used as a side frame antenna. When the side frame 11 is made of a conductive material such as metal, the insulation slot may be understood as that a slot provided in the side frame 11 is filled with a non-metal material (insulation material), and the slot is visible on an appearance surface of the side frame. When an outer surface of the side frame 11 is made of a non-conductive material, the insulation slot may be understood as a slot between conductor parts in the side frame 11, and the slot may be filled with a non-metal material (an insulation material), or may not be filled with a non-metal material, and is filled with air. In addition, the slot is invisible on an appearance surface of the side frame.

In an embodiment, the middle frame 19 and/or a conductive part of the rear cover 21 may serve as a reference ground of the electronic device 10. The side frame 11, the PCB 17, and the like of the electronic device may be electrically connected to the middle frame for grounding.

The antenna of the electronic device 10 may be further disposed in the side frame 11. When the side frame 11 of the electronic device 10 is made of a non-conductive material, the radiator of the antenna may be located in the electronic device 10 and disposed along the side frame 11. For example, the radiator of the antenna is disposed close to the side frame 11, to minimize a volume occupied by the radiator of the antenna, and is closer to the outside of the electronic device 10, to achieve a better signal transmission effect. It should be noted that, that the radiator of the antenna is disposed close to the side frame 11 means that the radiator of the antenna may be tightly attached to the side frame 11, or may be disposed close to the side frame 11. For example, there may be a specific small slot between the radiator of the antenna and the side frame 11.

The antenna of the electronic device 10 may be further disposed in the casing, for example, a bracketed antenna or a millimeter wave antenna (not shown in FIG. 1). Clearance of the antenna disposed in the housing may be obtained through a slit/hole in any one of the middle frame, and/or the side frame, and/or the rear cover, and/or the display, or through a non-conductive slit/aperture formed between any several of the middle frame, and/or the side frame, and/or the rear cover, and/or the display. The clearance of the antenna may be provided, to ensure a radiation characteristic of the antenna. It should be understood that, the clearance of the antenna may be a non-conductive area including any conductive component in the electronic device 10, and the antenna radiates a signal to external space through the non-conductive area. In an embodiment, a form of the antenna 40 may be an antenna form based on a flexible mainboard (FPC), an antenna form based on laser-direct-structuring (LDS), or an antenna form like a microstrip disk antenna (MDA). In an embodiment, the antenna may alternatively use a transparent structure embedded into a display of the electronic device 10, so that the antenna is a transparent antenna element embedded into the display of the electronic device 10.

FIG. 1 shows only an example of some parts included in the electronic device 10. Actual shapes, actual sizes, and actual structures of the parts are not limited to those in FIG. 1.

It should be understood that, in embodiments of this application, it may be considered that a surface on which the display of the electronic device is located is a front surface, a surface on which the rear cover is located is a rear surface, and a surface on which the side frame is located is a side surface.

It should be understood that, in embodiments of this application, it is considered that when a user holds the electronic device (the user usually holds the electronic device vertically and faces the display), an orientation in which the electronic device is located has a top part, a bottom part, a left part, and a right part. It should be understood that, in embodiments of this application, it is considered that when the user holds the electronic device (the user usually holds the electronic device vertically and faces the display), the orientation in which the electronic device is located has the top part, the bottom part, the left part, and the right part.

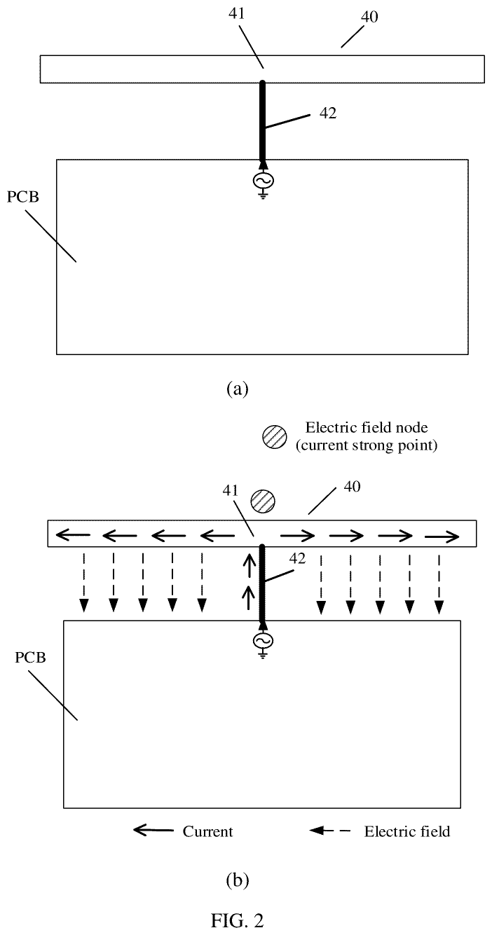

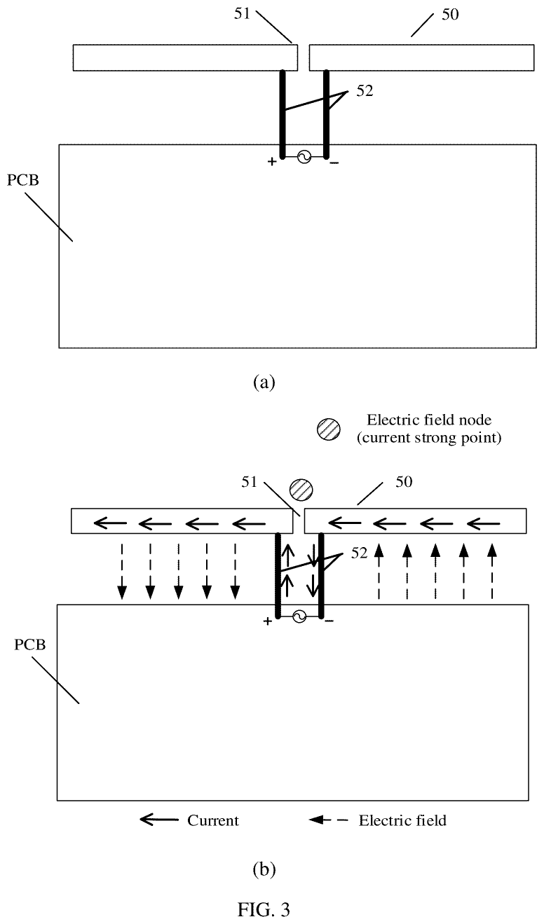

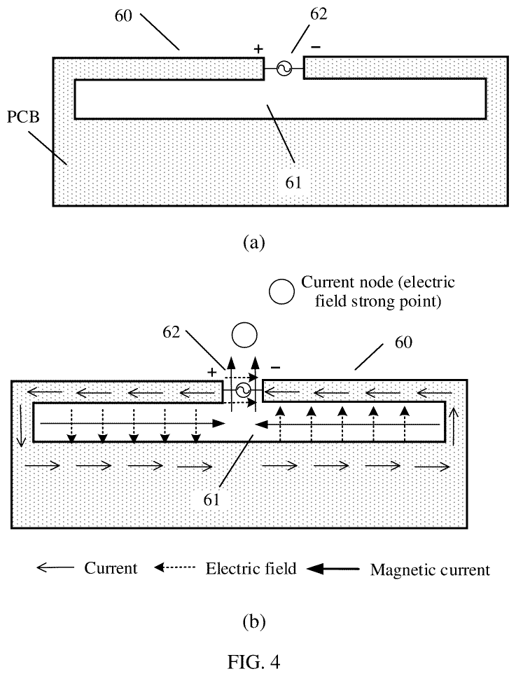

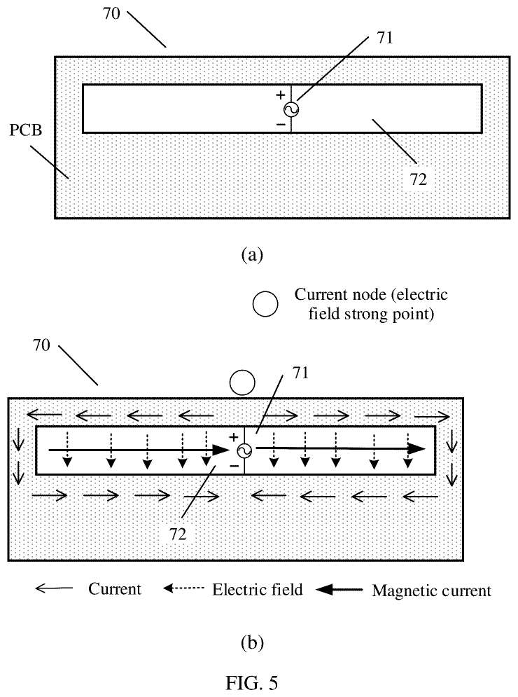

First, FIG. 2 to FIG. 5 describe four antenna modes in this application. FIG. 2 shows diagrams of a structure in a common mode of an antenna and distribution of corresponding currents and electric fields according to this application. FIG. 3 shows diagram of a structure in a differential mode of another antenna and distribution of corresponding currents and electric fields according to this application. Two ends of each of radiators of antennas in FIG. 2 and FIG. 3 are open, and a common mode and a differential mode of the radiators of the antennas may be respectively referred to as a wire common mode and a wire differential mode. FIG. 4 shows diagrams of a structure in a common mode of an antenna and distribution of corresponding currents, electric fields, and magnetic currents according to this application. FIG. 5 shows diagrams of a structure in a differential mode of another antenna and distribution of corresponding currents, electric fields, and magnetic currents according to this application. Two ends of each of radiators of antennas in FIG. 4 and FIG. 5 are grounded, and a common mode and a differential mode of the radiators of the antennas may be respectively referred to as a slot common mode and a slot differential mode.

It should be understood that the “common mode” or the “CM mode” in this application includes a wire common mode and a slot common mode, and the “differential mode” or the “DM mode” in this application includes a wire differential mode and a slot differential mode, which may be specifically determined based on a structure of an antenna.

It should be understood that a “common-differential mode” or a “CM-DM mode” in this application is a wire common mode and a wire differential mode that are generated on a same radiator, or is a slot common mode and a slot differential mode that are generated on a same radiator, and may be specifically determined based on a structure of an antenna.

### 1. Wire Common Mode (CM) Mode

Herein, (a) in FIG. 2 shows that two ends of a radiator of an antenna 40 are open, and a feed circuit (not shown in the figure) is connected to a middle position 41. In an embodiment, the antenna 40 adopts a symmetrical feed (symmetrical feed) form. The feed circuit may be connected to the middle position 41 of the antenna 40 through a feed line 42. It should be understood that the symmetrical feed may be understood as that one end of the feed circuit is connected to the radiator and the other end of the feed circuit is grounded. A connection point (feed point) between the feed circuit and the radiator is located at a center of the radiator. The center of the radiator may be, for example, a midpoint of a geometric structure, or a midpoint of an electrical length (or an area within a specific range near the midpoint).

The middle position 41 of the antenna 40 may be, for example, a geometric center of the antenna, or the midpoint of the electrical length of the radiator. For example, a joint between the feed line 42 and the antenna 40 covers the middle position 41.

Herein, (b) in FIG. 2 shows current and electric field distribution of the antenna 40. As shown in (b) in FIG. 2, currents are reversely distributed, for example, symmetrically distributed, on two sides of the middle position 41. Electric fields are co-directionally distributed on the two sides of the middle position 41. As shown in (b) in FIG. 2, the currents are co-directionally distributed at the feed line 42. Based on co-directional distribution of the currents at the feed line 42, such feed shown in (a) in FIG. 2 may be referred to as wire CM feed. Based on reverse distribution of the currents on two sides of a joint between the radiator and the feed line 42, such an antenna mode shown in (b) in FIG. 2 may be referred to as a wire CM mode (which may also be briefly referred to as a CM mode, for example, for a wire antenna, the CM mode is the wire CM mode). The current and the electric field shown in (b) in FIG. 2 may be respectively referred to as a current and an electric field in the wire CM mode.

The current is stronger at the middle position 41 of the antenna 40 (a current strong point is located near the middle position 41 of the antenna 40), and is weaker at two ends of the antenna 40, as shown in (b) in FIG. 2. The electric field is weak at the middle position 41 of the antenna 40, and is strong at the two ends of the antenna 40.

### 2. Wire Differential Mode (DM) Mode

As shown in (a) in FIG. 3, a left end and a right end of each of two radiators of an antenna 50 are open ends, and a feed circuit is connected to a middle position 51. In an embodiment, the antenna 50 adopts an anti-symmetrical feed form. One end of the feed circuit is connected to one of the radiators through a feed line 52, and the other end of the feed circuit is connected to the other one of the radiators through a feed line 52. The middle position 51 may be a geometric center of the antenna 50, or a slot formed between the radiators.

It should be understood that, “central anti-symmetrical feed” mentioned in this application may be understood as that a positive electrode and a negative electrode of a feed element are respectively connected to two connection points near a midpoint between the radiators. In an embodiment, signals output from the positive electrode and the negative electrode of the feed element have a same amplitude but opposite phases. For example, a phase difference is 180°±10°.

Herein, (b) in FIG. 3 shows current and electric field distribution of the antenna 50. As shown in (b) in FIG. 3, currents are co-directionally distributed, for example, anti-symmetrically distributed, on two sides of the middle position 51 of the antenna 50. Electric fields are reversely distributed on the two sides of the middle position 51. As shown in (b) in FIG. 3, the currents are reversely distributed at the feed line 52. Based on reverse distribution of the currents at the feed line 52, such feed shown in (a) in FIG. 3 may be referred to as wire DM feed. Based on co-directional distribution of the currents on two sides of a joint between the radiator and the feed line 52, such an antenna mode shown in (b) in FIG. 3 may be referred to as a wire DM mode (which may also be briefly referred to as a DM mode, for example, for a wire antenna, the DM mode is the wire DM mode). The current and the electric field shown in (b) in FIG. 3 may be respectively referred to as a current and an electric field in the wire DM mode.

The current is strong at the middle position 51 of the antenna 50 (a current strong point is located near the middle position 51 of the antenna 50), and is weak at two ends of the antenna 50, as shown in (b) in FIG. 3. The electric field is weak at the middle position 51 of the antenna 50, and is strong at the two ends of the wire antenna 50.

It should be understood that the radiator of the antenna may be understood as a metal mechanical part that generates radiation, and there may be one radiator of the antenna, as shown in FIG. 2, or there may be two radiators of the antenna, as shown in FIG. 3, which may be adjusted based on an actual design or a production requirement. For example, for the wire CM mode, the two radiators may alternatively be used, as shown in FIG. 3. Two ends of the two radiators are oppositely disposed and are spaced from each other by a slot. A symmetrical feed manner is used at the two ends that are close to each other. For example, an effect similar to that of the antenna structure shown in FIG. 2 may also be achieved by separately feeding a same feed signal into the two ends that are of the two radiators and that are close to each other. Correspondingly, for the wire DM mode, one radiator may alternatively be used, as shown in FIG. 2. Two feed points are disposed at a middle position of a radiator, and an anti-symmetrical feed manner is used. For example, an effect similar to that of the antenna structure shown in FIG. 3 may also be achieved by respectively feeding signals of a same amplitude but opposite phases at the two symmetrical feed points on the radiator.

### 3. Wire CM-DM Mode

FIG. 2 and FIG. 3 respectively show that when two ends of a radiator are open, a wire CM mode and a wire DM mode are respectively generated in different feed manners.

When an antenna adopts an asymmetric feed form (including a side feed form and an offset feed form, where a feed point deviates from a middle position of the radiator), or a ground point (a position coupled to a ground plane) of the radiator is asymmetric (the ground point deviates from the middle position of the radiator), the antenna may generate both a first resonance and a second resonance, which respectively correspond to the wire CM mode and the wire DM mode. For example, the first resonance corresponds to the wire CM mode, and current and electric field distribution is shown in (b) in FIG. 2. The second resonance corresponds to the wire DM mode, and current and electric field distribution is shown in (b) in FIG. 3.

### 4. Slot CM Mode

A radiator of an antenna 60 shown in (a) in FIG. 4 has a hollow slot or slit 61, or a radiator of an antenna 60 and a ground (for example, a ground plane, which may be a PCB) may enclose the slot 61. The slot 61 may be formed by slotting the ground plane. An opening 62 is provided on a side of the slot 61, and the opening 62 may be specifically provided at a middle position of the side. The middle position of the side of the slot 61 may be, for example, a geometric midpoint of the antenna 60, or a midpoint of an electrical length of the radiator. For example, an area of the opening 62 on the radiator covers the middle position of the side. A feed circuit may be connected to the opening 62, and anti-symmetrical feed is used. It should be understood that the anti-symmetrical feed may be understood as that a positive electrode and a negative electrode of the feed circuit are respectively connected to two ends of the radiator. Signals output from the positive electrode and the negative electrode of the feed circuit have a same amplitude but opposite phases. For example, a phase difference is 180°±10°.

Herein, (b) in FIG. 4 shows current, electric field, and magnetic flow distribution of the antenna 60. As shown in (b) in FIG. 4, currents are co-directionally distributed around the slot 61 and on a conductor (for example, a ground plane and/or a radiator 60) surrounding the slot 61. Electric fields are reversely distributed on two sides of a middle position of the slot 61. Magnetic currents are reversely distributed on the two sides of the middle position of the slot 61. As shown in (b) in FIG. 4, electric fields are co-directional at the opening 62 (for example, a feed position), and magnetic currents are co-directional at the opening 62 (for example, the feed position). Because the magnetic currents are co-directional at the opening 62 (the feed position), the such feed shown in (a) in FIG. 4 may be referred to as slot CM feed. As the currents are co-directionally distributed (for example, anti-symmetrically distributed) on radiators on two sides of the opening 62, or as the currents are co-directionally distributed around the slot 61 and on a conductor surrounding the slot 61, the antenna mode shown in (b) in FIG. 4 may be referred to as a slot CM mode (which may also be referred to as a CM mode for short, for example, for a slot antenna, the CM mode is a slot CM mode). An electric field, a current, and a magnetic flow shown in (b) in FIG. 4 may be referred to as an electric field, a current, and a magnetic flow in the slot CM mode.

The magnetic field is weak at the middle position of the antenna 60, and is strong at two ends of the antenna 60. The electric field is strong at the middle position of the antenna 60 (an electric field strong point is near the middle position of the antenna 60), and is weak at the two ends of the antenna 60, as shown in (b) in FIG. 4.

### 5. Slot DM Mode

A radiator of an antenna 70 shown in (a) in FIG. 5 has a hollow slot or slit 72, or a radiator of an antenna 70 and a ground (for example, a ground plane, which may be a PCB) may enclose the slot 72. The slot 72 may be formed by slotting the ground plane. A feed circuit is connected to a middle position 71 of the slot 72, and symmetrical feed is used. It should be understood that the symmetrical feed may be understood as that one end of the feed circuit is connected to the radiator and the other end of the feed circuit is grounded. A connection point (feed point) between the feed circuit and the radiator is located at a center of the radiator. The center of the radiator may be, for example, a midpoint of a geometric structure, or a midpoint of an electrical length (or an area within a specific range near the midpoint). A middle position of a side edge of the slot 72 is connected to a positive electrode of the feed circuit, and a middle position of another side edge of the slot 72 is connected to a negative electrode of the feed circuit. The middle position of the side edge of the slot 72 may be, for example, the middle position of the slot antenna 60/the middle position of the ground, for example, the geometric midpoint of the slot antenna, or a midpoint of an electrical length of the radiator. For example, a connection joint between the feed circuit and the radiator covers the middle position 51 of the side.

Herein, (b) in FIG. 5 shows current, electric field, and magnetic flow distribution of the antenna 70. As shown in (b) in FIG. 5, on a conductor (for example, a ground plane and/or a radiator 60) surrounding the slot 72, currents are distributed around the slot 72, and are reversely distributed on two sides of the middle position of the slot 72. Electric fields are co-directionally distributed on the two sides of the middle position 71. Magnetic currents are co-directionally distributed on the two sides of the middle position 71. Magnetic currents are reversely distributed at the feed circuit (not shown). Based on reverse distribution of the magnetic currents at the feed circuit, such feed shown in (a) in FIG. 5 may be referred to as slot DM feed. As the currents are reversely distributed (for example, symmetrically distributed) on two sides of the connection joint between the feed circuit and the radiator, or as the currents are reversely distributed (for example, symmetrically distributed) around the slot 71, such antenna mode shown in (b) in FIG. 5 may be referred to as a slot DM mode (which may also be referred to as a DM mode for short, for example, for a slot antenna, the DM mode is a slot DM mode). An electric field, a current, and a magnetic flow shown in (b) in FIG. 5 may be referred to as an electric field, a current, and a magnetic flow in the slot DM mode.

The current is weak at the middle position of the antenna 70, and is strong at two ends of the antenna 70. The electric field is strong at the middle position of the antenna 70 (an electric field strong point is near the middle position of the antenna 60), and is weak at the two ends of the slot antenna 70, as shown in (b) in FIG. 5.

It should be understood that the radiator of the antenna may be understood as a metal mechanical part (for example, including a part of the ground plane) that generates radiation, and may include an opening, as shown in FIG. 4, or may be in a shape of a complete loop, as shown in FIG. 5, which may be adjusted based on an actual design or a production requirement. For example, for the slot CM mode, a complete annular radiator may alternatively be used, as shown in FIG. 5. Two feed points are disposed at a middle position of a radiator on one side of the slot 61, and an anti-symmetrical feed manner is used. For example, an effect similar to that of the antenna structure shown in FIG. 4 may also be achieved by respectively feeding signals of a same amplitude but opposite phases into two ends of an original opening position. Correspondingly, for the slot DM mode, a radiator including an opening may also be used, as shown in FIG. 4, and a symmetrical feed manner is used at both ends of the opening position. For example, an effect similar to that of the antenna structure shown in FIG. 5 may also be achieved by separately feeding a same feed source signal into two ends of the radiator on two sides of the opening.

### 6. Slot CM-DM Mode

FIG. 4 and FIG. 5 show that a slot structure uses different feed manners to respectively generate a slot CM mode and a slot DM mode.

When an antenna adopts an asymmetric feed form (including a side feed form or an offset feed form, where a feed point deviates from a middle position), or an opening on one side of a slot is asymmetric (the opening deviates from a middle position of the side), the antenna may generate both a first resonance and a second resonance, which respectively correspond to the slot CM mode and the slot DM mode. For example, the first resonance corresponds to the slot CM mode, and current, electric field, and magnetic flow distribution is shown in (b) in FIG. 4. The second resonance corresponds to the slot DM mode, and current, electric field, and magnetic flow distribution is shown in (b) in FIG. 5.

Because the above antenna structure may have two operating modes (electric fields are symmetrically distributed or anti-symmetrically distributed) in which the electric fields are orthogonal ((integrally orthogonal) an inner product of the electric fields is zero in far field), the antenna structure has good isolation between the two operating modes, and may be used in a multi-input multi-output (MIMO) antenna system in an electronic device.

In addition, when two antenna structures respectively operate in the two operating modes (the electric fields are symmetrically distributed or anti-symmetrically distributed) in which the electric fields are orthogonal ((integrally orthogonal) an inner product of the electric fields is zero in far field), two antenna structures may have good isolation, and may be used as subunits in the MIMO antenna system in the electronic device.

It should be understood that the two antenna structures may be understood as antenna structures in which signals are separately fed into a first feed circuit and a second feed circuit. The first feed circuit is different from the second feed circuit. In the electronic device, the first feed circuit and the second feed circuit may be different radio frequency channels in a radio frequency integrated circuit (RF IC).

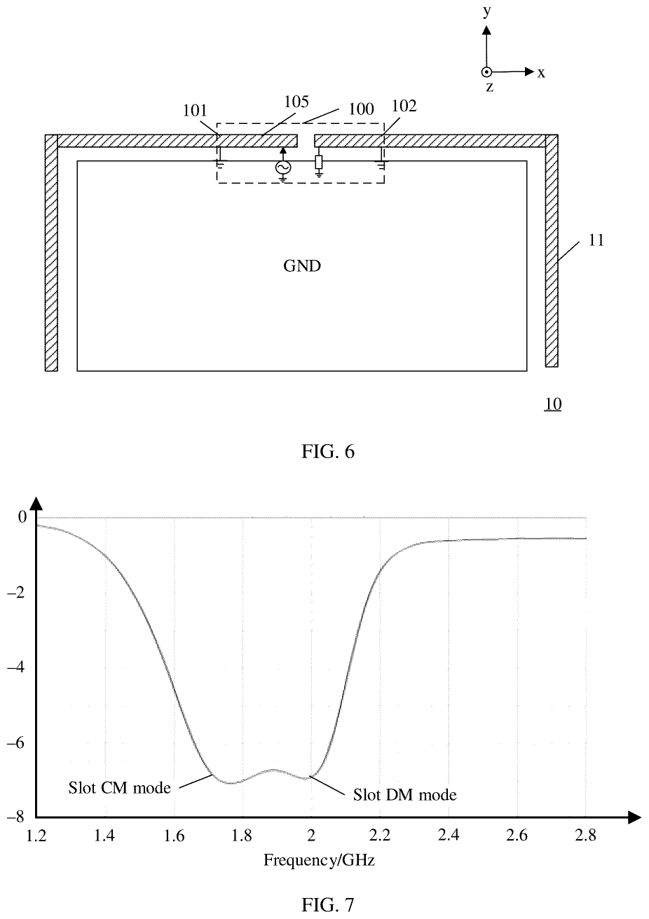

FIG. 6 is a diagram of another electronic device 10 according to an embodiment of this application.

As shown in FIG. 6, the electronic device 10 may include an antenna 100.

A conductive side frame 11 of the electronic device 10 may include a first position 101 and a second position 102. The side frame 11 is coupled to a ground plane at the first position 101 and the second position 102, and is provided with a slot between the first position and the second position. A radiator 105 of the antenna 100 is a conductive part between the first position 101 and the second position 102.

The antenna 100 may further include a feed circuit and an electronic element. The radiator 105 may include a first connection point and a second connection point. The first connection point is located between the first position 101 and the slot, and the second connection point is located between the second position 102 and the slot. The feed circuit is coupled to the first connection point. A first end of the electronic element is coupled to the second connection point, and a second end of the electronic element is coupled to the ground plane.

When the feed circuit feeds an electrical signal, the antenna 100 may operate in the slot CM-DM mode. A resonance generated in a slot CM mode and a resonance generated in a slot DM mode may be close to each other through the electronic element, to jointly form a resonance frequency band, so as to expand an operating bandwidth of the antenna 100. In an embodiment, the electronic element may shift a frequency of the resonance generated in the slot DM mode toward a low frequency.

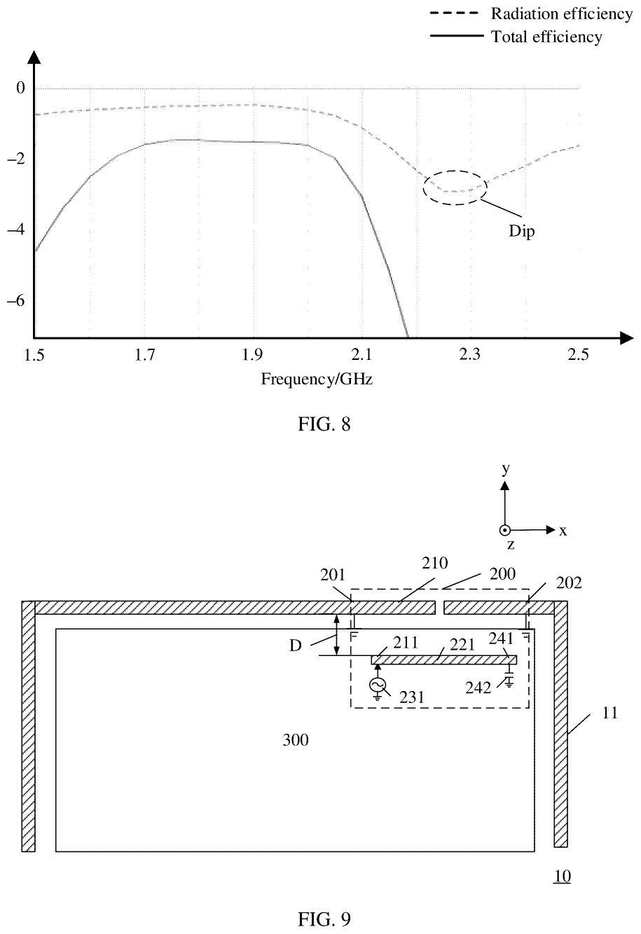

FIG. 7 and FIG. 8 show simulation results of the antenna 200 in the electronic device 10 shown in FIG. 6. FIG. 7 shows a simulation result of an S parameter of the antenna 100 in the electronic device 10 shown in FIG. 6. FIG. 8 shows simulation results of total efficiency and radiation efficiency of the antenna 100 in the electronic device 10 shown in FIG. 6.

As shown in FIG. 7, the antenna 100 may generate a resonance near 1.7 GHz and a resonance near 2 GHz. The resonance generated near 1.7 GHz may correspond to the slot CM mode, and the resonance generated near 2 GHz may correspond to the slot DM mode.

As shown in FIG. 8, when the antenna 100 operates in the slot CM mode, there are a plurality of current modes on the ground plane. Radiation is mainly generated through the radiator in the slot DM mode. Therefore, radiation efficiency of the slot CM mode is higher than radiation efficiency of the slot DM mode. When the operating bandwidth of the antenna 100 is expanded by using the resonance generated in the slot CM mode and the resonance generated in the slot DM mode, because the radiation efficiency of the slot DM mode is lower, a dip is generated near the resonance generated in the slot DM mode. Consequently, a bandwidth of total efficiency (for example, total efficiency>−2 dB) is narrow, and is only 400 MHz.

Embodiments of this application provide an antenna structure and an electronic device thereof. The antenna structure uses a conductive part of a side frame as a radiator. An electrical signal is fed to the radiator through indirect coupling. A feed member and the radiator are configured to generate a first resonance and a second resonance. The two resonances may be used to jointly form a resonance frequency band to expand a bandwidth. In addition, in the resonance frequency band, radiation efficiency and total efficiency are good.

FIG. 9 is a diagram of another electronic device 10 according to an embodiment of this application.

As shown in FIG. 9, the electronic device 10 includes a side frame 11, an antenna 200, and a ground plane 300.

At least a part of the side frame 11 and the ground plane 300 are spaced from each other. The side frame 11 includes a first position 201 and a second position 202. The side frame 11 is coupled to the ground plane 300 at the first position 201 and the second position 202. The side frame 11 is provided with a first slot between the first position 201 and the second position 202. In an embodiment, the first slot is located in a central area between the first position 201 and the second position 202.

It should be understood that the central area may be understood as an area within 5 mm away from a center. A physical length between the center and the first position 201 is the same as a physical length between the center and the second position 202, or an electrical length between the center and the first position 201 is the same as an electrical length between the center and the second position 202. For brevity of description, the central area in embodiments of this application may be correspondingly understood.

In addition, for brevity of description, in embodiments of this application, a coupling connection is described by using direct coupling (an electrical connection) as an example. In actual production or design, the coupling connection may alternatively be implemented through indirect coupling.

In an embodiment, the first position 201 and the second position 202 are coupled to the ground plane 300, to implement grounding of the radiator. At the first position 201 and the second position 202, the side frame 11 may be directly electrically connected to the ground plane 300 through a spring, or may be electrically connected to the ground plane 300 through an inductor, or may be electrically connected to the ground plane 300 through a mechanical part (for example, a connecting rib) of a middle frame. Being electrically connected to the ground plane 300 through the mechanical part of the middle frame may be understood as that at least a part of the side frame 11 and the ground plane 300 are of an integrated structure.

In an embodiment, the ground plane 300 may be electrically connected through a ground member (for example, a spring or a connecting rib) at the first position 201 and the second position 202. A width of a joint between the ground member and the side frame 11 is greater than or equal to 1 mm and less than or equal to 10 mm.

In an embodiment, the side frame 11 is provided with a first slot between the first position 201 and the second position 202, to implement an opening/open end on the radiator. Either of two sides of the first slot may be spaced from the ground plane 300, or may be coupled to the ground plane 300 through a capacitor.

The antenna 200 includes a radiator 210 and a feed member 221. The radiator 210 and the feed member 221 are spaced from each other, and the radiator 210 and the feed member 221 at least partially overlap in a first direction. The first direction is perpendicular to an extension direction (for example, a y direction) of the radiator 210. In an embodiment, the extension direction of the radiator 210 is the same as an extension direction of the feed member 221. The radiator 210 is a conductive part of the side frame 11 between the first position 201 and the second position 202. A first end and a second end of the radiator 210 are ground ends, where the first end and the second end of the radiator 210 respectively correspond to the first position 201 and the second position 202 of the side frame 11. A first end and a second end of the feed member 221 are open ends.

That the extension direction of the radiator 210 is the same as the extension direction of the feed member 221 may be understood as that an angle between the extension direction of the radiator 210 and the extension direction of the feed member 221 is less than or equal to a first threshold, for example, less than or equal to 10°.

It should be understood that, in this embodiment of this application, the open end may be understood as being spaced from the ground plane 300 or coupled to the ground plane 300 through a capacitor. In this embodiment of this application, the ground end may be understood as being directly electrically connected to the ground plane 300 or being coupled to the ground plane 300 through an inductor. The capacitor or the inductor in this embodiment of this application may be understood as a capacitive electronic element or an inductive electronic element. For brevity of description, details are not described again. Being directly electrically connected to the ground plane 300 may be understood as that only a connection component (for example, a spring or a metal connecting rib) is disposed between the ground end and the ground plane 300, and no electronic element (for example, no capacitor, no inductor, or no switch) is disposed. For example, a ground structure may be milled on the electronic device by using a process.

In the foregoing embodiment, both the open end and the ground end may be coupled to the ground plane 300 through electronic elements. A difference lies in that an original electric field or current characteristic is not changed after the open end and the ground end are coupled to the ground plane 300 through the electronic elements. At the open end, the electronic element is coupled to the ground plane 300, and there is still a strong electric field near the open end. Correspondingly, a current in the area is weak. At the ground end, the electronic element is coupled to the ground plane 300, and there is still a strong current near the ground end. Correspondingly, an electric field in the area is weak.

It should be understood that the extension direction of the radiator 210 may be understood as an extension direction of the side frame at which the first position 201 or the second position 202 is located. For example, both the first position 201 and the second position 202 are located on a first side of the side frame, and the extension direction of the radiator 210 is an extension direction (for example, an x direction) of the first side. Alternatively, the first position 201 and the second position 202 are respectively located on a first side and a second side that are of the side frame and that intersect at an angle. The extension direction of the radiator 210 includes an extension direction (for example, the x direction) of the first side and an extension direction (for example, the y direction) of the second side. The radiator 210 and the feed member 221 at least partially overlap in a direction perpendicular to either direction in the extension directions of the radiator 210.

In addition, that the radiator 210 and the feed member 221 are spaced from each other may be understood that the radiator 210 and the feed member 221 are not directly connected to each other and form a gap. In this embodiment of this application, being spaced from each other may be correspondingly understood. The radiator 210 is coupled to the feed member 221 by using the gap.

The antenna 200 further includes a feed circuit 231, the feed member 221 includes a feed point 211, and the feed circuit 231 is coupled to the feed point 211. In an embodiment, a distance between the feed point 211 and an end part of the first end of the feed member 221 is less than one third of a length of the feed member 221. It should be understood that a radiation characteristic, for example, a resonance point frequency, of the antenna 200 may be adjusted by adjusting a position of the feed point 211.

The feed member 221 and the radiator 210 are configured to generate a first resonance and a second resonance. In an embodiment, the first resonance and the second resonance are used to jointly support a first operating frequency band of the electronic device 10. The feed circuit 231 may be configured to feed an electrical signal on the first operating frequency band.

The first operating frequency band of the electronic device 10 includes a frequency range, for example, a low band (LB) (698 MHz to 960 MHz), a middle band (MB) (1710 MHz to 2170 MHz), or a high band (HB) (2300 MHz to 2690 MHz) in a cellular network. For example, an operating frequency band of the electronic device 10 is LB (698 MHz to 960 MHz). The operating frequency band may include a plurality of communication frequency bands that are within the frequency range, for example, B5 and B8, which may be correspondingly understood in this embodiment of this application.

It should be understood that, in the technical solution provided in this embodiment of this application, the radiator 210 may form a radiator structure that conforms to a slot antenna. When the feed circuit 231 feeds the electrical signal, the antenna 200 may generate the first resonance and the second resonance through the radiator 210 and the feed member 221. In the electronic device 10, compared with the radiator 210 (the conductive part of the side frame 11 is used as the radiator 210), the feed member 221 has a worse radiation environment (for example, a worse clearance, and is closer to an adjacent metal part). However, the feed member 221 may generate a new current path for the radiator 210, to generate a new resonance (for example, the second resonance), so as to expand an operating bandwidth of the antenna 200.

In addition, because the first end and the second end of the radiator 210 are ground ends, the radiator 210 has stronger currents and weaker electric fields in areas near the first end and the second end. The first end and the second end of the feed member 221 are open ends, and the feed member 221 has weaker currents and stronger electric fields in areas near the first end and the second end. The area with a weaker electric field (a stronger magnetic field) of the radiator 210 is close to the area with a stronger electric field (a stronger magnetic field) of the feed member 221, so that the first resonance and the second resonance can be balanced, and no dip of radiation efficiency is generated in the first operating frequency band jointly supported by the first resonance and the second resonance. In this way, a radiation characteristic of the antenna 200 is improved, and the electronic device 10 has better communication performance.

In an embodiment, the first resonance and the second resonance may be close to each other, so that the first resonance and the second resonance are used to jointly support an operating frequency band of the electronic device 10. In an embodiment, a frequency difference between the first resonance and the second resonance is within a range of 5% to 20% (greater than or equal to 5% and less than or equal to 20%) of a low-frequency resonance frequency point or a high-frequency resonance frequency point. In an embodiment, in the low band (less than or equal to 1 GHz, for example, 698 MHz to 960 MHz), a frequency difference between a resonance point frequency of the first resonance and/or a resonance point frequency of the second resonance is greater than or equal to 50 MHz and less than or equal to 160 MHz. In the middle band (in a range of 1 GHz to 2 GHz, for example, 1710 MHz to 2170 MHz), a frequency difference between a resonance point frequency of the first resonance and/or a resonance point frequency of the second resonance is greater than or equal to 120 MHz and less than or equal to 300 MHz. In the high band (in a range of 2 GHz to 3 GHz, for example, 2300 MHz to 2690 MHz), a frequency difference between a resonance point frequency of the first resonance and/or a resonance point frequency of the second resonance is greater than or equal to 160 MHz and less than or equal to 500 MHz.

In an embodiment, at a resonance point of the first resonance, currents on radiators 210 on two sides of the first slot are co-directional, and co-directional currents are distributed on each of the radiators 210 on the two sides of the first slot (in other words, there is no current reversal point on the radiator). At a resonance point of the second resonance, the currents on the radiators 210 on the two sides of the first slot are co-directional, and co-directional currents are distributed on each of the radiators 210 on the two sides of the first slot (in other words, there is no current reversal point on the radiator).

It should be understood that, that the currents are co-directional may be understood as that the currents flow from one end to the other end. For example, the current on the radiator 210 flows from the first position 201 (the first end) to the second position 202 (the second end), or flows from the second position 202 (the second end) to the first position 201 (the first end). Alternatively, that the currents are co-directional may be understood as that the currents are co-directionally distributed on a current flow path, and there is no current reversal point. For brevity of description, that the currents are co-directional mentioned in embodiments of this application may be correspondingly understood.

It should be understood that the first resonance and the second resonance may be considered as being generated in a slot CM mode. Because the slot CM mode has higher radiation efficiency and total efficiency, the antenna has better radiation efficiency and total efficiency in the operating frequency band formed by the first resonance and the second resonance.

In an embodiment, at a resonance point of the first resonance, currents distributed on the feed member 221 are co-directional currents. At a resonance point of the second resonance, the currents distributed on the feed member 221 are co-directional currents.

It should be understood that the current on the feed member 221 may be generated in a wire DM mode. The radiator 210 generates co-directional currents through co-directional current coupling on the feed member 221, to generate the second resonance.

In an embodiment, a width of the first slot is greater than or equal to 0.1 mm and less than or equal to 2 mm. It should be understood that, in this embodiment of this application, a width of a slot provided in the side frame may fall within the foregoing range. For brevity of description, details are not described again.

In an embodiment, a proportion of a length of an overlapping part between the radiator 210 and a projection of the feed member 221 on the side frame 11 to a length of the radiator 210 is greater than or equal to 25%. In an embodiment, a proportion of a length of an overlapping part between the radiator 210 and a projection of the feed member 221 on the side frame 11 to a length of the radiator 210 is greater than or equal to 50%.

In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 50%. In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 75%.

It should be understood that when a proportion of a length of a projection to the length of the feed member 221 (or a proportion of a length of a projection to the length of the radiator 210) falls within the foregoing range, the radiator 210 can be better excited, and the antenna 200 has a better radiation characteristic. When the first position 201 and the second position 202 are respectively located on the first side and the second side that are of the side frame and that intersect at an angle, the extension direction of the radiator 210 includes the extension direction (for example, the x direction) of the first side and the extension direction (for example, the y direction) of the second side. The length of the overlapping part may be understood as a sum of a length of an overlapping part in the extension direction (for example, the x direction) of the first side and a length of an overlapping part in the extension direction (for example, the y direction) of the second side.

In an embodiment, lengths of radiators on the two sides of the first slot are approximately the same, and a proportion of the lengths of the radiators on the two sides of the first slot (a length of a conductor part of the side frame between the first position 201 and the first slot and a length of a conductor part of the side frame between the second position 202 and the first slot) is greater than or equal to 0.7 and less than or equal to 1.3.

It should be understood that when the lengths of the radiators on the two sides of the first slot are approximately the same, a structure of the antenna 200 is more symmetrical. Increasing symmetry of the antenna 200 can better excite the slot CM mode, so that the antenna 200 can have a better radiation characteristic (for example, bandwidth and radiation efficiency) in the first resonance and the second resonance.

In an embodiment, a distance between a projection of the first slot on the feed member 221 and a center of the feed member 221 is less than or equal to a quarter of the length of the feed member 221. In an embodiment, the projection of the first slot on the feed member 221 is in a central area of the feed member 221.

It should be understood that when the feed member 221 and the radiator 210 are approximately aligned, a structure of the antenna 200 is more symmetrical. Increasing symmetry of the antenna 200 can better excite the slot CM mode, so that the antenna 200 has a better radiation characteristic (for example, bandwidth and radiation efficiency) in the first resonance and the second resonance. That the feed member 221 and the radiator 210 are aligned may be understood as that the first radiator 210 is symmetrical along a virtual axis of the feed member 221, and lengths of feed members 221 on two sides of the virtual axis are the same.

In addition, the radiator 210 has a weaker current and a stronger electric field in an area near the first slot. The feed member 221 has a weaker electric field and a stronger current in an area near the center. The area (the first slot) with a stronger electric field (a stronger magnetic field) of the radiator 210 is close to the area (a midpoint) with a weaker electric field (a stronger magnetic field) of the feed member 221, so that the first resonance and the second resonance can be more balanced.

In an embodiment, the feed member 221 includes a connection point 241. The antenna 200 may further include an electronic element 242. A first end of the electronic element 242 is coupled to the connection point 241, and a second end of the electronic element 242 is coupled to the ground plane 300. In an embodiment, a distance between the connection point 241 and the second end of the feed member 221 is less than one third of a length of the feed member 221.

It should be understood that the electronic element 242 may be configured to increase symmetry of the antenna 200. Increasing the symmetry of the antenna 200 can better excite the slot CM mode, so that the antenna 200 can have a better radiation characteristic (for example, bandwidth and radiation efficiency) in the first resonance and the second resonance. In an embodiment, the feed point 211 and the connection point 241 are symmetrical along a virtual axis of the feed member 221, and lengths of feed members 221 on the two sides of the virtual axis are the same. In an embodiment, the electronic element may be a capacitor.

In an embodiment, a projection of the feed member 221 on the side frame 11 completely overlaps the radiator 210. In an embodiment, a proportion of lengths of radiators on the two sides of the first slot is greater than or equal to 0.9 and less than or equal to 1.1. In an embodiment, two ends of the radiator 210 are coupled to the ground plane 300 in a same manner (for example, the side frame 11 is coupled to the ground plane 300 at both the first position 201 and the second position 202 through inductors, or is coupled to the ground plane 300 through connecting ribs). In an embodiment, the projection of the first slot on the feed member 221 coincides with the center of the feed member 221.

In an embodiment, the projection of the feed member 221 on the side frame 11 is located between the first position 201 and the second position 202.

It should be understood that increasing the symmetry of the antenna 200 can better excite the slot CM mode, so that the antenna 200 can have a better radiation characteristic (for example, bandwidth and radiation efficiency) in the first resonance and the second resonance.

In an embodiment, the second end of the feed member 221 is an open end.

In an embodiment, when the electronic element 242 is located at the second end of the feed member 221, a connection the connection point 241 and the ground plane 300 cannot be equivalent to a short circuit (the connection point 241 is coupled to the ground plane). Therefore, when the electronic element 242 is a capacitor, a capacitance value of the electronic element 242 is less than a first threshold. When a frequency (for example, a center frequency of an operating frequency band) of the electrical signal fed by the feed circuit 231 is less than or equal to 1 GHz, the first threshold is 10 pF. When a frequency of the electrical signal fed by the feed circuit 231 is greater than 1 GHz and less than or equal to 2 GHz, the first threshold is 5 pF. When a frequency of the electrical signal fed by the feed circuit 231 is greater than 2 GHz and less than or equal to 3 GHz, the first threshold is 3 pF. When a frequency of the electrical signal fed by the feed circuit 231 is greater than 3 GHz, the first threshold is 2 pF.

In an embodiment, both ends of the feed member 221 are open ends, and an electrical length of the radiator 210 and an electrical length of the feed member 221 are the same, and both are a half of a first wavelength. The first wavelength is a wavelength corresponding to a center frequency between the resonance point of the first resonance and the resonance point of the second resonance.

In an embodiment, an electrical length of the radiator 210 and an electrical length of the feed member 221 are approximately the same. In an embodiment, a physical length of the radiator 210 and a physical length of the feed member 221 are approximately the same. Because an electronic element coupled to the feed member 221/radiator 210 may increase or decrease the physical length when the electrical length remains unchanged, the physical length L1 of the radiator 210 and the physical length L2 of the feed member 221 satisfy: L1×50%≤L2≤L1. In an embodiment, the physical length L1 of the radiator 210 may be less than or equal to the physical length L2 of the feed member 221, and satisfy: L1≤L2≤L1×150%.

In an embodiment, the physical length L1 of the radiator 210 may be understood as a length of a conductive part of the side frame between the first position 201 and the second position 202, for example, a sum of physical lengths of the radiators 210 on the two sides of the first slot.

In an embodiment, a distance D between the feed member 221 and the radiator 210 is less than or equal to 5 mm, so that the feed member 221 and the radiator 210 have a good coupling characteristic. In an embodiment, a distance D between the feed member 221 and the radiator 210 is less than or equal to 2 mm.

It should be understood that the distance D between the feed member 221 and the radiator 210 may be understood as a minimum value of a distance between a point on the feed member 221 and a point on the radiator 210.

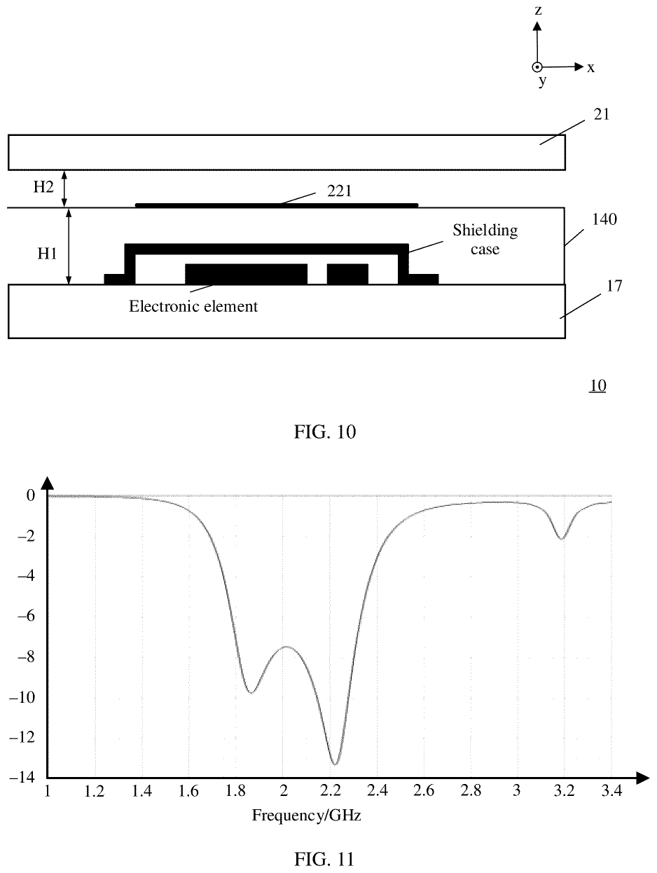

In an embodiment, the electronic device 10 may further include a bracket 140. FIG. 10 is a partial cross-sectional view of the electronic device in the first direction. For brevity of description, only a cross-section is used to show the antenna structure and a structural relationship between the bracket 140, the rear cover 21, and the PCB 17.

In an embodiment, the feed member 221 may be disposed on a surface of the bracket 140, and at least a part of the bracket 140 may be disposed between the PCB 17 and the rear cover 21, to support the feed member 221. A metal layer in the PCB 17 may be used as the ground plane 300 in this embodiment of this application. The ground plane may alternatively be the middle frame of the electronic device or another metal layer.

In an embodiment, the feed member 221 on the bracket 140 may be located above the PCB 17. For example, a projection of the feed member 221 on the PCB 17 completely overlaps the PCB 17. In an embodiment, another electronic element may be further disposed between the bracket 140 and the PCB 17. To avoid mutual interference between the electronic element and the feed member 221, the electronic element may be disposed in a metal shielding case. In an embodiment, the feed member 221 on the bracket 140 may be located at an edge of the PCB 17. For example, a projection of the feed member 221 on the PCB 17 partially overlaps a conductive component on the PCB 17. For another example, a projection of the feed member 221 on the PCB 17 coincides with an outer edge of a conductive component on the PCB 17 or is within a range of 10 mm inside an outer edge. In an embodiment, the feed member 221 on the bracket 140 may be located above a hollow area (for example, a non-conductive part) of the PCB 17 or above a gap between the PCB 17 and the side frame. For example, a projection of the feed member 221 on the PCB 17 does not overlap the PCB 17.

In an embodiment, a distance H1 between the bracket 140 and the PCB 17 may be greater than or equal to 0.1 mm and less than or equal to 3 mm. In an embodiment, a distance H2 between the bracket 140 and the rear cover 21 may be greater than or equal to 0.1 mm and less than or equal to 1 mm.

In an embodiment, the feed member 221 may be disposed on a surface of the rear cover 21 (for example, a surface facing the PCB 17). In an embodiment, the feed member 221 may alternatively be disposed on a surface of the PCB 17. A disposing position of the feed member 221 is not limited in embodiments of this application.

It should be understood that, for brevity of description, in the technical solutions shown in FIG. 9 and FIG. 10, the conductive part of the side frame 11 is used as the radiator 210, and the feed member 221 is of a non-side-frame structure (for example, disposed on the bracket, the PCB, or the rear cover). In actual production or design, relative positions of the radiator 210 and the feed member 221 may be interchanged. For example, the conductive part of the side frame 11 is used as the feed member 221, and the radiator 210 is of a non-side-frame structure (for example, disposed on the bracket, the PCB, or the rear cover).

It should be understood that, for brevity of description, in this embodiment of this application, only an example in which the feed member 221 is located on the ground plane 300 (the feed member 221 completely overlaps the ground plane 300 in a z direction) is used. In actual production or design, the feed member 221 partially overlaps the ground plane 300 in the z direction, or the feed member 221 does not overlap the ground plane 300 in the z direction. This is not limited in embodiments of this application.

In this embodiment of this application, both the feed member 221 and the radiator 210 are used as radiators to participate in a radiation mode of the antenna.

In an embodiment, the feed member 221 is bar-shaped. The “bar shape” may be understood as that a length is much greater than a width. For example, the length is greater than three times or six times the width. In an embodiment, a smallest dimension in three-dimensional dimensions of the feed member 221 is a thickness. For example, when the feed member 221 may be disposed on the surface of the bracket 140, a dimension in a direction perpendicular to the surface of the bracket 140 is the thickness. Dimensions other than the thickness in the three-dimensional dimensions of the feed member 221 may be understood as a length and a width.

In an embodiment, the width of the feed member 221 may be less than or equal to 3 mm. In an embodiment, the width of the feed member 221 may be less than or equal to 2 mm.

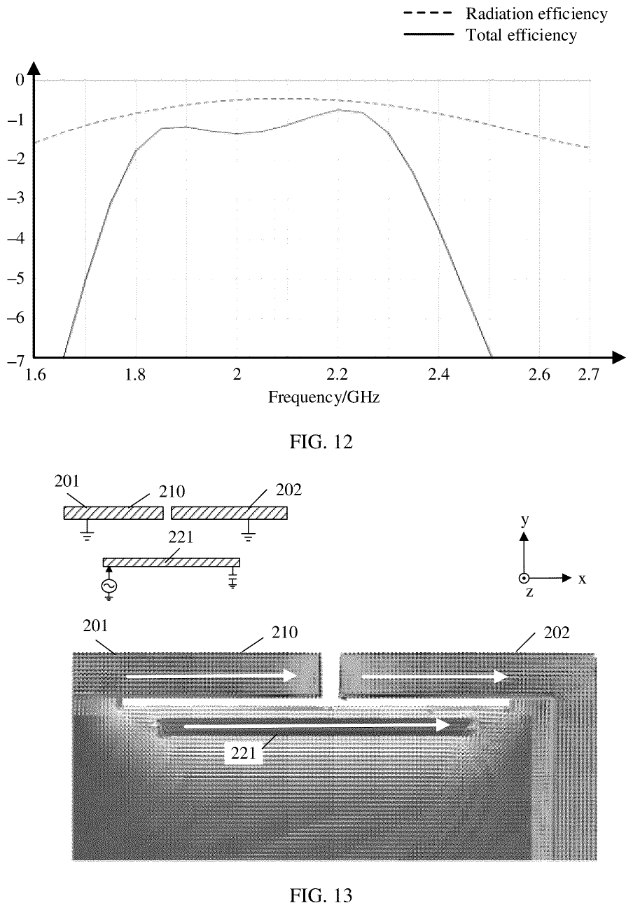

FIG. 11 and FIG. 12 show simulation results of the antenna 200 in the electronic device 10 shown in FIG. 9. FIG. 11 shows a simulation result of an S parameter of the antenna 200 in the electronic device 10 shown in FIG. 9. FIG. 12 shows simulation results of total efficiency and radiation efficiency of the antenna 200 in the electronic device 10 shown in FIG. 9.

It should be understood that, in the foregoing simulation results, only the following parameters are used as an example for description: A distance between the first slot and the first position is 14 mm, a distance between the first slot and the second position is 12 mm, a distance between the feed member and the radiator is 1.8 mm, a distance between the bracket and the PCB is 0.9 mm, a width of the feed member is 1.5 mm, a length of the feed member is 23 mm, and a capacitance value of the electronic element is 1 pF.

As shown in FIG. 11, the antenna 200 may generate a resonance near 1.87 GHz, a resonance near 2.23 GHz, and a resonance near 3.19 GHz, but resonance excitation near 3.19 GHz is weakest. The resonance generated near 1.87 GHz may correspond to the first resonance in the foregoing embodiment, and the resonance generated near 2.23 GHz may correspond to the second resonance in the foregoing embodiment. The resonance generated near 3.19 GHz may correspond to a resonance generated in a slot DM mode.

It should be understood that, for brevity of description, only an example in which a resonance point frequency of the first resonance is lower than a resonance point frequency of the second resonance is used for description. In actual production, the resonance point frequency of the first resonance may alternatively be higher than the resonance point frequency of the second resonance.

As shown in FIG. 12, both the first resonance and the second resonance may be generated in the slot CM mode. Because the slot CM mode has higher radiation efficiency and total efficiency, the antenna does not generate a dip in the operating frequency band formed by the first resonance and the second resonance, and has better radiation efficiency and total efficiency. For example, when total efficiency is greater than −2 dB, a total efficiency bandwidth of the antenna 200 is approximately 530 MHz.

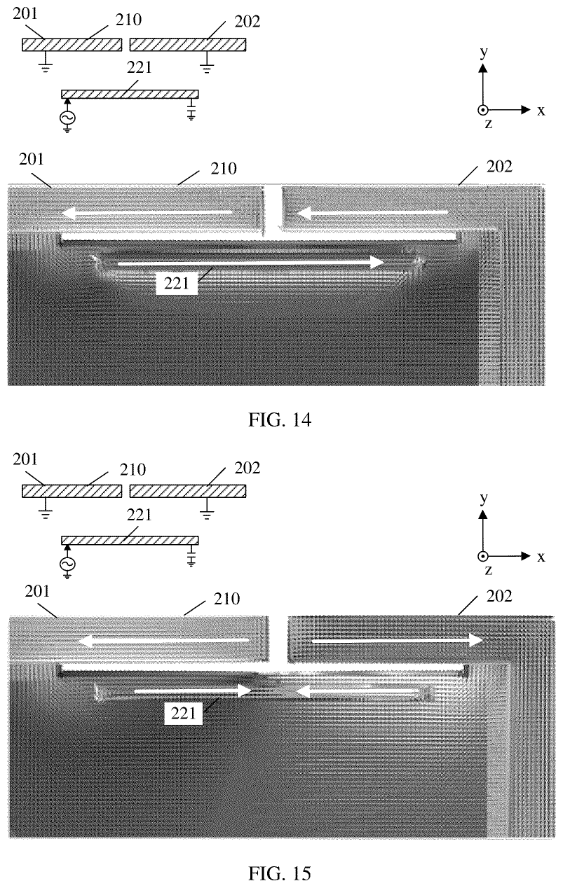

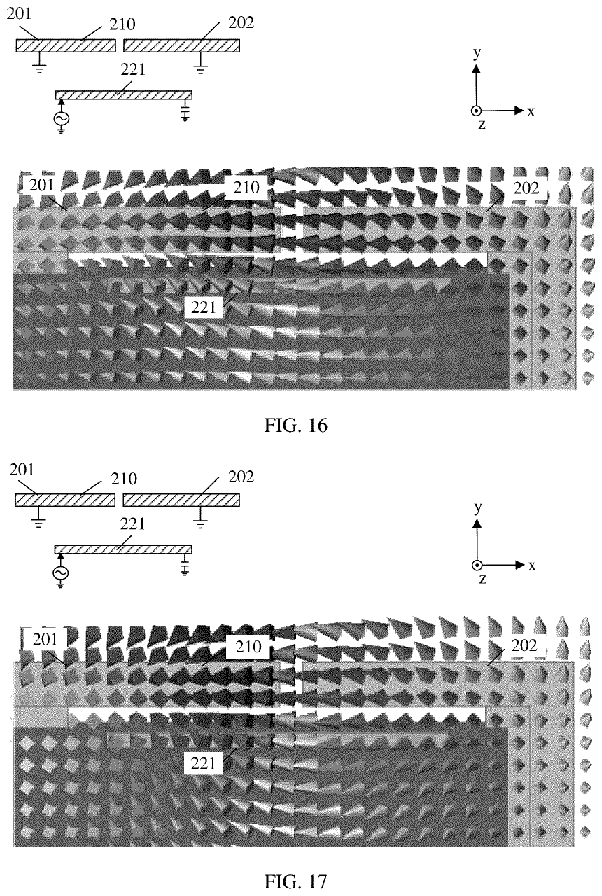

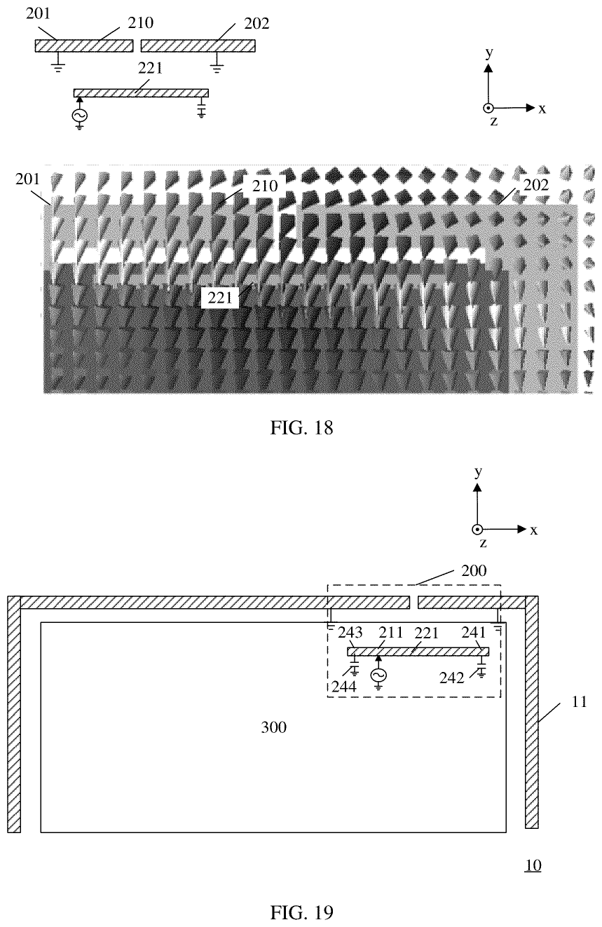

FIG. 13 to FIG. 18 are diagrams of current and electric field distribution of the antenna 200 in the electronic device 10 shown in FIG. 9. FIG. 13 is a diagram of current distribution of the antenna shown in FIG. 9 at a resonance point (1.87 GHz) of the first resonance. FIG. 14 is a diagram of current distribution of the antenna shown in FIG. 9 at a resonance point (2.23 GHz) of the second resonance. FIG. 15 is a diagram of current distribution of the antenna shown in FIG. 9 at 3.19 GHz. FIG. 16 is a diagram of electric field distribution of the antenna shown in FIG. 9 at a resonance point (1.87 GHz) of the first resonance. FIG. 17 is a diagram of electric field distribution of the antenna shown in FIG. 9 at a resonance point (2.23 GHz) of the second resonance. FIG. 18 is a diagram of electric field distribution of the antenna shown in FIG. 9 at 3.19 GHz.

As shown in FIG. 13, currents on the radiators on the two sides of the first slot are co-directional, and currents on the feed member are co-directional. Current distribution on the radiator conforms to a current characteristic of the slot CM mode. Current distribution on the feed member conforms to a current characteristic of the wire DM mode.

As shown in FIG. 14, currents on the radiators on the two sides of the first slot are co-directional, and currents on the feed member are co-directional. Current distribution on the radiator conforms to a current characteristic of the slot CM mode. Current distribution on the feed member conforms to a current characteristic of the wire DM mode.

As shown in FIG. 15, currents on the radiators on the two sides of the first slot are reverse in direction, and currents on feed members on two sides of the center are reverse in direction. Current distribution on the radiator conforms to a current characteristic of the slot DM mode. Current distribution on the feed member conforms to a current characteristic of the wire CM mode.

As shown in FIG. 16, electric fields generated by the antenna are reverse in direction on the two sides of the first slot (respectively pointing to a positive direction and a negative direction of a z axis), and conform to an electric field characteristic of the slot CM mode.

As shown in FIG. 17, electric fields generated by the antenna are reverse in direction on the two sides of the first slot (respectively pointing to a positive direction and a negative direction of a z axis), and conform to an electric field characteristic of the slot CM mode.

As shown in FIG. 18, electric fields generated by the antenna are co-directional on the two sides of the first slot (both pointing to a positive direction of a z axis), and conform to an electric field characteristic of the slot DM mode.

FIG. 19 is a diagram of another electronic device 10 according to an embodiment of this application.

As shown in FIG. 19, a feed member 221 includes a first connection point 241 and a second connection point 243, and a feed point 211 is located between the connection point 241 and the connection point 243. An antenna 200 may further include an electronic element 242 and an electronic element 244. A first end of the electronic element 242 is coupled to the connection point 241, and a second end of the electronic element 242 is coupled to a ground plane 300. A first end of the electronic element 244 is coupled to the connection point 243, and a second end of the electronic element 244 is coupled to the ground plane 300.

In an embodiment, the connection point 241 is located at a second end of the feed member 221, and the connection point 243 is located at a first end of the feed member 221. When an electrical length of the feed member 221 remains unchanged, the electronic element 242 and the electronic element 244 may be configured to reduce a physical length of the feed member 221 to implement miniaturization. In an embodiment, a distance between the connection point 241 and an end part of the second end of the feed member 221 is less than or equal to 3 mm. In an embodiment, a distance between the connection point 243 and an end part of the first end of the feed member 221 is less than or equal to 3 mm.

In an embodiment, when the electronic element 242 and the electronic element 244 are disposed, a physical length L1 of the radiator 210 and a physical length L2 of the feed member 221 satisfy: L1×70%≤L2≤L1×90%.

It should be understood that a difference between the antenna 200 shown in FIG. 19 and the antenna 200 shown in FIG. 9 includes disposing of the electronic element 244 and the electronic element 242.

In an embodiment, when the electronic element 242 and the electronic element 244 are capacitors, a capacitance value of the electronic element 242 and a capacitance value of the electronic element 244 are less than a first threshold. When a frequency of an electrical signal fed by the feed circuit 231 is less than or equal to 1 GHz, the first threshold is 10 pF. When a frequency of an electrical signal fed by the feed circuit 231 is greater than 1 GHz and less than or equal to 2 GHz, the first threshold is 5 pF. When a frequency of an electrical signal fed by the feed circuit 231 is greater than 2 GHz and less than or equal to 3 GHz, the first threshold is 3 pF. When a frequency of an electrical signal fed by the feed circuit 231 is greater than 3 GHz, the first threshold is 2 pF.

In an embodiment, the capacitance value of the electronic element 242 may be the same as or different from the capacitance value of the electronic element 244. This is not limited in embodiments of this application.

For brevity of description, similar parts between the antenna 200 shown in FIG. 19 and the antenna 200 shown in FIG. 9 are not described one by one again. For example, the similar parts include: a position of the radiator 210 and a position relationship between the radiator 210 and the feed member 221; the radiator 210 and the feed member 221 are configured to generate the first resonance and the second resonance; the first resonance and the second resonance may be used to jointly support one operating frequency band; a provided position and a width of the first slot; a boundary condition (an open end or a ground end) of the feed member 221; a shape of the feed member 221, for example, a bar shape; a position at which the feed member 221 is disposed; and the like.

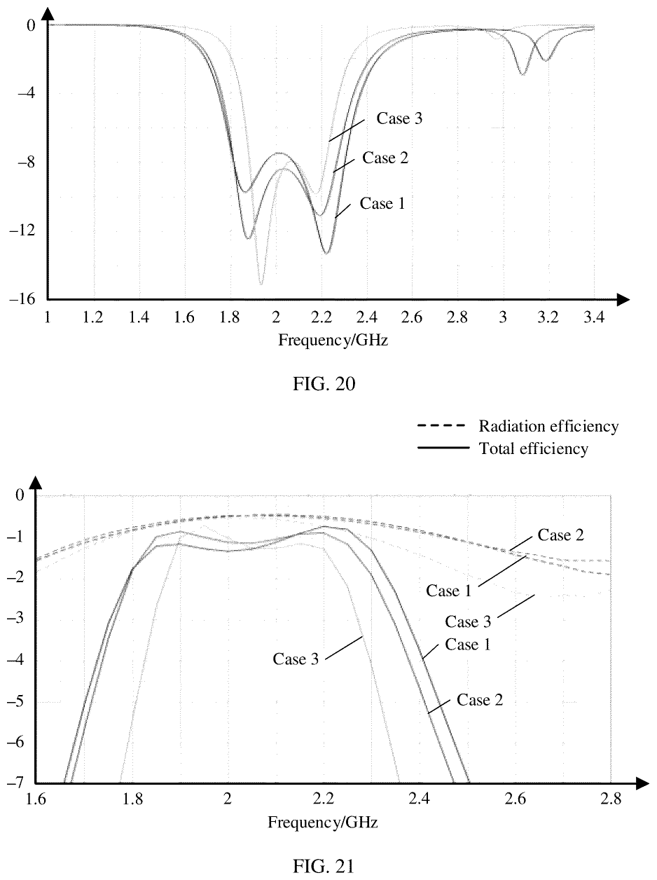

FIG. 20 and FIG. 21 show simulation results of the antenna 200 in the electronic device 10 shown in FIG. 19 in different cases. FIG. 20 shows simulation results of an S parameter of the antenna 200 in the electronic device 10 shown in FIG. 19 in different cases. FIG. 21 shows simulation results of total efficiency and radiation efficiency of the antenna 200 in the electronic device 10 shown in FIG. 19 in different cases.

It should be understood that, in the foregoing simulation results, sizes of radiators are the same, widths of feed members are 1 mm, and simulation results of the antenna 200 are shown when feed members have different physical lengths and distances between the feed members and the radiators are different.

Case 1: For the antenna shown in FIG. 9, no electronic element 244 is disposed, a distance between the feed member and the radiator is 1.8 mm, a length of the feed member is 23 mm, and a capacitance value of the electronic element 242 is 1 pF.

Case 2: For the antenna shown in FIG. 19, a distance between the feed member and the radiator is 1.2 mm, a length of the feed member is 15 mm, a capacitance value of the electronic element 242 is 1.5 pF, and a capacitance value of the electronic element 244 is 0.7 pF.

Case 3: For the antenna shown in FIG. 19, a distance between the feed member and the radiator is 0.6 mm, a length of the feed member is 7 mm, a capacitance value of the electronic element 242 is 3.6 pF, and a capacitance value of the electronic element 244 is 2 pF.

As shown in FIG. 20, the antennas in Case 1, Case 2, and Case 3 each may generate a resonance near 1.9 GHz (the first resonance) and a resonance near 2.2 GHz. However, as the length of the feed member decreases, in a case of using a boundary that S11 is less than −4 dB, an operating bandwidth of the antenna gradually decreases.

As shown in FIG. 21, both the first resonance and the second resonance in each of Case 1, Case 2, and Case 3 may be generated in a slot CM mode, and the antenna does not generate a dip in an operating frequency band formed by the first resonance and the second resonance, and has better radiation efficiency and total efficiency. However, as the length of the feed member decreases, for example, total efficiency is greater than −2 dB, a total efficiency bandwidth of the antenna 200 gradually decreases.

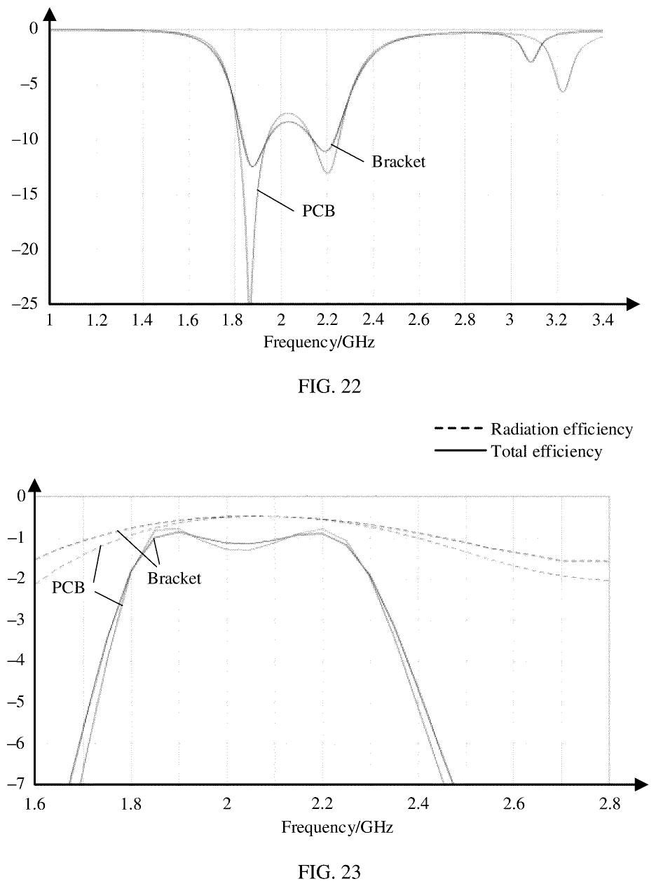

FIG. 22 and FIG. 23 show simulation results of the antenna in the electronic device 10 shown in FIG. 19 when the feed member is disposed at different positions. FIG. 20 shows a simulation result of an S parameter of the antenna in the electronic device 10 shown in FIG. 19 when the feed member is disposed at different positions. FIG. 21 shows simulation results of total efficiency and radiation efficiency of the antenna in the electronic device 10 shown in FIG. 19 when the feed member is disposed at different positions.

It should be understood that, in the foregoing embodiment, only an example in which the feed member is disposed on a bracket is used for description. In the simulation results shown in FIG. 22 and FIG. 23, simulation results of the antenna when the feed member is disposed on the bracket or a PCB are shown. Compared with disposing the feed member on a surface of the bracket, disposing the feed member on the PCB (for example, a thickness of the PCB is 0.7 mm) forms a microstrip structure. A resonance point frequency of the first resonance and a resonance point frequency of the second resonance may be adjusted by adjusting a distance between the microstrip structure and the radiator, the electronic element 242, the electronic element 244, and the like.

As shown in FIG. 22, when the feed member is disposed on the bracket or the PCB, the antenna may generate a resonance near 1.9 GHz (the first resonance) and a resonance near 2.2 GHz.

As shown in FIG. 23, both the first resonance and the second resonance may be generated in the slot CM mode. When the feed member is disposed on the bracket or the PCB, the antenna does not generate a dip in an operating frequency band formed by the first resonance and the second resonance, and has better radiation efficiency and total efficiency. However, when the feed member is disposed on the PCB to form the microstrip structure, radiation efficiency of the antenna slightly decreases.

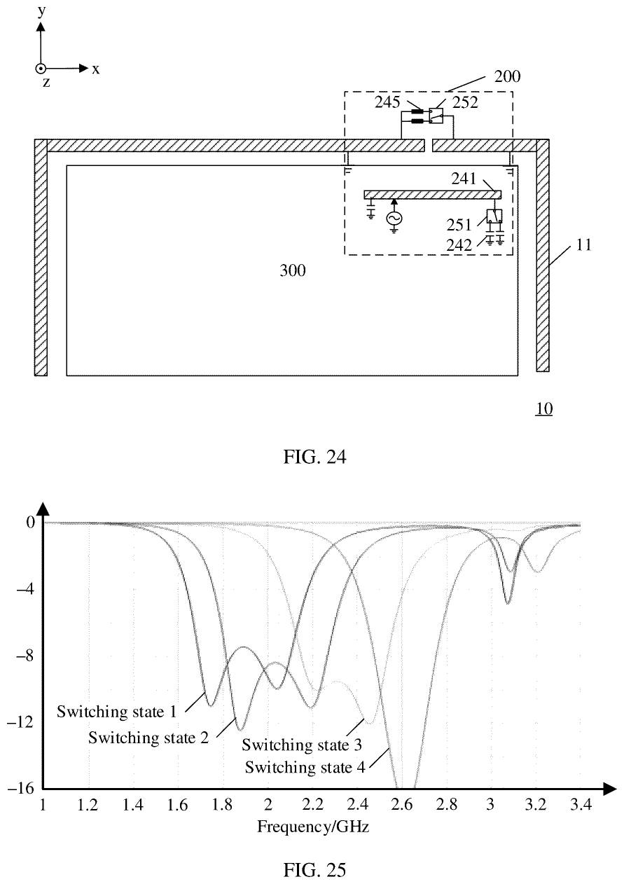

FIG. 24 is a diagram of another electronic device 10 according to an embodiment of this application.

As shown in FIG. 24, an antenna 200 may further include a switch 251 and a switch 252. The switch 251 may be connected through coupling between a connection point 241 and a ground plane 300, and may be configured to switch an electronic element 242. The switch 252 may be connected through coupling between conductors on two sides of a first slot, and is configured to switch an electronic element 245.

It should be understood that a difference between the antenna 200 shown in FIG. 24 and the antenna 200 shown in FIG. 19 lies in that the switch 251, the switch 252, and the electronic element 245 are included. The switch 251 and the switch 252 in the antenna 200 shown in FIG. 24 may switch between the electronic element 242 and the electronic element 245 that are different, to adjust a resonance point frequency of a first resonance and a resonance point frequency of a second resonance.

It should be understood that FIG. 24 may also be designed based on the overall structure in FIG. 9. A difference lies only in that the switch 252 coupled to two sides of the first slot is added, and a feed member is connected to an electronic element connected through single coupling and the switch 251.

For brevity of description, similar parts between the antenna 200 shown in FIG. 24 and the antenna 200 shown in FIG. 9 or FIG. 19 are not described one by one again. For example, the similar parts include: a position of the radiator 210 and a position relationship between the radiator 210 and the feed member 221; a proportional relationship between a physical length of the radiator 210 and a physical length of the feed member 221; the radiator 210 and the feed member 221 are configured to generate the first resonance and the second resonance; the first resonance and the second resonance may be used to jointly support one operating frequency band; a provided position and a width of the first slot; a boundary condition (an open end or a ground end) of the feed member 221; a shape of the feed member 221, for example, a bar shape; a position at which the feed member 221 is disposed; and the like.

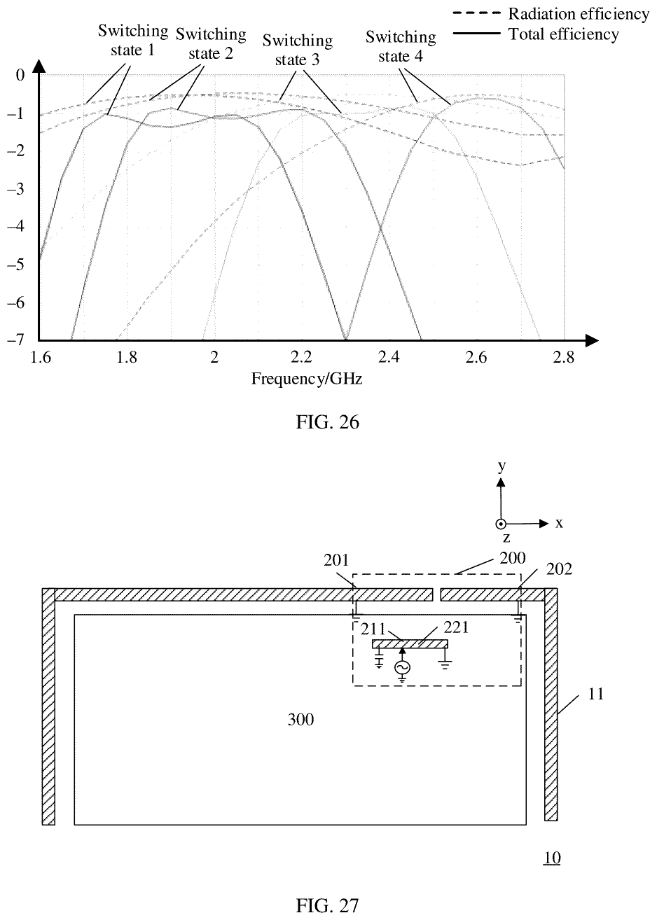

FIG. 25 and FIG. 26 show simulation results of the antenna 200 in the electronic device 10 shown in FIG. 24. FIG. 25 shows a simulation result of an S parameter of the antenna 200 in the electronic device 10 shown in FIG. 24. FIG. 26 shows simulation results of total efficiency and radiation efficiency of the antenna 200 in the electronic device 10 shown in FIG. 24.

As shown in FIG. 25, the switch 251 and the switch 252 in the antenna 200 shown in FIG. 24 may switch between the electronic element 242 and the electronic element 245 that are different, to adjust the resonance point frequency of the first resonance and the resonance point frequency of the second resonance.

It should be understood that the electronic element 242 and the electronic element 245 that are different may be switched according to different communication requirements of the electronic device 10. For brevity of description, only simulation results of four different switching states (the switching state may be understood as switching between the electronic element 242 and/or the electronic element 245 that are different) are shown in the simulation results shown in FIG. 25 and FIG. 26.

As shown in FIG. 26, the antenna has good radiation efficiency and total efficiency at different resonance point frequencies of the first resonance and the second resonance, and does not generate a dip in an operating frequency band formed by the first resonance and the second resonance.

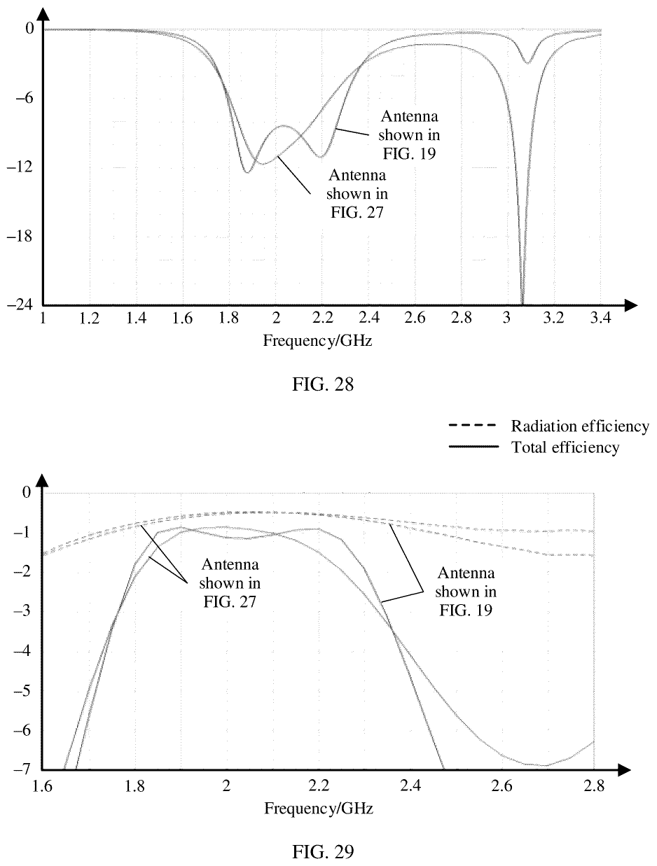

FIG. 27 is a diagram of another electronic device 10 according to an embodiment of this application.

As shown in FIG. 27, a first end of a feed member 221 is an open end, and a second end of the feed member 221 is a ground end. The second end of the feed member 221 is coupled to a ground plane 300.

In an embodiment, a distance between a feed point 211 and an end part of the first end of the feed member 221 is different from a distance between the feed point 211 and an end part of the second end of the feed member 221, and the feed member 221 may feed an electrical signal through offset feeding.

In an embodiment, the feed point 211 may be located at the first end of the feed member 221. In an embodiment, the distance between the feed point 211 and the end part of the first end of the feed member 221 is less than or equal to 3 mm, and the feed member 221 may feed an electrical signal through side feeding.

In an embodiment, a distance between the feed point 211 and an end part of the first end of the feed member 221 is greater than a half of a length of the feed member 221. The feed member 221 may form a structure similar to a left-handed antenna. The left-handed antenna may be, for example, an antenna that conforms to a composite right and left hand (composite right and left hand, CRLH) transmission line structure.

It should be understood that a difference between the antenna 200 shown in FIG. 27 and the antenna 200 shown in FIG. 19 includes that the second end of the feed member 221 is a ground end.

In the antenna 200 shown in FIG. 19, the first end and the second end of the feed member 221 are open ends, and the feed member 221 forms a radiator structure that conforms to a dipole antenna. In the antenna 200 shown in FIG. 27, the first end of the feed member 221 is an open end, the second end of the feed member 221 is a ground end, and the feed member 221 may form a structure similar to a monopole antenna or a left-handed antenna. When an electrical signal is fed at the feed point, co-directional currents may also be generated on the radiator 210, which are similar to currents on the feed member 221 shown in FIG. 19, and the radiator 210 may also be excited to generate a resonance. In addition, because the first end of the feed member 221 is an open end and the second end of the feed member 221 is a ground end, a size of the feed member 221 can be further reduced (for example, the feed member 221 can be considered as being reduced from a half-wavelength structure to a quarter-wavelength structure), to implement miniaturization.

In an embodiment, a distance between a projection of a first slot on the feed member 221 and the ground end (a ground point at the second end) of the feed member 221 is less than or equal to a half of the length of the feed member 221. In an embodiment, a distance between a projection of the ground end (the ground point at the second end) of the feed member 221 on the side frame 11 and the first slot is less than or equal to a quarter of a length of the radiator 210.

It should be understood that the radiator 210 has a weaker current and a stronger electric field in an area near the first slot. An area near the ground end of the feed member 221 has a weaker electric field and a stronger current. The area (the first slot) with a stronger electric field (a stronger magnetic field) of the radiator 210 is close to the area (the ground end) with a weaker electric field (a stronger magnetic field) of the feed member 221, so that the first resonance and the second resonance can be more balanced.

In an embodiment, a projection of the feed member 221 on the side frame 11 is located between a first position and a second position.

In an embodiment, a proportion of a length of an overlapping part between the radiator 210 and a projection of the feed member 221 on the side frame 11 to a length of the radiator 210 is greater than or equal to 12.5%. In an embodiment, a proportion of a length of an overlapping part between the radiator 210 and a projection of the feed member 221 on the side frame 11 to a length of the radiator 210 is greater than or equal to 25%.

In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 50%.

In an embodiment, an electrical length of the feed member 221 is a quarter of a first wavelength, an electrical length of the radiator 210 is a half of the first wavelength, and the first wavelength is a wavelength corresponding to a center frequency between a resonance point of the first resonance and a resonance point of the second resonance.

In an embodiment, the electrical length of the feed member 221 is a half of the electrical length of the radiator 210. In an embodiment, a physical length of the feed member 221 is approximately a half of a physical length of the radiator 210. Because an electronic element coupled to the feed member 221/radiator 210 may increase or decrease the physical length when the electrical length remains unchanged, the physical length L1 of the radiator 210 and the physical length L2 of the feed member 221 satisfy: L1×25%≤L2≤L1×50%. In an embodiment, a physical length L1 of the radiator 210 and a physical length L2 of the feed member 221 satisfy: L1×35%≤L2≤L1×75%.

For brevity of description, similar parts between the antenna 200 shown in FIG. 27 and the antenna 200 shown in FIG. 9 are not described one by one again. For example, the similar parts include: The radiator 210 and the feed member 221 are configured to generate the first resonance and the second resonance; the first resonance and the second resonance may be used to jointly support one operating frequency band; a provided position and a width of the first slot; a shape of the feed member 221, for example, a bar shape; a position at which the feed member 221 is disposed; and the like.

It should be understood that the feed members shown in the antenna 200 (for example, FIG. 9, FIG. 19, and FIG. 24) shown in the foregoing embodiments may all use a structure in which the first end is an open end and the second end is a ground end, to reduce a size. This is not limited in embodiments of this application.

In addition, in the antenna 200 shown in FIG. 27, the switch structure shown in FIG. 24 may also be used. For example, the switch may be coupled on two sides of the first slot, and a switch may be coupled between the first end of the feed member 221 and the ground plane. This is not limited in embodiments of this application, and may be correspondingly understood in embodiments of this application. Details are not described one by one again.

FIG. 28 and FIG. 29 show simulation results of the antenna 200 in the electronic device 10 shown in FIG. 27. FIG. 28 shows a simulation result of an S parameter of the antenna 200 in the electronic device 10 shown in FIG. 27. FIG. 29 shows simulation results of total efficiency and radiation efficiency of the antenna 200 in the electronic device 10 shown in FIG. 27.

As shown in FIG. 28, compared with the antenna shown in FIG. 19, the antenna shown in FIG. 27 may also generate a resonance near 1.9 GHz and a resonance near 2.2 GHz (resonance point frequencies of the two resonances are close, and therefore, the two resonances are combined into one resonance). However, because the first end of the feed member in the antenna shown in FIG. 27 is an open end and the second end of the feed member is a ground end, symmetry of a structure of the antenna is poor. In this case, an operating bandwidth of the antenna is narrow, and excitation near 3.1 GHz is enhanced by using a slot DM mode.

As shown in FIG. 29, the antenna does not generate a dip in an operating frequency band formed by the first resonance and the second resonance, and has better radiation efficiency and total efficiency.

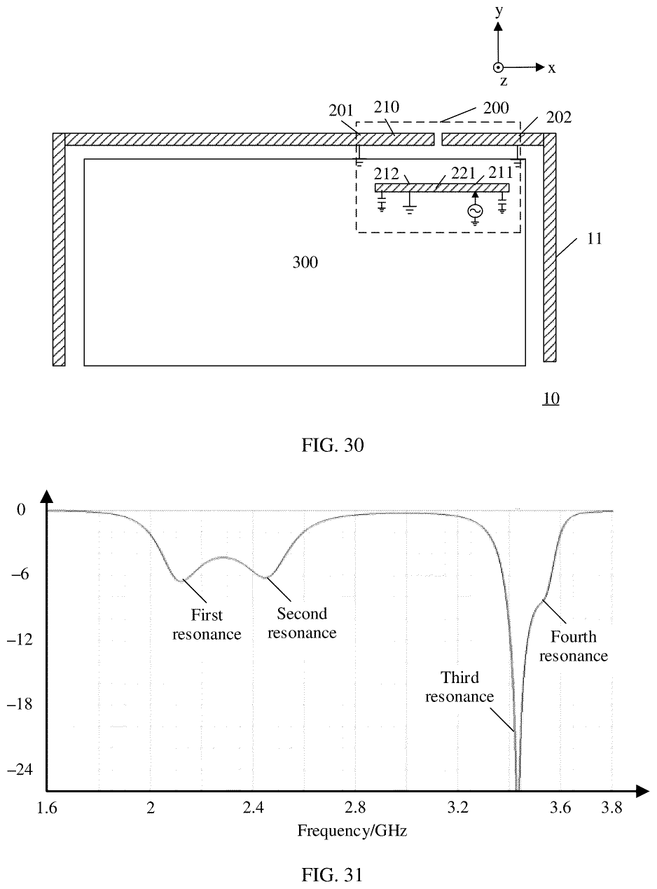

FIG. 30 is a diagram of another electronic device 10 according to an embodiment of this application.

As shown in FIG. 30, a first end of a feed member 221 is an open end, and a second end of the feed member 221 is an open end. The feed member 221 includes a ground point 212. The ground point 212 is coupled to a ground plane 300.

In an embodiment, the feed point 211 may be located at the first end or the second end of the feed member 221. In an embodiment, a distance between the feed point 211 and an end part of the first end or the second end of the feed member 221 is less than or equal to 3 mm, and the feed member 221 may feed an electrical signal through side feeding.

In an embodiment, lengths of feed members 221 on two sides of the ground point 212 are different, and the feed member 221 forms an asymmetric T-shaped structure. In an embodiment, that the lengths of the feed members 221 on the two sides of the ground point 212 are different may be understood as that a difference between the lengths of the feed member 221 on the two sides of the ground point 212 is greater than or equal to 5 mm.

It should be understood that a difference between the antenna 200 shown in FIG. 30 and the antenna 200 shown in FIG. 19 includes that the feed member 221 further includes the ground point 212, and the ground point 212 is coupled to the ground plane 300.

It should be understood that the feed member of the asymmetric T-shaped structure in FIG. 30 may be further used in the antenna 200 (for example, FIG. 9, FIG. 19, FIG. 24, and FIG. 27) shown in the foregoing embodiments.

For brevity of description, similar parts between the antenna 200 shown in FIG. 30 and the antenna 200 shown in FIG. 9 are not described one by one again. For example, the similar parts include: a position of the radiator 210 and a position relationship between the radiator 210 and the feed member 221; the radiator 210 and the feed member 221 are configured to generate the first resonance and the second resonance; the first resonance and the second resonance may be used to jointly support one operating frequency band; a provided position and a width of the first slot; a boundary condition (an open end or a ground end) of the feed member 221; a shape of the feed member 221, for example, a bar shape; a position at which the feed member 221 is disposed; and the like.

In the antenna 200 shown in FIG. 30, the feed member 221 may have both a wire DM mode and a wire CM mode. When the feed circuit 231 feeds the electrical signal, the antenna 200 may generate a first resonance, a second resonance, a third resonance, and a fourth resonance, to expand an operating bandwidth of the antenna 200.

In an embodiment, the first resonance and the second resonance may correspond to a slot CM mode, and the third resonance and the fourth resonance may correspond to a slot DM mode.

It should be understood that a greater or smaller ratio of the lengths of the feed members 221 on the two sides of the ground point 212 (approximately deviating from a center of the feed member 221) indicates a greater frequency difference between the first resonance (the second resonance) and the third resonance (the fourth resonance).

In an embodiment, at a resonance point of the first resonance, currents on radiators 210 on two sides of the first slot are co-directional, and co-directional currents are distributed on each of the radiators 210 on the two sides of the first slot (in other words, there is no current reversal point on the radiator). At a resonance point of the second resonance, the currents on the radiators 210 on the two sides of the first slot are co-directional, and co-directional currents are distributed on each of the radiators 210 on the two sides of the first slot (in other words, there is no current reversal point on the radiator).

In an embodiment, at a resonance point of the third resonance, the currents on the radiators 210 on the two sides of the first slot are reverse in direction, and a reverse current is distributed on each of the radiators 210 on the two sides of the first slot (in other words, there is a current reversal point on the radiator). At a resonance point of the fourth resonance, the currents on the radiators 210 on the two sides of the first slot are reverse in direction, and a reverse current is distributed on each of the radiators 210 on the two sides of the first slot (in other words, there is a current reversal point on the radiator).

In an embodiment, at a resonance point of the first resonance, currents on the feed member 221 are co-directional; and at a resonance point of the second resonance, the currents on the feed member 221 are co-directional. In addition, at a resonance point of the first resonance, co-directional currents are distributed on each of the feed members 221 on the two sides of the ground point 212 (in other words, the feed member 221 has no current reversal point).

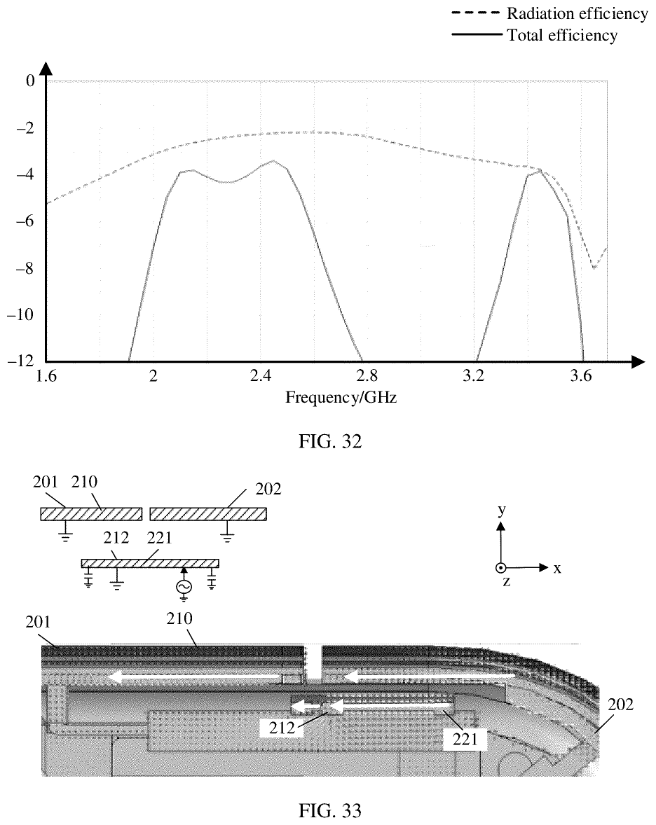

FIG. 31 and FIG. 32 show simulation results of the antenna 200 in the electronic device 10 shown in FIG. 30. FIG. 31 shows a simulation result of an S parameter of the antenna 200 in the electronic device 10 shown in FIG. 9. FIG. 32 shows simulation results of total efficiency and radiation efficiency of the antenna 200 in the electronic device 10 shown in FIG. 30.

As shown in FIG. 31, the antenna 200 may generate a resonance near 2.1 GHz, a resonance near 2.4 GHz, a resonance near 3.4 GHz, and a resonance near 3.5 GHz. The resonance generated near 2.1 GHz may correspond to the first resonance in the foregoing embodiment, and the resonance generated near 2.4 GHz may correspond to the second resonance in the foregoing embodiment. The resonance generated near 3.4 GHz may correspond to the third resonance in the foregoing embodiment, and the resonance generated near 3.5 GHz may correspond to the fourth resonance in the foregoing embodiment.

As shown in FIG. 32, both the first resonance and the second resonance may be generated in the slot CM mode, and both the third resonance and the fourth resonance may be generated in the slot DM mode. Because the slot CM mode has higher radiation efficiency and total efficiency than the slot DM mode, radiation efficiency and total efficiency of the antenna in an operating frequency band formed by the first resonance and the second resonance are better than radiation efficiency and total efficiency of an operating frequency band formed by the third resonance and the fourth resonance.

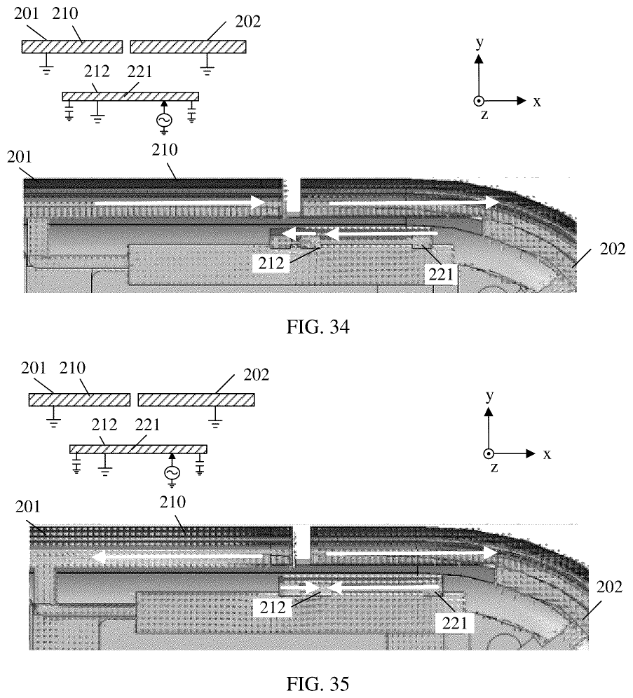

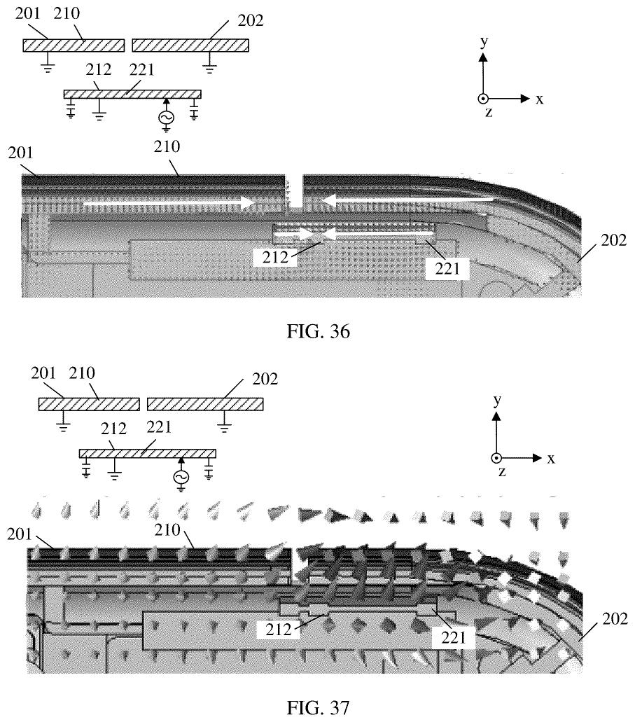

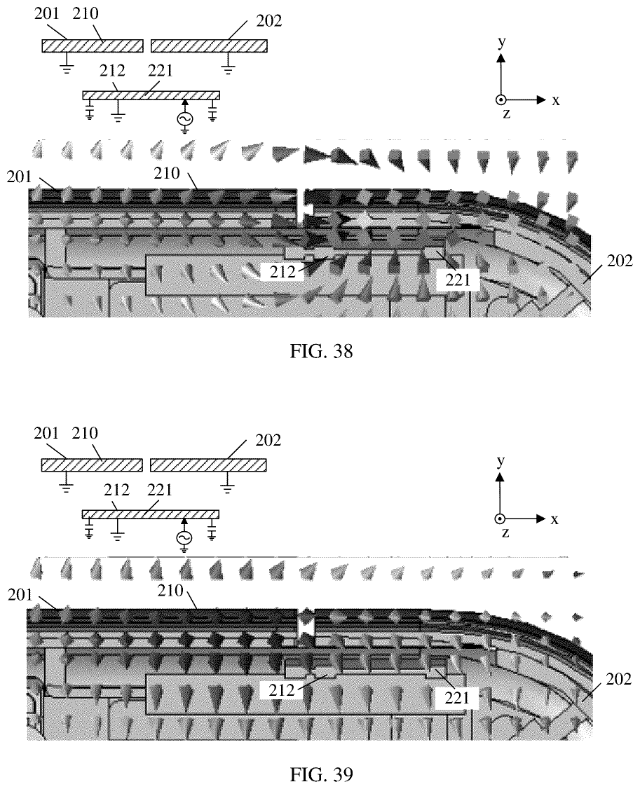

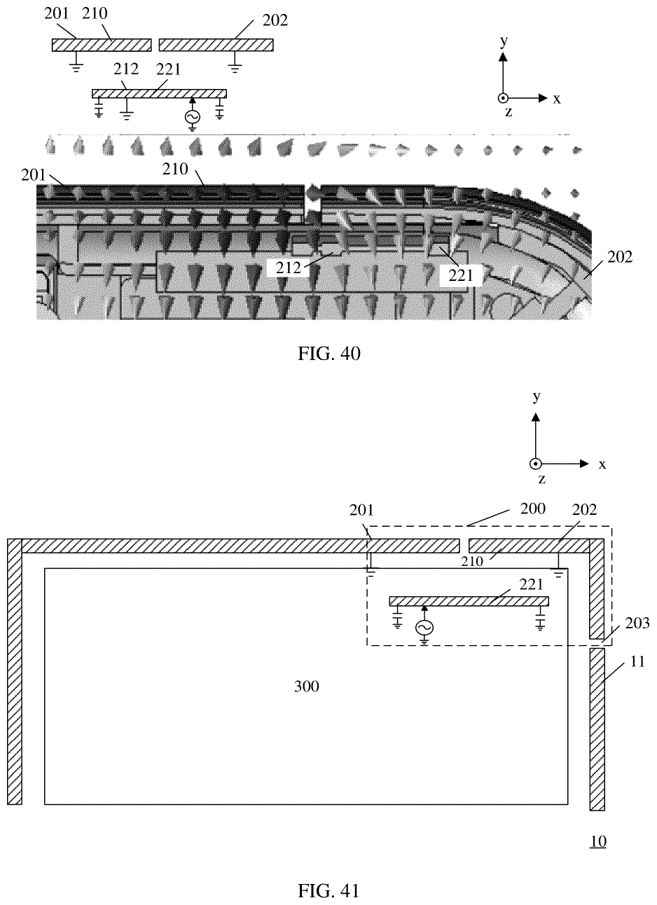

FIG. 33 to FIG. 40 are diagrams of current and electric field distribution of the antenna 200 in the electronic device 10 shown in FIG. 30. FIG. 33 is a diagram of current distribution of the antenna shown in FIG. 30 at a resonance point (2.12 GHz) of the first resonance. FIG. 34 is a diagram of current distribution of the antenna shown in FIG. 30 at a resonance point (2.45 GHz) of the second resonance; FIG. 35 is a diagram of current distribution of the antenna shown in FIG. 30 at a resonance point (3.43 GHz) of the third resonance; FIG. 36 is a diagram of current distribution of the antenna shown in FIG. 30 at a resonance point (3.54 GHz) of the fourth resonance; FIG. 37 is a diagram of electric field distribution of the antenna shown in FIG. 30 at a resonance point (2.12 GHz) of the first resonance; FIG. 38 is a diagram of electric field distribution of the antenna shown in FIG. 30 at a resonance point (2.45 GHz) of the second resonance; FIG. 39 is a diagram of electric field distribution of the antenna shown in FIG. 30 at a resonance point (3.43 GHz) of the third resonance. FIG. 40 is a diagram of electric field distribution of the antenna shown in FIG. 30 at a resonance point (3.54 GHz) of the fourth resonance.

As shown in FIG. 33, currents on radiators on the two sides of the first slot are co-directional, and currents on feed members on the two sides of the ground point are co-directional. Current distribution on the radiator conforms to a current characteristic of the slot CM mode. Current distribution on the feed member conforms to a current characteristic of the wire DM mode.

As shown in FIG. 34, currents on radiators on the two sides of the first slot are co-directional, and currents on feed members on the two sides of the ground point are co-directional. Current distribution on the radiator conforms to a current characteristic of the slot CM mode. Current distribution on the feed member conforms to a current characteristic of the wire DM mode.

As shown in FIG. 35, currents on radiators on the two sides of the first slot are reverse in direction, and currents on feed members on the two sides of the ground point are reverse in direction. Current distribution on the radiator conforms to a current characteristic of the slot DM mode. Current distribution on the feed member conforms to a current characteristic of the wire CM mode.

As shown in FIG. 36, currents on radiators on the two sides of the first slot are reverse in direction, and currents on feed members on the two sides of the ground point are reverse in direction. Current distribution on the radiator conforms to a current characteristic of the slot DM mode. Current distribution on the feed member conforms to a current characteristic of the wire CM mode.

As shown in FIG. 37, electric fields generated by the antenna are reverse in direction on the two sides of the first slot (respectively pointing to a positive direction and a negative direction of a z axis), and conform to an electric field characteristic of the slot CM mode.

As shown in FIG. 38, electric fields generated by the antenna are reverse in direction on the two sides of the first slot (respectively pointing to a positive direction and a negative direction of a z axis), and conform to an electric field characteristic of the slot CM mode.

As shown in FIG. 39, electric fields generated by the antenna are co-directional on the two sides of the first slot (both pointing to a positive direction of a z axis), and conform to an electric field characteristic of the slot DM mode.

As shown in FIG. 40, electric fields generated by the antenna are co-directional on two sides of the first slot (both pointing to a positive direction of a z axis), and conform to an electric field characteristic of the slot DM mode.

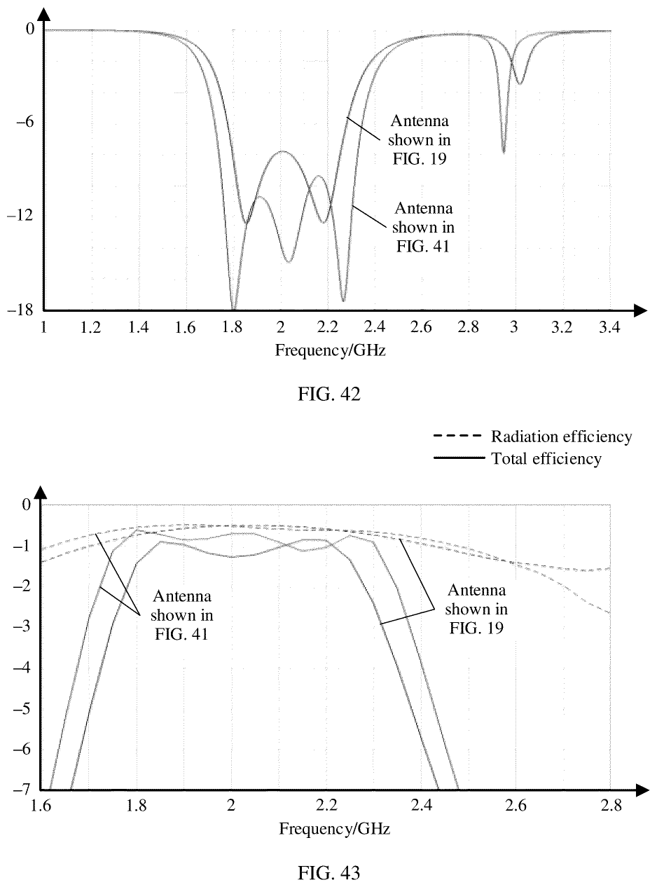

FIG. 41 is a diagram of another electronic device 10 according to an embodiment of this application.

As shown in FIG. 41, a side frame 11 includes a first position 201, a second position 202, and a third position 203 that are sequentially disposed, and the second position 202 is located between the first position 201 and the third position 203. The side frame 11 is coupled to a ground plane 300 at the first position 201 and the second position 202, and the side frame 11 is provided with a first slot between the first position 201 and the second position 202. The side frame 11 is provided with a second slot at the third position 203. In an embodiment, the first slot is located in a central area between the first position 201 and the second position 202.

The radiator 210 is a conductive part of the side frame 11 between the first position 201 and the second position 202. A conductive part of the side frame 11 between the second position 202 and the third position 203 is a parasitic stub.

In an embodiment, a distance between the second position 202 and the third position 203 is greater than or equal to one third or less than or equal to two thirds of a distance between the first position 201 and the second position 202.

It should be understood that a difference between the antenna 200 shown in FIG. 41 and the antenna 200 shown in FIG. 19 is the parasitic stub. The radiator 210 (the conductive part between the first position 201 and the second position 202) may form a slot antenna, and the first resonance and the second resonance are generated in a slot CM mode. The parasitic stub and a part of the radiator 210 (a conductive part between the first slot and the third position 203 (the second slot)) may form a radiator structure that conforms to a wire antenna, and a fifth resonance is generated in a wire DM mode. In an embodiment, the fifth resonance may be used to expand an operating bandwidth of the antenna 200, and the first resonance, the second resonance, and the fifth resonance may jointly support an operating frequency band of the electronic device 10. In an embodiment, a resonance point frequency of the fifth resonance may be greater than a resonance point frequency of the first resonance and a resonance point frequency of the second resonance. In an embodiment, a resonance point frequency of the fifth resonance may be less than a resonance point frequency of the first resonance and a resonance point frequency of the second resonance.

In an embodiment, in a low band (less than or equal to 1 GHz, for example, 698 MHz to 960 MHz), a frequency difference between the resonance point frequency of the fifth resonance and the resonance point frequency of the first resonance or the resonance point frequency of the second resonance is greater than or equal to 50 MHz and less than or equal to 160 MHz. In a middle band (in a range of 1 GHz to 2 GHz, for example, 1710 MHz to 2170 MHz), a frequency difference between the resonance point frequency of the fifth resonance and the resonance point frequency of the first resonance or the resonance point frequency of the second resonance is greater than or equal to 120 MHz and less than or equal to 300 MHz. In a high band (in a range of 2 GHz to 3 GHz, for example, 2300 MHz to 2690 MHz), a frequency difference between the resonance point frequency of the fifth resonance and the resonance point frequency of the first resonance or the resonance point frequency of the second resonance is greater than or equal to 160 MHz and less than or equal to 500 MHz.

It should be understood that the radiator 210 and a part of a feed member that are of the antenna 200 in FIG. 41 may alternatively be replaced with the antenna 200 shown in FIG. 9, FIG. 19, FIG. 24, FIG. 27, and FIG. 30. A difference lies only in that a conductor between the second position and the third position is used as the parasitic stub.

For brevity of description, similar parts between the antenna 200 shown in FIG. 41 and the antenna 200 shown in FIG. 9, FIG. 19, FIG. 24, FIG. 27, and FIG. 30 are not described one by one again. For example, the similar parts include: a position of the radiator 210 and a position relationship between the radiator 210 and the feed member 221; a provided position and a width of the first slot; a boundary condition (an open end or a ground end) of the feed member 221; a shape of the feed member 221, for example, a bar shape; a position at which the feed member 221 is disposed; and the like.

In an embodiment, the second position 202 may be located in a central area of the conductive part between the first slot and the third position 203.

FIG. 42 and FIG. 43 show simulation results of the antenna 200 in the electronic device 10 shown in FIG. 41. FIG. 42 shows a simulation result of an S parameter of the antenna 200 in the electronic device 10 shown in FIG. 41. FIG. 43 shows simulation results of total efficiency and radiation efficiency of the antenna 200 in the electronic device 10 shown in FIG. 41.

As shown in FIG. 42, in a range of 1.6 GHz to 2.4 GHz, compared with the antennas shown in FIG. 9, FIG. 19, FIG. 24, FIG. 27, and FIG. 30, the antenna shown in FIG. 41 may additionally generate the fifth resonance (near 2.24 GHz). In a case of using a boundary that S11 is less than −4 dB, an operating bandwidth is greater than an operating bandwidth of the antenna shown in FIG. 19.

As shown in FIG. 43, no efficiency dip is generated near the fifth resonance that can be additionally generated by the antenna. The antenna has good radiation efficiency and total efficiency in an operating frequency band formed by the first resonance, the second resonance, and the fifth resonance.

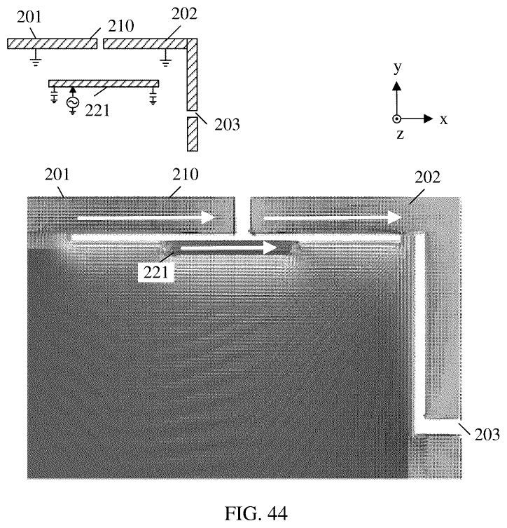

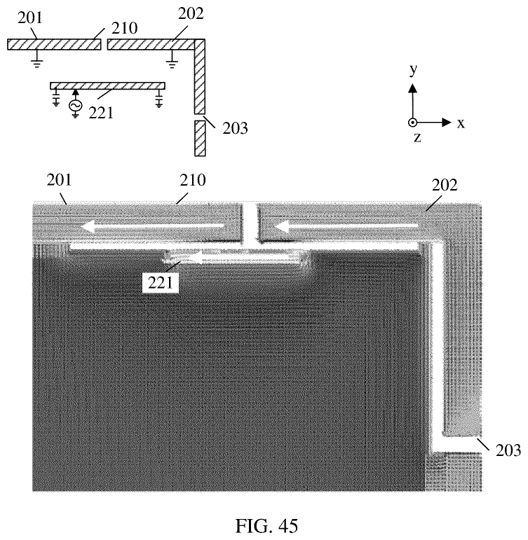

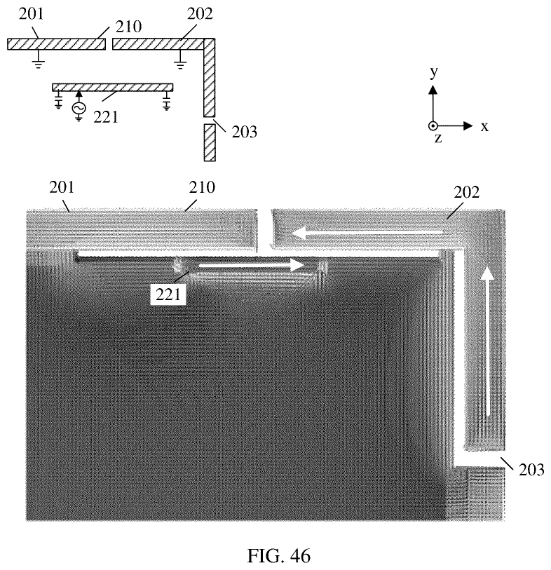

FIG. 44 to FIG. 46 are diagrams of current distribution of the antenna 200 in the electronic device 10 shown in FIG. 41. FIG. 44 is a diagram of current distribution of the antenna shown in FIG. 41 at a resonance point (1.79 GHz) of the first resonance. FIG. 45 is a diagram of current distribution of the antenna shown in FIG. 30 at a resonance point (2.01 GHz) of the second resonance; FIG. 46 is a diagram of current distribution of the antenna shown in FIG. 30 at a resonance point (2.24 GHz) of the fifth resonance;

As shown in FIG. 44 and FIG. 45, both the first resonance and the second resonance are generated in a slot CM mode of a slot antenna including a conductor part between the first position and the second position, and currents on radiators on two sides of the first slot are co-directional (a current on a radiator between the first position 201 and the first slot and a current on a radiator between the first slot and the second position 202 are co-directional).

As shown in FIG. 46, the fifth resonance is generated by a radiator structure (in a wire DM mode) that includes the conductive part between the first slot and the third position and that conforms to a wire antenna, and currents on conductor parts on two sides of the second position are co-directional (a current on a radiator between the first slot and the second position 202 and a current on the parasitic stub between the second position 202 and the third position are co-directional).

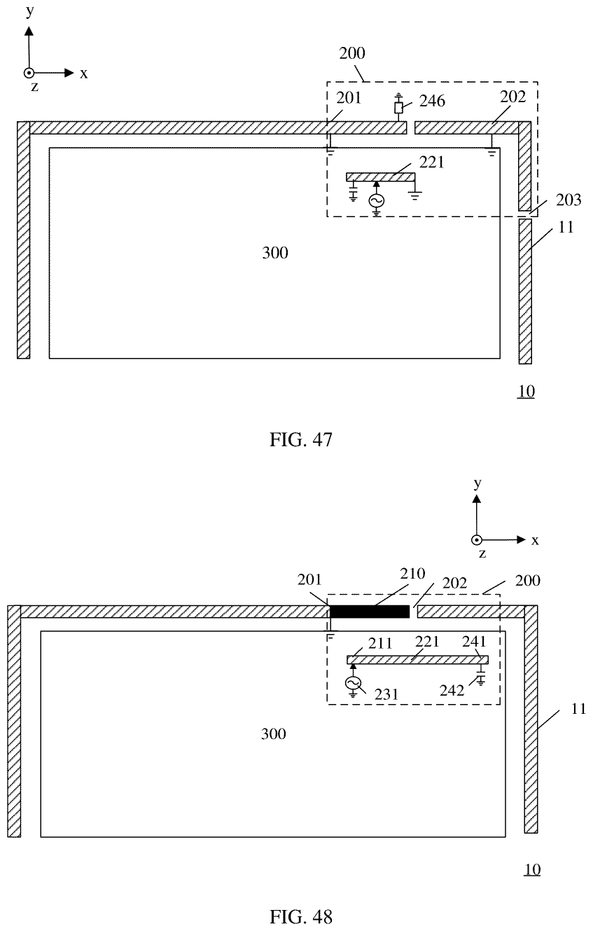

FIG. 47 is a diagram of another electronic device 10 according to an embodiment of this application.

It should be understood that, in the antenna 200 shown in FIG. 41, the first end and the second end of the feed member 221 are open ends, and the feed member 221 forms a dipole (dipole) antenna. However, in the antenna 200 shown in FIG. 47, the first end of the feed member 221 is an open end, and the second end of the feed member 221 is a ground end. The feed member 221 may form a structure similar to a monopole or left-handed antenna. The feed member 221 of the structure may also excite the antenna 200 to generate the first resonance, the second resonance, and the fifth resonance.

In an embodiment, the antenna 200 may further include an electronic element 246. The electronic element 246 may be connected between a conductor on one side of a first slot and a ground plane.

It should be understood that, because the first end of the feed member is an open end, and the second end is a ground end, symmetry of a structure of the antenna is poor. In this case, excitation of a third resonance generated in a slot DM mode (a conductor part between the first position and the second position forms a radiator structure that conforms to a slot antenna) is enhanced. The electronic element 246 may be configured to adjust a resonance point frequency of the third resonance, so that the first resonance, the second resonance, and the third resonance jointly support an operating frequency band of the electronic device 10.

In addition, the technical solution shown in FIG. 47 may also be applied to the antenna 200 shown in FIG. 9, FIG. 19, FIG. 24, FIG. 27, FIG. 30, and FIG. 41. For brevity of description, details are not described again.

For brevity of description, similar parts between the antenna 200 shown in FIG. 47 and the antenna 200 shown in FIG. 9, FIG. 19, FIG. 24, FIG. 27, FIG. 30, and FIG. 41 are not described one by one again. For example, the similar parts include: a position of the radiator 210 and a position relationship between the radiator 210 and the feed member 221; a provided position and a width of the first slot; a shape of the feed member 221, for example, a bar shape; a position at which the feed member 221 is disposed; and the like.

In addition, in the technical solutions shown in FIG. 41 and FIG. 47, a conductive part between the first slot and the third position 203 (a second slot) is used to form a radiator structure that conforms to a wire antenna, and the fifth resonance is generated in a wire DM mode. The technical solution may be applied to any one of the embodiments shown in FIG. 9 to FIG. 40.

FIG. 48 is a diagram of another electronic device 10 according to an embodiment of this application.

As shown in FIG. 48, a side frame 11 is coupled to a ground plane 300 at a first position 201, and is provided with a first slot at a second position 202. A first end of a radiator 210 is a ground end, and a second end of the radiator 210 is an open end. The first end and the second end of the radiator 210 respectively correspond to the first position 201 and the second position 202 of the side frame 11. A first end and a second end of a feed member 221 are open ends.

In an embodiment, a proportion of a length of an overlapping part between the radiator 210 and a projection of the feed member 221 on the side frame 11 to a length of the radiator 210 is greater than or equal to 50%.

In an embodiment, a proportion of a length of an overlapping part (the overlapping part between the radiator 210 and the projection of the feed member 221 on the side frame 11) between the feed member 221 and the radiator 210 in a first direction to a length of the feed member 221 is greater than or equal to 20%. In an embodiment, a proportion of a length of an overlapping part (the overlapping part between the radiator 210 and the projection of the feed member 221 on the side frame 11) between the feed member 221 and the radiator 210 in a first direction to a length of the feed member 221 is greater than or equal to 30%.

In an embodiment, a distance between a projection of the first slot on the feed member 221 and a midpoint of the feed member 221 is less than or equal to a quarter of the length of the feed member 221. In an embodiment, a projection of the first slot on the feed member 221 is in a central area of the feed member 221.

The radiator 210 has a weaker current and a stronger electric field in an area near the first slot. The feed member 221 has a weaker electric field and a stronger current in an area near the center. The area (the first slot) with a stronger electric field (a stronger magnetic field) of the radiator 210 is close to the area (a midpoint) with a weaker electric field (a stronger magnetic field) of the feed member 221, so that the first resonance and the second resonance can be more balanced.

It should be understood that a difference between the antenna 200 shown in FIG. 48 and the antenna 200 shown in the foregoing embodiment includes that the second end of the radiator 210 is an open end.

In the antenna 200 shown in the foregoing embodiment, the first end and the second end of the radiator 210 are ground ends, and the radiator 210 may form a radiator structure that conforms to a slot antenna. In the antenna 200 shown in FIG. 48, the first end of the radiator 210 is a ground end, and the second end of the radiator 210 is an open end. When an electrical signal is fed at the feed point, co-directional currents may also be generated on the radiator 210, and the radiator 210 may also be excited to generate the first resonance and the second resonance. In addition, because the first end of the radiator 210 is a ground end, and the second end of the radiator 210 is an open end, a size of the radiator 210 can be further reduced (for example, the size can be considered as being reduced from a half-wavelength structure to a quarter-wavelength structure), to implement miniaturization.

In an embodiment, an electrical length of the radiator 210 is a quarter of a first wavelength, an electrical length of the feed member 221 is a half of the first wavelength, and the first wavelength is a wavelength corresponding to a center frequency between a resonance point of the first resonance and a resonance point of the second resonance.

In an embodiment, the electrical length of the radiator 210 is a half of the electrical length of the feed member 221. Correspondingly, a physical length of the radiator 210 is approximately a half of a physical length of the feed member 221. Because an electronic element coupled to the feed member 221/radiator 210 may increase or decrease the physical length when the electrical length remains unchanged, the physical length L1 of the radiator 210 and the physical length L2 of the feed member 221 satisfy: L1≤L2≤L1×200%, or a physical length L2 of the feed member 221 is 1.4 times to 2.6 times (including end points in a range) of a physical length L1 of the radiator 210. In an embodiment, a physical length L1 of the radiator 210 and a physical length L2 of the feed member 221 satisfy: L1×200%≤L2≤L1×300%.

For brevity of description, similar parts between the antenna 200 shown in FIG. 48 and the antenna 200 shown in the foregoing embodiment are not described one by one again. For example, the similar parts include: The radiator 210 and the feed member 221 are configured to generate the first resonance and the second resonance; the first resonance and the second resonance may be used to jointly support one operating frequency band; a width of the first slot provided; a shape of the feed member 221, for example, a bar shape; a position at which the feed member 221 is disposed; and the like.

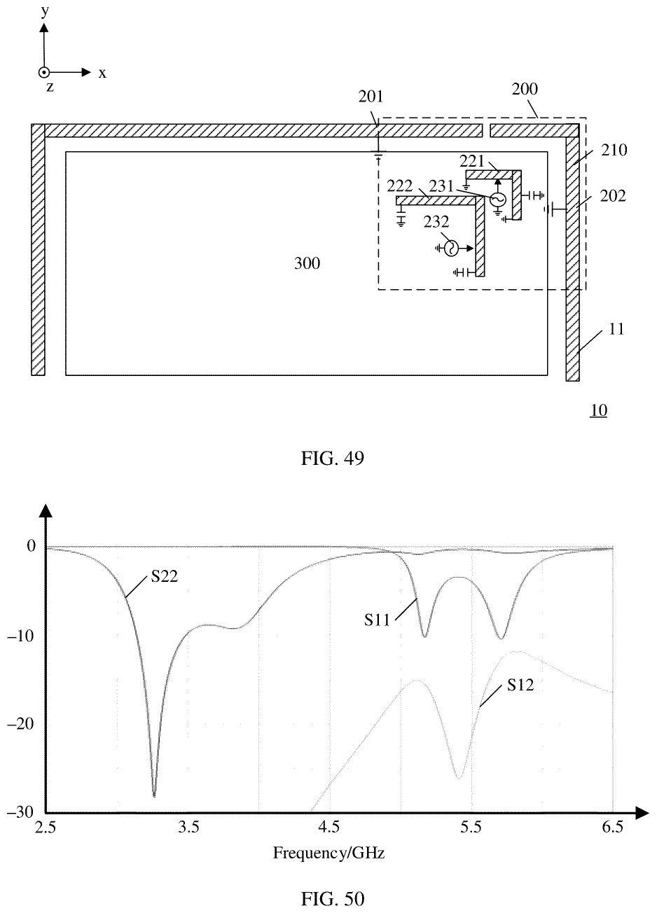

FIG. 49 is a diagram of an electronic device 10 according to an embodiment of this application.

As shown in FIG. 49, a side frame 11 is coupled to a ground plane 300 at a first position 201 and a second position 202, a first end and a second end of a radiator 210 are ground ends, and the radiator 210 forms a radiator structure that conforms to a slot antenna. The side frame 11 is provided with a first slot between the first position 201 and the second position 202. In an embodiment, the first slot is located in a central area between the first position 201 and the second position 202.

The antenna 200 may include a first feed member 221, a second feed member 222, and the radiator 210.

The radiator 210 is a conductive part of the side frame 11 between the first position 201 and the second position 202. The first end and the second end of the radiator 210 are open ends.

The first feed member 221, the second feed member 222, and the radiator 210 are spaced from each other. The radiator 210 at least partially overlaps the first feed member 221 and the second feed member 222 in a first direction, and the first direction is perpendicular to an extension direction (for example, a y direction) of the first radiator 210. In an embodiment, the extension direction of the radiator 210 is the same as an extension direction of the feed member 221. A first end and a second end of the first feed member 221 are ground ends. A first end and a second end of the second feed member 222 are open ends.

The antenna 200 further includes a first feed circuit 231 and a second feed circuit 232. The first feed member 221 includes a first feed point, and the first feed circuit 231 is coupled to the first feed point. The second feed member 222 includes a second feed point, and the second feed circuit 232 is coupled to the second feed point.

It should be understood that, in the foregoing embodiments, an example in which the radiator and the feed member are in a one-to-one correspondence is used for description. In the embodiment shown in FIG. 49, the radiator may be excited by the two feed members to generate a resonance, thereby reducing a size of the antenna 200 while expanding a bandwidth.

The antenna 200 may include a first antenna and a second antenna. The radiator 210 and the first feed member 221 may form the first antenna. The radiator 210 and the second feed member 222 may form the second antenna.

In the first antenna, the radiator 210 forms a radiator structure that conforms to a slot antenna, and an electrical signal is fed through a first feed element. The radiator 210 may generate a first resonance and a second resonance in a slot DM mode, and the first resonance and the second resonance are used to jointly support a first operating frequency band of the electronic device 10.

In the second antenna, the radiator 210 forms a radiator structure that conforms to a slot antenna, and an electrical signal is fed through a second feed element. The radiator 210 may generate a third resonance and a fourth resonance in a slot CM mode, and the third resonance and the fourth resonance are used to jointly support a second operating frequency band of the electronic device 10.

In an embodiment, the first resonance and the second resonance may be close to each other, so that the first resonance and the second resonance are used to jointly support an operating frequency band of the electronic device 10. In an embodiment, a frequency difference between the first resonance and the second resonance is within a range of 5% to 20% (greater than or equal to 5% and less than or equal to 20%) of a low-frequency resonance frequency point or a high-frequency resonance frequency point. In an embodiment, in a low band (less than or equal to 1 GHz, for example, 698 MHz to 960 MHz), a frequency difference between a resonance point frequency of the first resonance and/or a resonance point frequency of the second resonance is greater than or equal to 50 MHz and less than or equal to 160 MHz. In a middle band (in a range of 1 GHz to 2 GHz, for example, 1710 MHz to 2170 MHz), a frequency difference between a resonance point frequency of the first resonance and/or a resonance point frequency of the second resonance is greater than or equal to 120 MHz and less than or equal to 300 MHz. In a high band (in a range of 2 GHz to 3 GHz, for example, 2300 MHz to 2690 MHz), a frequency difference between a resonance point frequency of the first resonance and/or a resonance point frequency of the second resonance is greater than or equal to 160 MHz and less than or equal to 500 MHz.

In an embodiment, the third resonance and the fourth resonance may be close to each other, so that the third resonance and the fourth resonance are used to jointly support an operating frequency band of the electronic device 10. In an embodiment, a frequency difference between the third resonance and the fourth resonance is within a range of 5% to 20% (greater than or equal to 5% and less than or equal to 20%) of a low-frequency resonance frequency point or a high-frequency resonance frequency point. In an embodiment, in a low band (less than or equal to 1 GHz, for example, 698 MHz to 960 MHz), a frequency difference between a resonance point frequency of the third resonance and/or a resonance point frequency of the fourth resonance is greater than or equal to 50 MHz and less than or equal to 160 MHz. In a middle band (in a range of 1 GHz to 2 GHz, for example, 1710 MHz to 2170 MHz), a frequency difference between a resonance point frequency of the third resonance and/or a resonance point frequency of the fourth resonance is greater than or equal to 120 MHz and less than or equal to 300 MHz. In a high band (in a range of 2 GHz to 3 GHz, for example, 2300 MHz to 2690 MHz), a frequency difference between a resonance point frequency of the third resonance and/or a resonance point frequency of the fourth resonance is greater than or equal to 160 MHz and less than or equal to 500 MHz.

In an embodiment, at a resonance point of the first resonance, currents on radiators 210 on two sides of the first slot are reverse in direction. At a resonance point of the second resonance, the currents on the radiators 210 on two sides of the first slot are reverse in direction.

In an embodiment, at a resonance point of the first resonance, currents on the first feed member 221 on two sides of a center are reverse in direction. At a resonance point of the second resonance, currents on the first feed member 221 on two sides of a center are reverse in direction. It should be understood that currents on the first feed member 221 are reversely distributed, and the first feed member 221 may operate in the slot DM mode.

In an embodiment, at a resonance point of the third resonance, the currents on the radiators 210 on two sides of the first slot are co-directional. At a resonance point of the fourth resonance, the currents on the radiators 210 on two sides of the first slot are co-directional.

In an embodiment, at the resonance point of the third resonance, currents on the second feed member 222 are co-directional. At the resonance point of the fourth resonance, currents on the second feed member 222 are co-directional. It should be understood that currents on the second feed member 222 are co-directionally distributed, and the second feed member 222 may operate in a wire DM mode.

In an embodiment, both ends of the first feed member 221 are ground ends, and an electrical length of the radiator 210 and an electrical length of the feed member 221 are the same, and both are a half of a first wavelength. The first wavelength is a wavelength corresponding to a center frequency between the resonance point of the first resonance and the resonance point of the second resonance.

In an embodiment, the electrical length of the radiator 210 and the electrical length of the first feed member 221 are the same. Correspondingly, a physical length of the radiator 210 and a physical length of the first feed member 221 are approximately the same. Because an electronic element coupled to the first feed member 221/radiator 210 may increase or decrease the physical length when the electrical length remains unchanged, the physical length L1 of the radiator 210 and the physical length L2 of the first feed member 221 satisfy: L1×50%≤L2≤L1. In an embodiment, a physical length L1 of the radiator 210 and a physical length L2 of the first feed member 221 satisfy: L1≤L2≤L1×150%.

In an embodiment, both ends of the second feed member 222 are open ends, an electrical length of the radiator 210 and an electrical length of the second feed member 222 are the same, and both are a half of a second wavelength. The second wavelength is a wavelength corresponding to a center frequency between the third resonance and the fourth resonance.

In an embodiment, the electrical length of the radiator 210 and the electrical length of the second feed member 222 are the same. Correspondingly, a physical length of the radiator 210 and a physical length of the second feed member 222 are approximately the same. Because an electronic element coupled to the second feed member 222/radiator 210 may increase or decrease the physical length when the electrical length remains unchanged, the physical length L1 of the radiator 210 and the physical length L3 of the second feed member 222 satisfy: L1×50%≤L3≤L1. In an embodiment, a physical length L1 of the radiator 210 and a physical length L3 of the second feed member 222 satisfy: L1≤L3≤L1×150%.

In an embodiment, in the electronic device 10, that the first feed member 221 and the second feed member 222 are spaced from each other may be understood as that the first feed member 221 and the second feed member 222 are not disposed on a same surface. For example, the first feed member 221 and the second feed member 222 may be respectively disposed on an upper surface and a lower surface of a bracket. Alternatively, the first feed member 221 and the second feed member 222 may be respectively disposed on different surfaces of a plurality of dielectric layers included in a PCB. Alternatively, the first feed member 221 and the second feed member 222 are respectively disposed on a surface of a bracket and a surface of a PCB, or are respectively disposed on an inner surface of a rear cover and a surface of a bracket.

In an embodiment, the side frame 11 may include a first side and a second side that intersect at an angle, the first position 201 is located on the first side, and the second position 202 is located on the second side. A length of the radiator 210 on the first side is greater than or equal to three quarters of a length of the radiator 210, so that the antenna 200 has a better radiation characteristic.

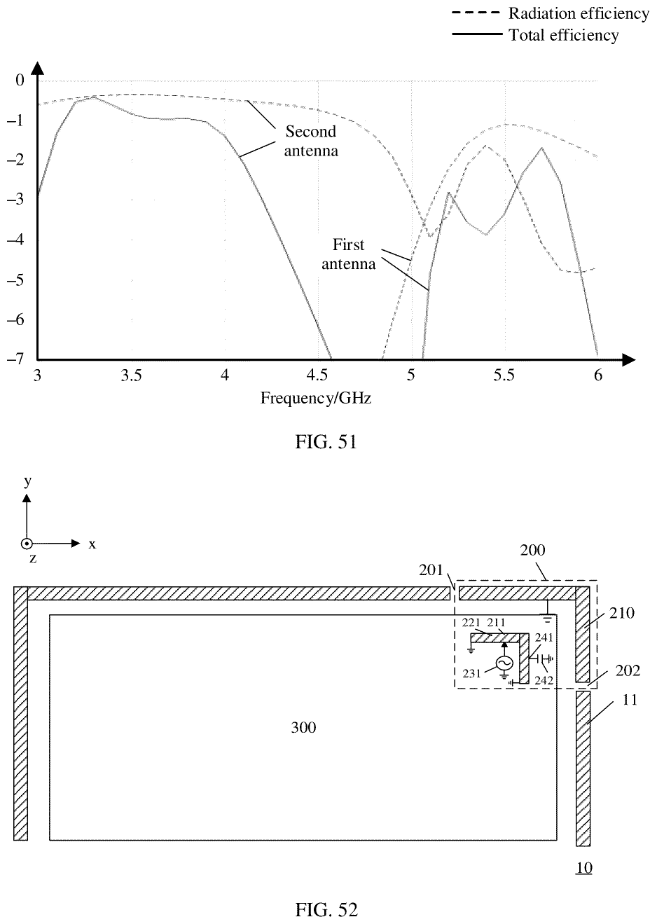

FIG. 50 and FIG. 51 show simulation results of the antenna 200 in the electronic device 10 shown in FIG. 49. FIG. 50 shows a simulation result of an S parameter of the antenna 200 in the electronic device 10 shown in FIG. 49. FIG. 51 shows simulation results of total efficiency and radiation efficiency of the antenna 200 in the electronic device 10 shown in FIG. 49.

As shown in FIG. 50, the first antenna (S11) may generate a resonance near 5.1 GHz and a resonance near 5.7 GHz, which may respectively correspond to the first resonance and the second resonance in the foregoing embodiments. The second antenna (S22) may generate a resonance near 3.3 GHz and a resonance near 3.9 GHz, which may respectively correspond to the third resonance and the fourth resonance in the foregoing embodiments.

The first resonance and the second resonance are generated in the slot DM mode, and the third resonance and the fourth resonance are generated in the slot CM mode. Therefore, the first antenna and the second antenna also have good isolation. In a case of using a boundary that S11/S22 is less than −4 dB, in respective resonance frequency bands, isolation (S12) between the first antenna and the second antenna is less than −11 dB.

As shown in FIG. 51, both the third resonance and the fourth resonance are generated in the slot CM mode. Because the slot CM mode has high radiation efficiency and total efficiency, the second antenna does not generate a dip in an operating frequency band formed by the third resonance and the fourth resonance, and has better radiation efficiency and total efficiency. However, both the first resonance and the second resonance are generated in the slot DM mode. Because the slot DM mode has lower radiation efficiency and total efficiency than the slot CM mode, the radiation efficiency and the total efficiency of the second antenna are higher than the radiation efficiency and the total efficiency of the first antenna.

FIG. 52 is a diagram of another electronic device 10 according to an embodiment of this application.

As shown in FIG. 52, the electronic device 10 includes a side frame 11, an antenna 200, and a ground plane 300.

At least a part of the side frame 11 and the ground plane 300 are spaced from each other. The side frame 11 includes a first position 201 and a second position 202. The side frame 11 is provided with a first slot and a second slot respectively at the first position 201 and the second position 202, a ground point is included between the first position 201 and the second position 202, and the side frame 11 is coupled to the ground plane 300 at the ground point. In an embodiment, the ground point is located in a central area between the first position 201 and the second position 202.

In an embodiment, the ground point is coupled to the ground plane 300 to implement grounding. At the ground point, the side frame 11 may be directly electrically connected to the ground plane 300 through a spring, or may be electrically connected to the ground plane 300 through an inductor, or may be electrically connected to the ground plane 300 through a mechanical part (for example, a connecting rib) of a middle frame. Being electrically connected to the ground plane 300 through the mechanical part of the middle frame may be understood as that at least a part of the side frame 11 and the ground plane 300 are of an integrated structure.

In an embodiment, the ground point may be electrically connected to the ground plane 300 through a ground member (for example, a spring or a connecting rib). A width of a joint between the ground member and the side frame 11 is greater than or equal to 1 mm and less than or equal to 10 mm.

The antenna 200 includes a radiator 210 and a feed member 221. The radiator 210 and the feed member 221 are spaced from each other, and the radiator 210 and the feed member 221 at least partially overlap in a first direction. The first direction is perpendicular to an extension direction (for example, a y direction) of the radiator 210. The extension direction of the radiator 210 is the same as an extension direction of the feed member 221. The radiator 210 is a conductive part of the side frame 11 between the first position 201 and the second position 202. A first end and a second end of the radiator 210 are open ends, where the first end and the second end of the radiator 210 respectively correspond to the first position 201 and the second position 202 of the side frame 11. A first end and a second end of the feed member 221 are ground ends.

That the extension direction of the radiator 210 is the same as the extension direction of the feed member 221 may be understood as that an angle between the extension direction of the radiator 210 and the extension direction of the feed member 221 is less than or equal to a first threshold, for example, less than or equal to 10°.

In an embodiment, the first end and the second end of the feed member 221 are coupled to the ground plane 300, to implement grounding. The feed member 221 may be electrically connected to the ground plane 300 through a spring at the first end and the second end of the feed member 221, or may be electrically connected to the ground plane 300 through an inductor.

That the radiator 210 and the feed member 221 are spaced from each other may be understood that the radiator 210 and the feed member 221 are not directly connected to each other and form a gap. In this embodiment of this application, being spaced from each other may be correspondingly understood. The radiator 210 is coupled to the feed member 221 by using the gap.

The antenna 200 further includes a feed circuit 231, the feed member 221 includes a feed point 211, and the feed circuit 231 is coupled to the feed point 211.

The feed member 221 and the radiator 210 are configured to generate a first resonance and a second resonance. In an embodiment, the first resonance and the second resonance are used to jointly support an operating frequency band of the electronic device 10.

The operating frequency band of the electronic device 10 includes a frequency range, for example, a low band (low band, LB) (698 MHz to 960 MHz), a middle band (middle band, MB) (1710 MHz to 2170 MHz), or a high band (high band, HB) (2300 MHz to 2690 MHz) in a cellular network. For example, an operating frequency band of the electronic device 10 is LB (698 MHz to 960 MHz). The operating frequency band may include a plurality of communication frequency bands that are within the frequency range, for example, B5 and B8, which may be correspondingly understood in this embodiment of this application.

It should be understood that the radiator 210 may form a radiator structure that conforms to a wire antenna. For example, the wire antenna may be a T antenna or a T-shaped antenna. When the feed circuit 231 feeds the electrical signal, the antenna 200 may generate the first resonance and the second resonance through the radiator 210 and the feed member 221. In the electronic device 10, compared with the radiator 210 (the conductive part of the side frame 11 is used as the radiator 210), the feed member 221 has a worse radiation environment (for example, a worse clearance, and is closer to an adjacent metal part). However, the feed member 221 may generate a new current path for the radiator 210, to generate a new resonance (for example, the second resonance), so as to expand an operating bandwidth of the antenna 200.

In addition, because the first end and the second end of the radiator 210 are open ends, the radiator 210 has stronger electric fields and weaker currents in areas near the first end and the second end. The first end and the second end of the feed member 221 are ground ends, and the feed member 221 has weaker electric fields and stronger currents in areas near the first end and the second end. The area with a stronger electric field (a stronger magnetic field) of the radiator 210 is close to the area with a weaker electric field (a stronger magnetic field) of the feed member 221, so that the first resonance and the second resonance can be balanced, and no dip of radiation efficiency is generated in the first operating frequency band jointly supported by the first resonance and the second resonance. In this way, a radiation characteristic of the antenna 200 is improved, and the electronic device 10 has better communication performance.

In an embodiment, the first resonance and the second resonance may be close to each other, so that the first resonance and the second resonance are used to jointly support an operating frequency band of the electronic device 10. In an embodiment, a frequency difference between the first resonance and the second resonance is within a range of 5% to 20% (greater than or equal to 5% and less than or equal to 20%) of a low-frequency resonance frequency point or a high-frequency resonance frequency point. In an embodiment, in the low band (less than or equal to 1 GHz, for example, 698 MHz to 960 MHz), a frequency difference between a resonance point frequency of the first resonance and/or a resonance point frequency of the second resonance is greater than or equal to 50 MHz and less than or equal to 160 MHz. In the middle band (in a range of 1 GHz to 2 GHz, for example, 1710 MHz to 2170 MHz), a frequency difference between a resonance point frequency of the first resonance and/or a resonance point frequency of the second resonance is greater than or equal to 120 MHz and less than or equal to 300 MHz. In the high band (in a range of 2 GHz to 3 GHz, for example, 2300 MHz to 2690 MHz), a frequency difference between a resonance point frequency of the first resonance and/or a resonance point frequency of the second resonance is greater than or equal to 160 MHz and less than or equal to 500 MHz.

In an embodiment, at a resonance point of the first resonance, currents on first radiators 210 on two sides of the ground point are reverse in direction, and a reverse current is distributed on each of the radiators 210 on the two sides of the ground point (in other words, there is a current reversal point on the radiator). At a resonance point of the second resonance, the currents on the first radiators 210 on the two sides of the ground point are reverse in direction, and a reverse current is distributed on each of the radiators 210 on the two sides of the ground point (in other words, there is a current reversal point on the radiator).

It should be understood that both the first resonance and the second resonance may be considered as being generated in a wire CM mode. Because the wire CM mode has higher radiation efficiency and total efficiency, the antenna has better radiation efficiency and total efficiency in the operating frequency band formed by the first resonance and the second resonance.

In an embodiment, at the resonance point of the first resonance and a resonance point of the second resonance, currents on two sides of a center of the feed member 221 are reverse in direction.

It should be understood that the current on the feed member 221 may be generated in a slot DM mode. The radiator 210 generates co-directional currents through co-directional current coupling on the feed member 221, to generate the second resonance.

In an embodiment, the feed member 221 includes a connection point 241. The antenna 200 may further include an electronic element 242. A first end of the electronic element 242 is coupled to the connection point 241, and a second end of the electronic element 242 is coupled to the ground plane 300.

It should be understood that the electronic element 242 may be configured to adjust a resonance point frequency of the second resonance, so that the first resonance, and the second resonance may jointly support an operating frequency band of the electronic device 10.

In an embodiment, a proportion of a length of an overlapping part between the radiator 210 and a projection of the feed member 221 on the side frame 11 to a length of the radiator 210 is greater than or equal to 25%. In an embodiment, a proportion of a length of an overlapping part between the radiator 210 and a projection of the feed member 221 on the side frame 11 to a length of the radiator 210 is greater than or equal to 50%.

In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 50%. In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 75%.

It should be understood that when a proportion of a length of the projection to the length of the feed member 221 (or a proportion of a length of the projection to the length of the radiator 210) falls within the foregoing range, the radiator 210 can be better excited, and the antenna 200 has a better radiation characteristic. When the first position 201 and the second position 202 are respectively located on a first side and a second side that are of the side frame and that intersect at an angle, the extension direction of the radiator 210 includes the extension direction (for example, the x direction) of the first side and the extension direction (for example, the y direction) of the second side. The length of the overlapping part may be understood as a sum of a length of an overlapping part in the extension direction (for example, the x direction) of the first side and a length of an overlapping part in the extension direction (for example, the y direction) of the second side.

In an embodiment, lengths of radiators on the two sides of the ground point are approximately the same, and a proportion of the lengths of the radiators on the two sides of the ground point (a length of a conductor part of the side frame between the first position 201 and the ground point and a length of a conductor part of the side frame between the second position 202 and the ground point) is greater than or equal to 0.7 and less than or equal to 1.3.

It should be understood that when the lengths of the radiators on the two sides of the ground point are approximately the same, a structure of the antenna 200 is more symmetrical. Increasing symmetry of the antenna 200 can better excite the wire CM mode, so that the antenna 200 has a better radiation characteristic (for example, bandwidth and radiation efficiency) in the first resonance and the second resonance.

In an embodiment, a distance between a projection of the ground point on the feed member 221 and a center of the feed member 221 is less than or equal to a quarter of the length of the feed member 221. In an embodiment, a projection of the ground point on the feed member 221 is in a central area of the feed member 221.

It should be understood that when the feed member 221 and the radiator 210 are approximately aligned, a structure of the antenna 200 is more symmetrical. Increasing symmetry of the antenna 200 can better excite a slot CM mode, so that the antenna 200 has a better radiation characteristic (for example, bandwidth and radiation efficiency) in the first resonance and the second resonance. That the feed member 221 and the radiator 210 are aligned may be understood as that the first radiator 210 is symmetrical along a virtual axis of the feed member 221, and lengths of feed members 221 on two sides of the virtual axis are the same.

In addition, the radiator 210 has a weaker electric field and a stronger current in an area near the ground point. The feed member 221 has a weaker current and a stronger electric field in an area near the center. The area (the ground point) with a weaker electric field (a stronger magnetic field) of the radiator 210 is close to the area (the midpoint) with a stronger electric field (a stronger magnetic field) of the feed member 221, so that the first resonance and the second resonance can be more balanced.

In an embodiment, a projection of the feed member 221 on the side frame 11 completely overlaps the radiator 210. In an embodiment, a proportion of lengths of radiators on the two sides of the ground point is greater than or equal to 0.9 and less than or equal to 1.1. In an embodiment, two ends of the feed member 221 are coupled to the ground plane 300 in a same manner (for example, both the first end and the second end of the feed member 221 are coupled to the ground plane 300 through inductors, or are coupled to the ground plane 300 through connecting ribs). In an embodiment, a projection of the ground point on the feed member 221 coincides with the center of the feed member 221.

In an embodiment, a projection of the feed member 221 on the side frame 11 is located between the first position 201 and the second position 202.

It should be understood that increasing the symmetry of the antenna 200 can better excite the slot CM mode, so that the antenna 200 can have a better radiation characteristic (for example, bandwidth and radiation efficiency) in the first resonance and the second resonance.

In an embodiment, both ends of the feed member 221 are ground ends, and an electrical length of the radiator 210 and an electrical length of the feed member 221 are the same, and both are a half of a first wavelength. The first wavelength is a wavelength corresponding to a center frequency between the resonance point of the first resonance and the resonance point of the second resonance.

In an embodiment, an electrical length of the radiator 210 and an electrical length of the feed member 221 are approximately the same. In an embodiment, a physical length of the radiator 210 and a physical length of the feed member 221 are approximately the same. Because an electronic element coupled to the feed member 221/radiator 210 may increase or decrease the physical length when the electrical length remains unchanged, the physical length L1 of the radiator 210 and the physical length L2 of the feed member 221 satisfy: L1×50%≤L2≤L1. In an embodiment, a physical length L1 of the radiator 210 and a physical length L2 of the feed member 221 satisfy: L1≤L2≤L1×150%.

In an embodiment, the physical length L1 of the radiator 210 may be understood as a length of a conductive part of the side frame between the first position 201 and the second position 202, for example, a sum of physical lengths of radiators 210 on the two sides of the ground point.

In an embodiment, a distance D between the feed member 221 and the radiator 210 is less than or equal to 5 mm, so that the feed member 221 and the radiator 210 have a good coupling characteristic. In an embodiment, the distance D between the feed member 221 and the radiator 210 is less than or equal to 2 mm.

It should be understood that the distance D between the feed member 221 and the radiator 210 may be understood as a minimum value of a distance between a point on the feed member 221 and a point on the radiator 210.

In an embodiment, the electronic device 10 may further include a bracket. The feed member 221 may be disposed on a surface of the bracket, and at least a part of the bracket may be disposed between a PCB and a rear cover, to support the feed member 221. A metal layer in the PCB may be used as the ground plane 300 in this embodiment of this application. The ground plane may alternatively be the middle frame of the electronic device or another metal layer.

In an embodiment, the feed member on the bracket may be located above the PCB. For example, a projection of the feed member 221 in a direction perpendicular to the PCB completely overlaps the PCB. In an embodiment, the feed member 221 on the bracket may be located at an edge of the PCB. For example, a projection of the feed member 221 in the first direction partially overlaps the PCB. In an embodiment, the feed member 221 on the bracket may be located above a hollow area of the PCB or a gap between the PCB and the side frame. For example, a projection of the feed member 221 in a direction perpendicular to the PCB does not overlap the PCB.

In an embodiment, a distance H1 between the bracket and the PCB may be greater than or equal to 0.1 mm and less than or equal to 3 mm. In an embodiment, a distance H2 between the bracket and the rear cover may be greater than or equal to 0.1 mm and less than or equal to 1 mm.

In an embodiment, the feed member 221 may be disposed on a surface of the rear cover (for example, a surface facing the PCB). In an embodiment, the feed member 221 may alternatively be disposed on a surface of the PCB. A disposing position of the feed member 221 is not limited in embodiments of this application.

It should be understood that, for brevity of description, in the technical solutions shown in FIG. 52, the conductive part of the side frame 11 is used as the radiator 210, and the feed member 221 is of a non-side-frame structure (for example, disposed on the bracket, the PCB, or the rear cover). In actual production or design, relative positions of the radiator 210 and the feed member 221 may be interchanged. For example, the conductive part of the side frame 11 is used as the feed member 221, and the radiator 210 is of a non-side-frame structure (for example, disposed on the bracket, the PCB, or the rear cover).

In an embodiment, the feed member 221 is bar-shaped. The “bar shape” may be understood as that a length is much greater than a width. For example, the length is greater than three times or six times the width. In an embodiment, a smallest dimension in three-dimensional dimensions of the feed member 221 is a thickness. For example, when the feed member 221 may be disposed on the surface of the bracket 140, a dimension in a direction perpendicular to the surface of the bracket 140 is the thickness. Dimensions other than the thickness in the three-dimensional dimensions of the feed member 221 may be understood as a length and a width.

In an embodiment, the width of the feed member 221 may be less than or equal to 3 mm. In an embodiment, the width of the feed member 221 may be less than or equal to 2 mm.

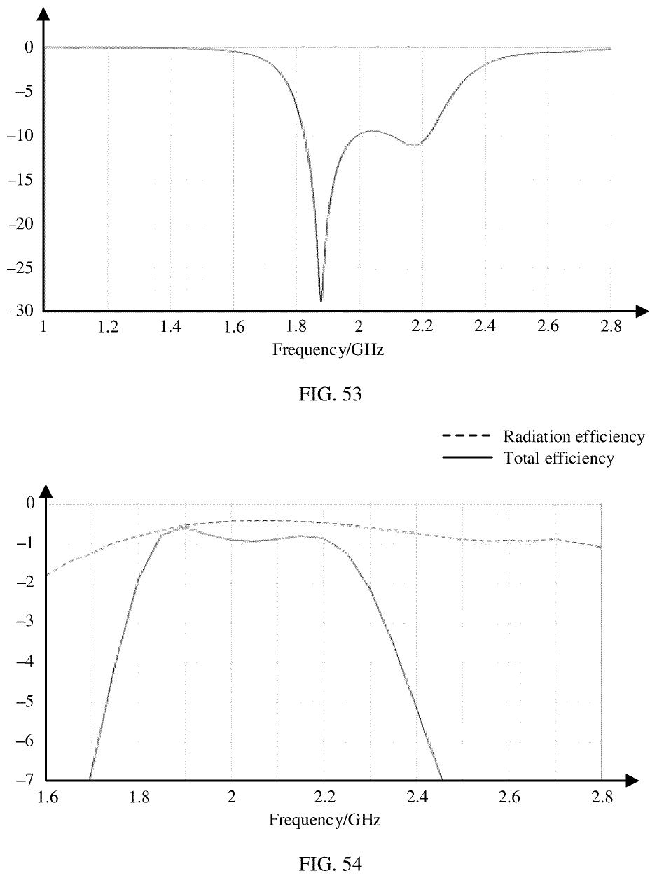

FIG. 53 and FIG. 54 show simulation results of the antenna 200 in the electronic device 10 shown in FIG. 52. FIG. 53 shows a simulation result of an S parameter of the antenna 200 in the electronic device 10 shown in FIG. 52. FIG. 54 shows simulation results of total efficiency and radiation efficiency of the antenna 200 in the electronic device 10 shown in FIG. 52.

As shown in FIG. 53, the antenna 200 may generate a resonance near 1.9 GHz and a resonance near 2.2 GHz. The resonance generated near 1.8 GHz may correspond to the first resonance in the foregoing embodiment, and the resonance generated near 2.2 GHz may correspond to the second resonance in the foregoing embodiment.

As shown in FIG. 54, both the first resonance and the second resonance may be generated in the wire CM mode. Because the wire CM mode has high radiation efficiency and total efficiency, the antenna does not generate a dip in an operating frequency band formed by the first resonance and the second resonance, and better good radiation efficiency and total efficiency. For example, when total efficiency is greater than −2 dB, a total efficiency bandwidth of the antenna 200 is approximately 500 MHz.

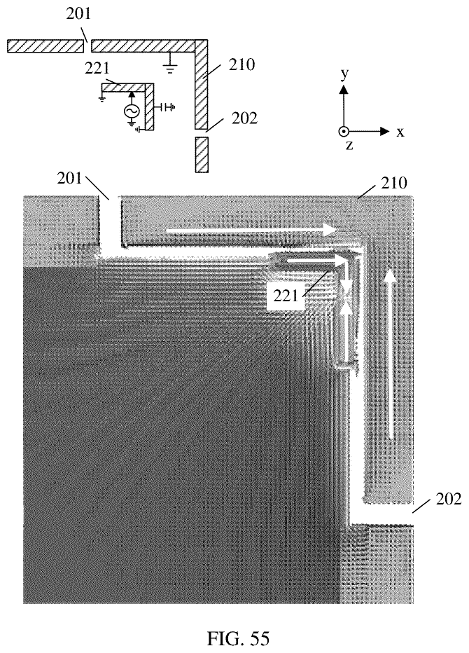

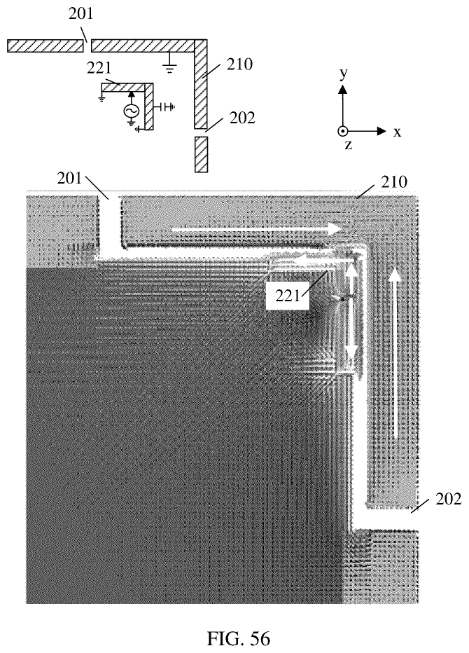

FIG. 55 and FIG. 56 are diagrams of current and electric field distribution of the antenna 200 in the electronic device 10 shown in FIG. 52. FIG. 55 is a diagram of current distribution of the antenna shown in FIG. 52 at a resonance point (1.88 GHz) of the first resonance. FIG. 56 is a diagram of current distribution of the antenna shown in FIG. 52 at a resonance point (2.16 GHz) of the second resonance.

As shown in FIG. 55, currents on the first radiators 210 on the two sides of the ground point are reverse in direction, and currents on the two sides of the center of the feed member are reverse in direction. Current distribution on the radiator conforms to a current characteristic of the wire CM mode. Current distribution on the feed member meets a current characteristic of the slot DM mode.

As shown in FIG. 56, currents on the first radiators 210 on the two sides of the ground point are reverse in direction, and currents on the two sides of the center of the feed member are reverse in direction. Current distribution on the radiator conforms to a current characteristic of the wire CM mode. Current distribution on the feed member meets a current characteristic of the slot DM mode.

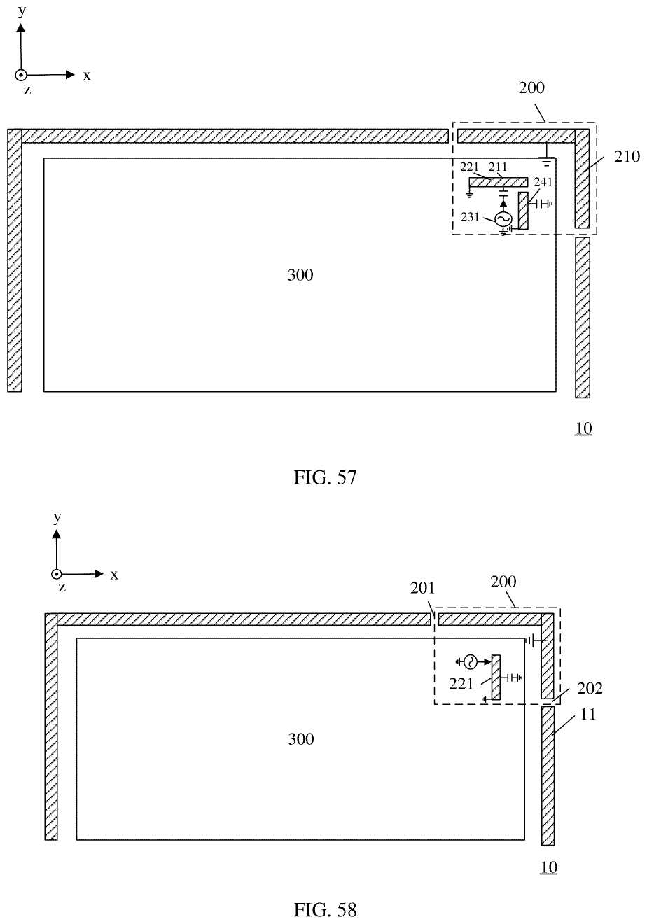

FIG. 57 is a diagram of another electronic device 10 according to an embodiment of this application.

As shown in FIG. 57, a first end and a second end of the feed member 221 are ground ends. The feed member 221 may be provided with a third slot. In an embodiment, the third slot may be located in a central area of the feed member 221.

In an embodiment, lengths of feed members 221 on two sides of the third slot are approximately the same. In an embodiment, that the lengths of the feed members 221 on the two sides of the third slot are different may be understood as that a difference between the lengths of the feed member 221 on the two sides of the third slot is less than or equal to 5 mm.

It should be understood that a difference between the antenna 200 shown in FIG. 57 and the antenna 200 shown in FIG. 52 includes that the feed member 221 further includes the third slot.

For brevity of description, similar parts between the antenna 200 shown in FIG. 57 and the antenna 200 shown in FIG. 52 are not described one by one again. For example, the similar parts include: a position of the radiator 210 and a position relationship between the radiator 210 and the feed member 221; the feed member 221 and the radiator 210 are configured to generate the first resonance and the second resonance; the first resonance and the second resonance may be used to jointly support one operating frequency band; a provided position and a width of the first slot; a boundary condition (an open end or a ground end) of the feed member 221; a shape of the feed member 221, for example, a bar shape; a position at which the feed member 221 is disposed; and the like.

In the antenna 200 shown in FIG. 57, the feed member 221 may have both the slot DM mode and the slot CM mode. When the feed circuit 231 feeds the electrical signal, the antenna 200 may generate a first resonance, a second resonance, a third resonance, and a fourth resonance, to expand an operating bandwidth of the antenna 200.

In an embodiment, the first resonance and the second resonance may correspond to a wire CM mode, and the third resonance and the fourth resonance may correspond to a wire DM mode.

In an embodiment, at a resonance point of the first resonance, currents on radiators 210 on the two sides of the ground point are reverse in direction, and a reverse current is distributed on each of the radiators 210 on the two sides of the ground point (in other words, there is a current reversal point on the radiator). At a resonance point of the second resonance, the currents on the radiators 210 on the two sides of the ground point are reverse in direction, and a reverse current is distributed on each of the radiators 210 on the two sides of the ground point (in other words, there is a current reversal point on the radiator).

In an embodiment, at a resonance point of the third resonance, the currents on the radiators 210 on the two sides of the ground point are co-directional, and co-directional currents are distributed on each of the radiators 210 on the two sides of the ground point (in other words, there is no current reversal point on the radiator). At a resonance point of the fourth resonance, the currents on the radiators 210 on the two sides of the ground point are co-directional, and co-directional currents are distributed on each of the radiators 210 on the two sides of the ground point (in other words, there is no current reversal point on the radiator).

In an embodiment, the feed point 211 may be located on a first side of the second slot (between the second slot and the first end of the feed member 221), and a first capacitor may be disposed between the feed circuit 231 and the feed member 221. In an embodiment, a capacitance value of the first capacitor is less than or equal to 1.5 pF.

In an embodiment, the feed member 221 on a second side of the second slot (between the second slot and the second end of the feed member 221) may include a connection point 241. A first end of the second capacitor is coupled to the connection point, and a second end of the second capacitor is coupled to the ground plane 300.

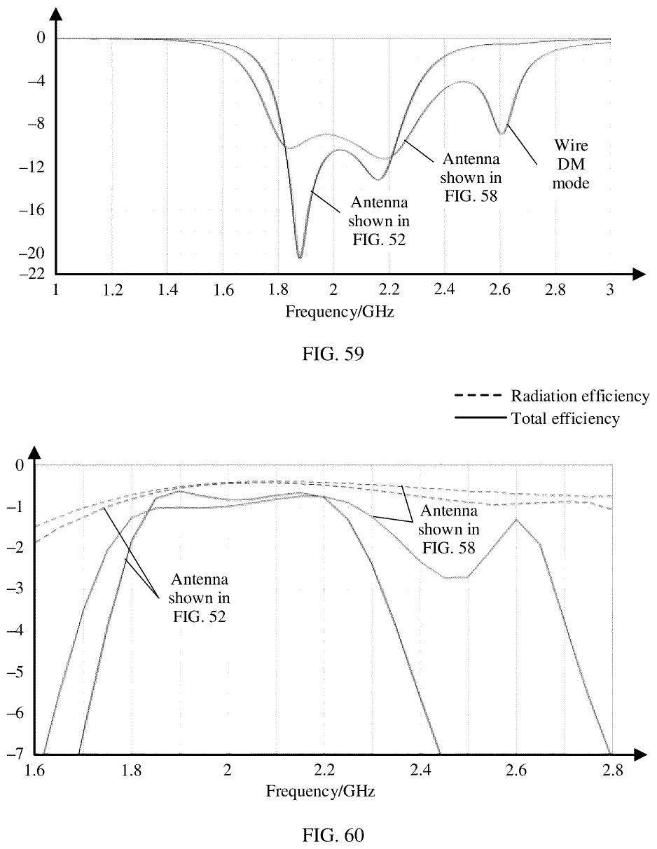

FIG. 58 is a diagram of another electronic device 10 according to an embodiment of this application.

As shown in FIG. 58, a first end of a feed member 221 is a ground end, and a second end of the feed member 221 is an open end. The first end of the feed member 221 is coupled to a ground plane 300.

In an embodiment, a distance between a feed point 211 and an end part of the first end of the feed member 221 is different from a distance between the feed point 211 and an end part of the second end of the feed member 221, and the feed member 221 may feed an electrical signal through offset feeding.

In an embodiment, a distance between the feed point 211 and an end part of the first end of the feed member 221 is less than a half of a length of the feed member 221. The feed member 221 may form a structure similar to a monopole or left-handed antenna.

It should be understood that a difference between the antenna 200 shown in FIG. 58 and the antenna 200 shown in FIG. 52 includes that the second end of the feed member 221 is an open end. In the antenna 200 shown in FIG. 52, the first end and the second end of the feed member 221 are ground ends, and the feed member 221 forms a radiator structure that conforms to a slot antenna. In the antenna 200 shown in FIG. 58, the first end of the feed member 221 is a ground end, the second end of the feed member 221 is an open end, and the feed member 221 may form a structure similar to a left-handed antenna. When an electrical signal is fed at the feed point, co-directional currents may also be generated on the radiator 210, which are similar to a part of currents on the feed member 221 shown in FIG. 52, and the radiator 210 may also be excited to generate a second resonance. In addition, because the first end of the feed member 221 is a ground end, and the second end is an open end, a size of the feed member 221 may be further reduced, to implement miniaturization.

In an embodiment, a distance between a projection of a ground point on the feed member 221 and the open end (the second end) of the feed member 221 is less than or equal to a half of the length of the feed member 221. In an embodiment, a distance between a projection of the open end (the end part of the second end) of the feed member 221 on the side frame 11 and the ground point is less than or equal to a quarter of a length of the radiator 210.

It should be understood that, the radiator 210 has a weaker electric field and a stronger current in an area near the ground point. The feed member 221 has a weaker current and a stronger electric field in an area near the open end. The area (the ground point) with a weaker electric field (a stronger magnetic field) of the radiator 210 is close to the area (the open end) with a stronger electric field (a stronger magnetic field) of the feed member 221, so that the first resonance and the second resonance can be more balanced.

In an embodiment, a projection of the feed member 221 on the side frame 11 is located between a first position and a second position.

In an embodiment, a proportion of a length of an overlapping part between the radiator 210 and a projection of the feed member 221 on the side frame 11 to a length of the radiator 210 is greater than or equal to 12.5%. In an embodiment, a proportion of a length of an overlapping part between the radiator 210 and a projection of the feed member 221 on the side frame 11 to a length of the radiator 210 is greater than or equal to 25%.

In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 50%.

In an embodiment, an electrical length of the feed member 221 is a quarter of a first wavelength, an electrical length of the radiator 210 is a half of the first wavelength, and the first wavelength is a wavelength corresponding to a center frequency between a resonance point of the first resonance and a resonance point of the second resonance.

In an embodiment, the electrical length of the feed member 221 is a half of the electrical length of the radiator 210. Correspondingly, a physical length of the feed member 221 is approximately a half of a physical length of the radiator 210. Because an electronic element coupled to the feed member 221/radiator 210 may increase or decrease the physical length when the electrical length remains unchanged, the physical length L1 of the radiator 210 and the physical length L2 of the feed member 221 satisfy: L1×25%≤L2≤L1×50%. In an embodiment, a physical length L1 of the radiator 210 and a physical length L2 of the feed member 221 satisfy: L1×50%≤L2≤L1×75%.

For brevity of description, similar parts between the antenna 200 shown in FIG. 58 and the antenna 200 shown in FIG. 9 are not described one by one again. For example, the similar parts include: The feed member 221 and the radiator 210 are configured to generate the first resonance and the second resonance; the first resonance and the second resonance are used to jointly support one operating frequency band; a provided position and a width of the first slot; a shape of the feed member 221, for example, a bar shape; a position at which the feed member 221 is disposed; and the like.

It should be understood that the feed members shown in the antenna 200 (for example, FIG. 52) shown in the foregoing embodiment may all use a structure in which the first end is a ground end and the second end is an open end, to reduce a size. This is not limited in embodiments of this application.

FIG. 59 and FIG. 60 show simulation results of the antenna 200 in the electronic device 10 shown in FIG. 58. FIG. 59 shows a simulation result of an S parameter of the antenna 200 in the electronic device 10 shown in FIG. 58. FIG. 60 shows simulation results of total efficiency and radiation efficiency of the antenna 200 in the electronic device 10 shown in FIG. 58.

As shown in FIG. 59, compared with the antenna shown in FIG. 52, the antenna shown in FIG. 58 may also generate a resonance near 1.9 GHz and a resonance near 2.2 GHz (resonance point frequencies of the two resonances are close, and therefore, the two resonances are combined into one resonance). However, because the first end of the feed member in the antenna shown in FIG. 58 is a ground end and the second end of the feed member is an open end, symmetry of a structure of the antenna is poor. In this case, an operating bandwidth of the antenna is narrow, and excitation near 2.6 GHz is enhanced by using a wire DM mode.

As shown in FIG. 60, the antenna does not generate a dip in an operating frequency band formed by the first resonance and the second resonance, and has better radiation efficiency and total efficiency.

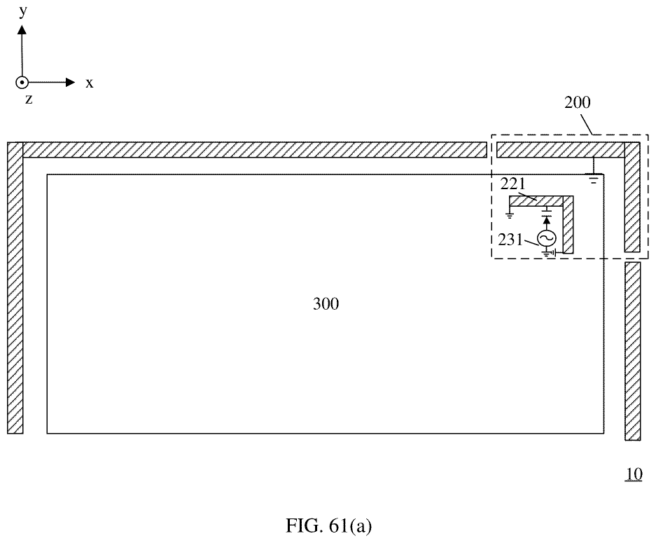

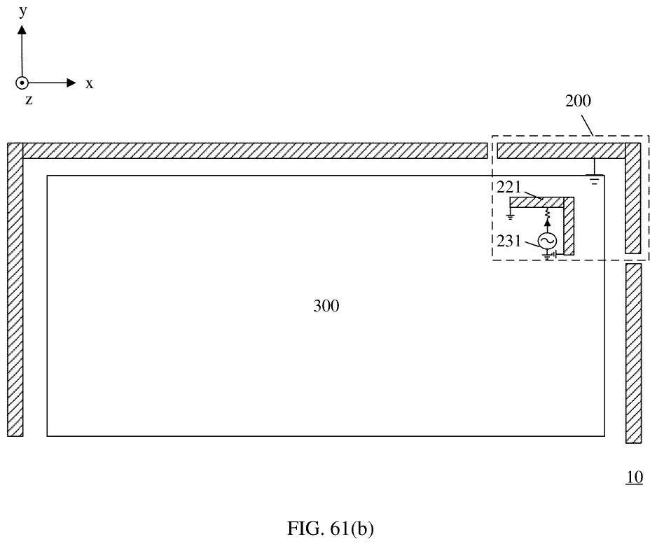

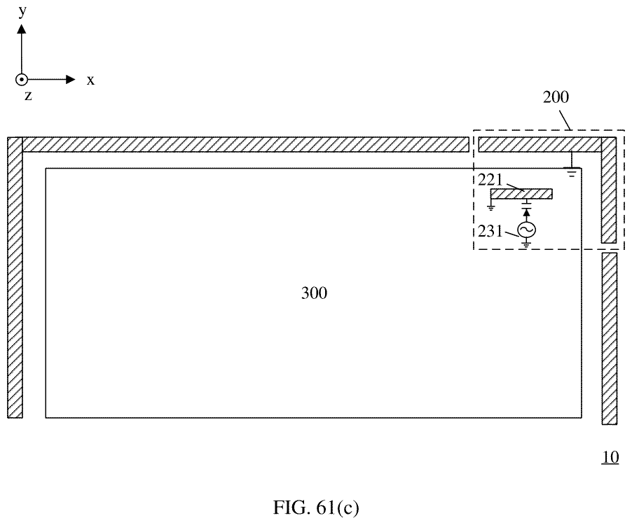

FIG. 61(a) to FIG. 61(c) are a diagram of another electronic device 10 according to an embodiment of this application.

It should be understood that, in the foregoing embodiment, whether a matching circuit is disposed between a feed circuit 231 and a feed member 221 is not shown. During actual application, the matching circuit may be disposed between the feed circuit 231 and the feed member 221, to adjust a radiation characteristic (for example, a resonance point frequency of a resonance) of an antenna 200.

In an embodiment, when a first end and a second end of the feed member 221 are ground ends (as shown in FIG. 52), a capacitor or an inductor may be disposed between the feed circuit 231 and the feed member 221, as shown in FIG. 61(a) and FIG. 61(b).

In an embodiment, when a first end of the feed member 221 is a ground end and a second end of the feed member 221 is an open end (as shown in FIG. 58), a capacitor may be disposed between the feed circuit 231 and the feed member 221, as shown in FIG. 61(c).

It should be understood that the foregoing capacitor and inductor are merely used as examples. During actual application, the capacitor and the inductor may alternatively be replaced with a circuit formed by cascading a plurality of capacitors and inductors. Values of the capacitor and the inductor may be determined based on actual production or design.

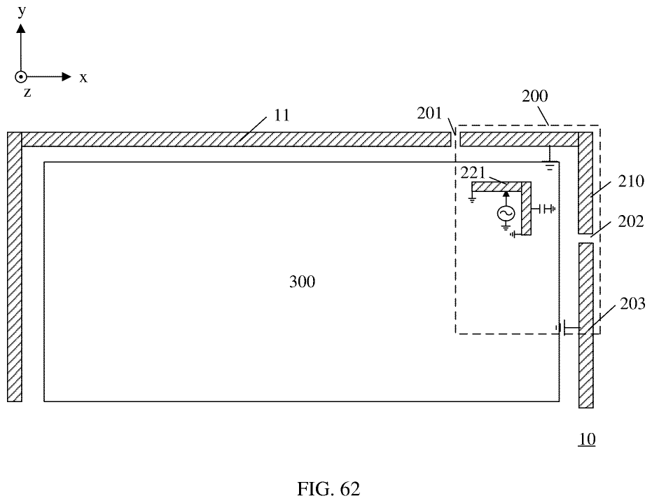

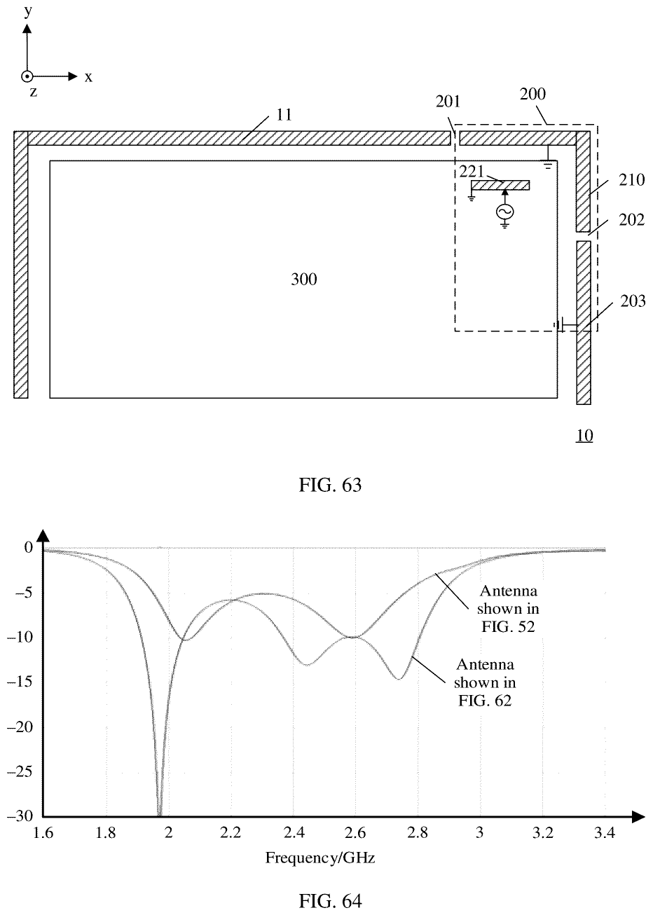

FIG. 62 is a diagram of another electronic device 10 according to an embodiment of this application.

As shown in FIG. 62, a side frame 11 includes a first position 201, a second position 202, and a third position 203 that are sequentially disposed, and the second position 202 is located between the first position 201 and the third position 203. The side frame 11 is provided with a first slot and a second slot respectively at the first position 201 and the second position 202. The side frame 11 further includes a ground point, located between the first position 201 and the second position 202. The side frame 11 is coupled to the ground plane 300 at the ground point. The side frame 11 is coupled to the ground plane 300 at the third position 203. In an embodiment, the ground point is located in a central area between the first position 201 and the second position 202.

The radiator 210 is a conductive part of the side frame 11 between the first position 201 and the second position 202. A conductive part of the side frame 11 between the second position 202 and the third position 203 is a parasitic stub.

It should be understood that a difference between the antenna 200 shown in FIG. 62 and the antenna 200 shown in FIG. 52 is the parasitic stub. The radiator 210 (the conductive part between the first position 201 and the second position 202) may form a radiator structure that conforms to a wire antenna, and the first resonance and the second resonance are generated in a wire CM mode. The parasitic stub and a part of the radiator (a conductive part between the ground point and the third position 203) may form a radiator structure that conforms to a slot antenna, and a fifth resonance is generated in a slot DM mode. In an embodiment, currents on the first radiators 210 on two sides of the second slot are reverse in direction.

In an embodiment, in a low band (less than or equal to 1 GHz, for example, 698 MHz to 960 MHz), a frequency difference between a resonance point frequency of the fifth resonance and a resonance point frequency of the first resonance or a resonance point frequency of the second resonance is greater than or equal to 50 MHz and less than or equal to 160 MHz. In a middle band (in a range of 1 GHz to 2 GHz, for example, 1710 MHz to 2170 MHz), a frequency difference between a resonance point frequency of the fifth resonance and a resonance point frequency of the first resonance or a resonance point frequency of the second resonance is greater than or equal to 120 MHz and less than or equal to 300 MHz. In a high band (in a range of 2 GHz to 3 GHz, for example, 2300 MHz to 2690 MHz), a frequency difference between a resonance point frequency of the fifth resonance and a resonance point frequency of the first resonance or a resonance point frequency of the second resonance is greater than or equal to 160 MHz and less than or equal to 500 MHz.

For brevity of description, similar parts between the antenna 200 shown in FIG. 62 and the antennas 200 shown in FIG. 52, FIG. 57, FIG. 58, FIG. 60, and FIG. 61(a) to FIG. 61(c) are not described one by one again, for example, a position relationship between the radiator 210 and the feed member 221, a position of the ground point, and a shape of the feed member 221, for example, a bar shape.

In an embodiment, a distance between the second position 202 and the third position 203 is greater than or equal to one third or less than or equal to two thirds of a distance between the first position 201 and the second position 202.

It should be understood that, in the technical solution shown in FIG. 62, the first radiator 210 is extended to the third position 203 of the side frame 11, and is grounded at the third position 203. A conductive part between the ground point and a ground point at the third position 203 may be used to form a radiator structure that conforms to an open-slot antenna, and the fifth resonance is generated in a slot DM mode. The technical solution may be applied to any one of the embodiments shown in FIG. 52 to FIG. 60.

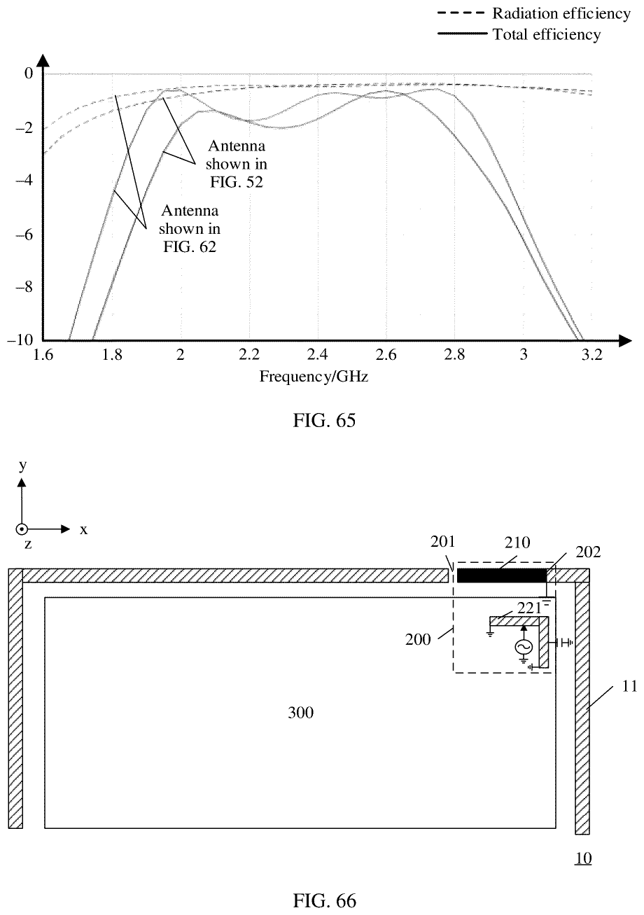

In an embodiment, the technical solution shown in FIG. 62 may be applied to the antenna 200 shown in FIG. 58, as shown in FIG. 63.

In the antenna 200 shown in FIG. 63, the first end of the feed member 221 is an open end, and the second end is a ground end. The feed member 221 may form a structure similar to a monopole or left-handed antenna. The feed member 221 of the structure may also excite the antenna 200 to generate the first resonance, the second resonance, and the fifth resonance.

FIG. 64 and FIG. 65 show simulation results of the antenna 200 in the electronic device 10 shown in FIG. 62. FIG. 64 shows a simulation result of an S parameter of the antenna 200 in the electronic device 10 shown in FIG. 62. FIG. 65 shows simulation results of total efficiency and radiation efficiency of the antenna 200 in the electronic device 10 shown in FIG. 62.

As shown in FIG. 64, in a range of 1.8 GHz to 3 GHz, compared with the antenna shown in FIG. 52, the antenna shown in FIG. 62 may additionally generate the fifth resonance near 2.7 GHz. In a case of using a boundary that S11 is less than −4 dB, an operating bandwidth is greater than an operating bandwidth of the antenna shown in FIG. 52.

As shown in FIG. 65, no efficiency dip is generated near the fifth resonance that can be additionally generated by the antenna. The antenna has good radiation efficiency and total efficiency in an operating frequency band formed by the first resonance, the second resonance, and the fifth resonance.

FIG. 66 is a diagram of another electronic device 10 according to an embodiment of this application.

As shown in FIG. 66, a side frame 11 is provided with a first slot at a first position 201, and is coupled to a ground plane 300 at a second position 202. A first end of a radiator 210 is an open end, and a second end of the radiator 210 is a ground end. The first end and the second end of the radiator 210 respectively correspond to the first position 201 and the second position 202 of the side frame 11. A first end and a second end of the feed member 221 are ground ends.

In an embodiment, a proportion of a length of an overlapping part between the radiator 210 and a projection of the feed member 221 on the side frame 11 to a length of the radiator 210 is greater than or equal to 50%.

In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 20%. In an embodiment, a proportion of a length of an overlapping part (the overlapping part between the radiator 210 and the projection of the feed member 221 on the side frame 11) between the feed member 221 and the radiator 210 in the first direction to a length of the feed member 221 is greater than or equal to 30%.

In an embodiment, the projection of the feed member 221 on the side frame 11 covers the second position 202.

It should be understood that, in this embodiment of this application, “covering” may be understood as that an area that is of the side frame and that is occupied by a projection formed by the feed member 221 on the side frame 11 includes the second position 202. As shown in FIG. 66, the projection of the feed member 221 on the side frame 11 is L-shaped, and the L-shaped area includes the second position 202.

In an embodiment, a distance between a projection of the second position 202 on the feed member 221 and a midpoint of the feed member 221 is less than or equal to a quarter of the length of the feed member 221. In an embodiment, the projection of the second position 202 on the feed member 221 is in a central area of the feed member 221.

When the second position 202 is located in a junction area of two sides of the side frame 11 (for example, the junction area may be understood as that when the second position 202 is located on a first side, a distance between the second position 202 and a second side in an extension direction of the first side is less than or equal to 10 mm, or the junction area may be understood as an arc-shaped area in which the first side and the second side intersect), the projection of the second position 202 on the feed member 221 may be understood as a projection of the second position 202 on the feed member 221 in a tangent direction of the junction area.

It should be understood that, the radiator 210 has a weaker electric field and a stronger current in an area near the second position 202. The feed member 221 has a weaker current and a stronger electric field in an area near the center. The area (the second position 202) with a weaker electric field (a stronger magnetic field) of the radiator 210 is close to the area (the midpoint) with a stronger electric field (a stronger magnetic field) of the feed member 221, so that the first resonance and the second resonance can be more balanced.

It should be understood that a difference between the antenna 200 shown in FIG. 66 and the antenna 200 shown in the foregoing embodiment includes that the second end of the radiator 210 is a ground end.

In the antenna 200 shown in FIG. 52 to FIG. 65, the first end and the second end of the radiator 210 are open ends, and the radiator 210 may form a radiator structure that conforms to a wire antenna. In the antenna 200 shown in FIG. 66, the first end of the radiator 210 is an open end, and the second end is a ground end. When an electrical signal is fed at the feed point, co-directional currents may also be generated on the radiator 210, and the radiator 210 may also be excited to generate the first resonance and the second resonance. In addition, because the first end of the radiator 210 is an open end, and the second end of the radiator 210 is a ground end, a size of the radiator 210 can be further reduced (for example, the size can be considered as being reduced from a half-wavelength structure to a quarter-wavelength structure), to implement miniaturization.

In an embodiment, an electrical length of the radiator 210 is a quarter of a first wavelength, an electrical length of the feed member 221 is a half of the first wavelength, and the first wavelength is a wavelength corresponding to a center frequency between a resonance point of the first resonance and a resonance point of the second resonance.

In an embodiment, the electrical length of the radiator 210 is a half of the electrical length of the feed member 221. Correspondingly, a physical length of the radiator 210 is approximately a half of a physical length of the feed member 221. Because an electronic element coupled to the feed member 221/radiator 210 may increase or decrease the physical length when the electrical length remains unchanged, the physical length L1 of the radiator 210 and the physical length L2 of the feed member 221 satisfy: L1×100%≤L2≤L1×200%. In an embodiment, a physical length L1 of the radiator 210 and a physical length L2 of the feed member 221 satisfy: L1×200%≤L2≤L1×300%.

For brevity of description, similar parts between the antenna 200 shown in FIG. 66 and the antenna 200 shown in FIG. 52 to FIG. 65 are not described one by one again. For example, the similar parts include: The radiator 210 and the feed member 221 are configured to generate the first resonance and the second resonance; the first resonance and the second resonance may be used to jointly support one operating frequency band; a width of the first slot provided; a shape of the feed member 221, for example, a bar shape; a position at which the feed member 221 is disposed; and the like.

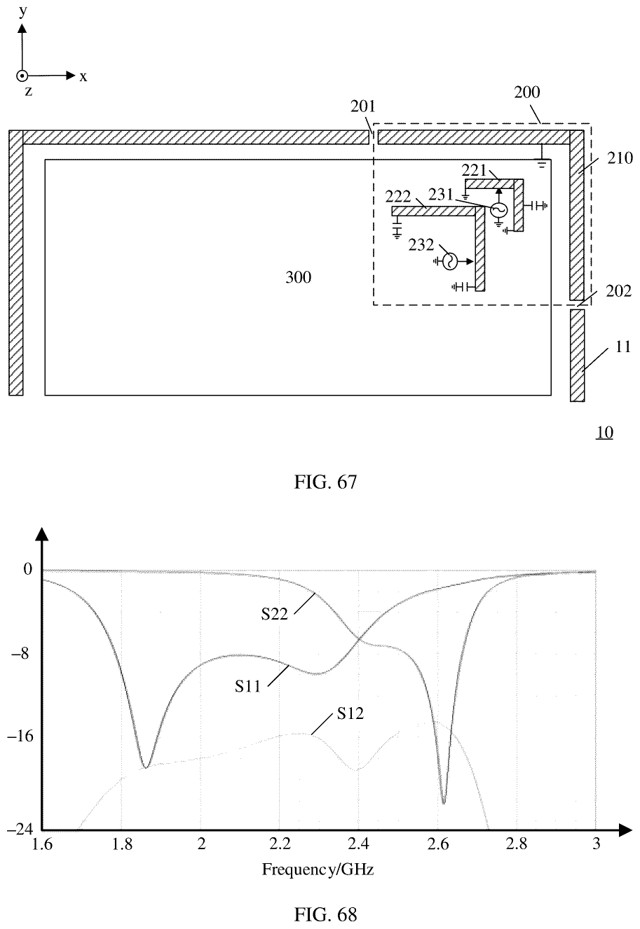

FIG. 67 is a diagram of an electronic device 10 according to an embodiment of this application.

As shown in FIG. 67, a side frame 11 includes a first position 201 and a second position 202. The side frame 11 is provided with a first slot and a second slot respectively at the first position 201 and the second position 202, a ground point is included between the first position 201 and the second position 202, and the side frame 11 is coupled to the ground plane 300 at the ground point. In an embodiment, the ground point is located in a central area between the first position 201 and the second position 202.

The antenna 200 may include a first feed member 221, a second feed member 222, and a radiator 210.

The radiator 210 is a conductive part of the side frame 11 between the first position 201 and the second position 202. A first end and a second end of the radiator 210 are open ends.

The first feed member 221, the second feed member 222, and the radiator 210 are spaced from each other. The radiator 210 at least partially overlaps the first feed member 221 and the second feed member 222 in a first direction, and the first direction is perpendicular to an extension direction (for example, a y direction) of the first radiator 210. The extension direction of the first radiator 210 is the same as an extension direction of the first feed member 221. A first end and a second end of the first feed member 221 are ground ends. A first end and a second end of the second feed member 222 are open ends.

The antenna 200 further includes a first feed circuit 231 and a second feed circuit 232. The first feed member 221 includes a first feed point, and the first feed circuit 231 is coupled to the first feed point. The second feed member 222 includes a second feed point 213, and the second feed circuit 232 is coupled to the second feed point 213.

It should be understood that, in the foregoing embodiments, an example in which the radiator and the feed member are in a one-to-one correspondence is used for description. In the embodiment shown in FIG. 67, the radiator may be excited by the two feed members to generate a resonance, thereby reducing a size of the antenna 200 while expanding a bandwidth.

The antenna 200 may include a first antenna and a second antenna. The radiator 210 and the first feed member 221 may form the first antenna. The radiator 210 and the second feed member 222 may form the second antenna.

In the first antenna, the radiator 210 forms a radiator structure that conforms to a wire antenna, and an electrical signal is fed through a first feed element. The radiator 210 may generate a first resonance and a second resonance in a wire CM mode. In an embodiment, the first resonance and the second resonance may be used to jointly support a first operating frequency band of the electronic device 10.

In the second antenna, the radiator 210 forms a radiator structure that conforms to a wire antenna, and an electrical signal is fed through a second feed element. The radiator 210 may generate a third resonance and a fourth resonance in a wire DM mode. In an embodiment, the third resonance and the fourth resonance may be used to jointly support a second operating frequency band of the electronic device 10.

In an embodiment, the first resonance and the second resonance may be close to each other, so that the first resonance and the second resonance are used to jointly support an operating frequency band of the electronic device 10. In an embodiment, a frequency difference between the first resonance and the second resonance is within a range of 5% to 20% (greater than or equal to 5% and less than or equal to 20%) of a low-frequency resonance frequency point or a high-frequency resonance frequency point. In an embodiment, in a low band (less than or equal to 1 GHz, for example, 698 MHz to 960 MHz), a frequency difference between a resonance point frequency of the first resonance and/or a resonance point frequency of the second resonance is greater than or equal to 50 MHz and less than or equal to 160 MHz. In a middle band (in a range of 1 GHz to 2 GHz, for example, 1710 MHz to 2170 MHz), a frequency difference between a resonance point frequency of the first resonance and/or a resonance point frequency of the second resonance is greater than or equal to 120 MHz and less than or equal to 300 MHz. In a high band (in a range of 2 GHz to 3 GHz, for example, 2300 MHz to 2690 MHz), a frequency difference between a resonance point frequency of the first resonance and/or a resonance point frequency of the second resonance is greater than or equal to 160 MHz and less than or equal to 500 MHz.

In an embodiment, the third resonance and the fourth resonance may be close to each other, so that the third resonance and the fourth resonance are used to jointly support an operating frequency band of the electronic device 10. In an embodiment, a frequency difference between the third resonance and the fourth resonance is within a range of 5% to 20% (greater than or equal to 5% and less than or equal to 20%) of a low-frequency resonance frequency point or a high-frequency resonance frequency point. In an embodiment, in a low band (less than or equal to 1 GHz, for example, 698 MHz to 960 MHz), a frequency difference between a resonance point frequency of the third resonance and/or a resonance point frequency of the fourth resonance is greater than or equal to 20 MHz and less than or equal to 160 MHz. In a middle band (in a range of 1 GHz to 2 GHz, for example, 1710 MHz to 2170 MHz), a frequency difference between a resonance point frequency of the third resonance and/or a resonance point frequency of the fourth resonance is greater than or equal to 120 MHz and less than or equal to 300 MHz. In a high band (in a range of 2 GHz to 3 GHz, for example, 2300 MHz to 2690 MHz), a frequency difference between a resonance point frequency of the third resonance and/or a resonance point frequency of the fourth resonance is greater than or equal to 160 MHz and less than or equal to 500 MHz.

Because there is good isolation between the wire CM mode and the wire DM mode, mutual interference between the first antenna and the second antenna is small. In an embodiment, the first operating frequency band and the second operating frequency band may be the same, and the first antenna and the second antenna may be used as sub-antennas in a MIMO system, to improve communication performance of the electronic device. In an embodiment, the first operating frequency band and the second operating frequency band may be different.

In an embodiment, at a resonance point of the first resonance, currents on radiators 210 on two sides of the ground point are reverse in direction. At a resonance point of the second resonance, the currents on the radiators 210 on the two sides of the ground point are reverse in direction.

In an embodiment, at a resonance point of the first resonance, and at a resonance point of the second resonance, currents on first feed member 221 on two sides of a center are reverse in direction. It should be understood that currents on the first feed member 221 are reversely distributed, and the first feed member 221 may operate in a slot DM mode.

In an embodiment, at a resonance point of the third resonance, currents on the radiators 210 on the two sides of the ground point are co-directional. At a resonance point of the fourth resonance, currents on the radiators 210 on the two sides of the ground point are co-directional.

In an embodiment, at the resonance point of the third resonance, the currents on the second feed member 222 are co-directional. At the resonance point of the fourth resonance, the currents on the second feed member 222 are co-directional. It should be understood that currents on the second feed member 222 are co-directionally distributed, and the second feed member 222 may operate in the wire DM mode.

In an embodiment, both ends of the first feed member 221 are ground ends, and an electrical length of the radiator 210 and an electrical length of the feed member 221 are the same, and both are a half of a first wavelength. The first wavelength is a wavelength corresponding to a center frequency between the resonance point of the first resonance and the resonance point of the second resonance.

In an embodiment, the electrical length of the radiator 210 and the electrical length of the first feed member 221 are the same. Correspondingly, a physical length of the radiator 210 and a physical length of the first feed member 221 are approximately the same. Because an electronic element coupled to the first feed member 221/radiator 210 may increase or decrease the physical length when the electrical length remains unchanged, the physical length L1 of the radiator 210 and the physical length L2 of the first feed member 221 satisfy: L1×50%≤L2≤L1. In an embodiment, a physical length L1 of the radiator 210 and a physical length L2 of the first feed member 221 satisfy: L1≤L2≤L1×150%.

In an embodiment, both ends of the second feed member 222 are open ends, an electrical length of the radiator 210 and an electrical length of the second feed member 222 are the same, and both are a half of a second wavelength. The second wavelength is a wavelength corresponding to a center frequency between the third resonance and the fourth resonance.

In an embodiment, the electrical length of the radiator 210 and the electrical length of the second feed member 222 are the same. Correspondingly, a physical length of the radiator 210 and a physical length of the second feed member 222 are approximately the same. Because an electronic element coupled to the second feed member 222/radiator 210 may increase or decrease the physical length when the electrical length remains unchanged, the physical length L1 of the radiator 210 and the physical length L3 of the second feed member 222 satisfy: L1×50%≤L3≤L1. In an embodiment, a physical length L1 of the radiator 210 and a physical length L3 of the second feed member 222 satisfy: L1≤L3≤L1×150%.

In an embodiment, in the electronic device 10, that the first feed member 221 and the second feed member 222 are spaced from each other may be understood as that the first feed member 221 and the second feed member 222 are not disposed on a same surface. For example, the first feed member 221 and the second feed member 222 may be respectively disposed on an upper surface and a lower surface of a bracket. Alternatively, the first feed member 221 and the second feed member 222 may be respectively disposed on different surfaces of a plurality of dielectric layers included in a PCB. Alternatively, the first feed member 221 and the second feed member 222 are respectively disposed on a surface of the bracket and a surface of the PCB.

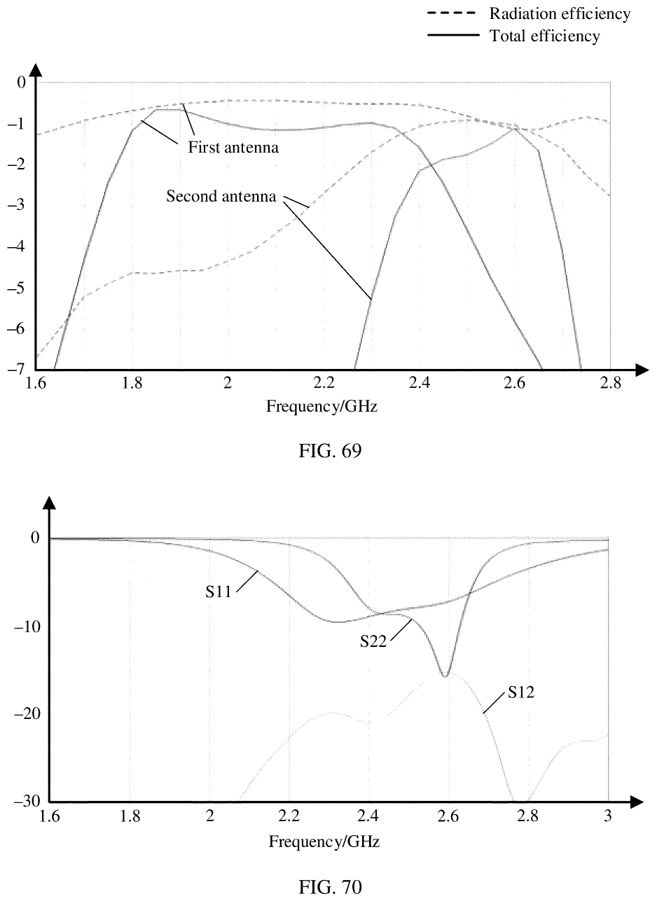

FIG. 68 and FIG. 69 show simulation results of the antenna 200 in the electronic device 10 shown in FIG. 67. FIG. 68 shows a simulation result of an S parameter of the antenna 200 in the electronic device 10 shown in FIG. 67. FIG. 69 shows simulation results of total efficiency and radiation efficiency of the antenna 200 in the electronic device 10 shown in FIG. 67.

As shown in FIG. 68, the first antenna (S11) may generate a resonance near 1.85 GHz and a resonance near 2.3 GHz, which may respectively correspond to the first resonance and the second resonance in the foregoing embodiments. The second antenna (S22) may generate a resonance near 2.45 GHz and a resonance near 2.6 GHz, which may respectively correspond to the third resonance and the fourth resonance in the foregoing embodiments.

The first resonance and the second resonance are generated in the wire DM mode, and the third resonance and the fourth resonance are generated in the wire CM mode. Therefore, the first antenna and the second antenna also have good isolation. In a case of using a boundary that S11/S22 is less than −4 dB, in respective resonance frequency bands, isolation (S12) between the first antenna and the second antenna is less than −14 dB.

As shown in FIG. 69, both the first resonance and the second resonance are generated in the wire CM mode. Because the wire CM mode has high radiation efficiency and total efficiency, the first antenna does not generate a dip in an operating frequency band formed by the first resonance and the second resonance, and has better radiation efficiency and total efficiency. However, both the third resonance and the fourth resonance are generated in the wire DM mode. Because the wire DM mode has lower radiation efficiency and total efficiency than the wire CM mode, the radiation efficiency and the total efficiency of the second antenna are lower than the radiation efficiency and the total efficiency of the first antenna.

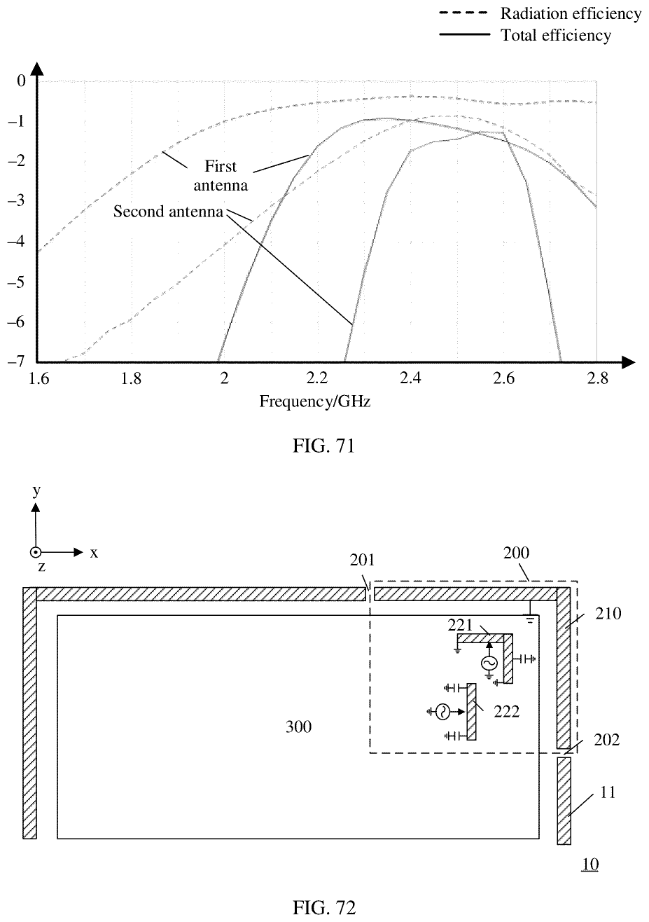

FIG. 70 and FIG. 71 show simulation results of the antenna 200 in the electronic device 10 shown in FIG. 67. FIG. 70 shows a simulation result of an S parameter of the antenna 200 in the electronic device 10 shown in FIG. 67. FIG. 71 shows simulation results of total efficiency and radiation efficiency of the antenna 200 in the electronic device 10 shown in FIG. 67.

It should be understood that, in the simulation results shown in FIG. 68 and FIG. 69, an example in which the first operating frequency band formed by the first resonance and the second resonance is different from the second operating frequency band formed by the third resonance and the fourth resonance is used for description. In the simulation results shown in FIG. 70 and FIG. 71, the first operating frequency band formed by the first resonance and the second resonance and the second operating frequency band formed by the third resonance and the fourth resonance may be the same by adjusting some parameters. For example, the parameters may be a first feed point position, a second feed point position, a spacing between the feed member and the radiator, and an element coupled to the feed member/radiator.

As shown in FIG. 70, the first antenna (S11) may generate a resonance near 2.3 GHz and a resonance near 2.6 GHz, which may respectively correspond to the first resonance and the second resonance in the foregoing embodiments. The second antenna (S22) may generate a resonance near 2.45 GHz and a resonance near 2.6 GHz, which may respectively correspond to the third resonance and the fourth resonance in the foregoing embodiments.

The first resonance and the second resonance are generated in the wire CM mode, and the third resonance and the fourth resonance are generated in the wire DM mode. Therefore, when the first operating frequency band and the second operating frequency band are the same, the first antenna and the second antenna also have good isolation. In a case of using a boundary that S11/S22 is less than −4 dB, in respective resonance frequency bands, isolation (S12) between the first antenna and the second antenna is less than −15 dB.

As shown in FIG. 71, both the first resonance and the second resonance are generated in the wire CM mode. Because the wire CM mode has high radiation efficiency and total efficiency, the first antenna does not generate a dip in an operating frequency band formed by the first resonance and the second resonance, and has better radiation efficiency and total efficiency. However, both the third resonance and the fourth resonance are generated in the wire DM mode. Because the wire DM mode has lower radiation efficiency and total efficiency than the wire CM mode, the radiation efficiency and the total efficiency of the second antenna are lower than the radiation efficiency and the total efficiency of the first antenna.

FIG. 72 is a diagram of an electronic device 10 according to an embodiment of this application.

It should be understood that, in the foregoing embodiments, an example in which the radiator is in a half-wavelength mode of a CM mode/DM mode is used for description. Correspondingly, an operating mode of the feed member is also a half-wavelength mode (when both ends of the feed member are ground ends/open ends, or when one end of the feed member is a ground end and the other end of the feed member is an open end, an operating mode of the feed member is a quarter-wavelength mode).

However, in an antenna 200 shown in FIG. 72, a first antenna is the same as the first antenna shown in FIG. 67. In the first antenna, a radiator 210 operates in a half-wavelength mode of a wire CM mode. However, a second antenna is different from the second antenna shown in FIG. 67. In the second antenna shown in FIG. 72, a second feed member 222 may excite a three-half wavelength mode of the radiator 210. Correspondingly, a third resonance and a fourth resonance may be generated in a three-half wavelength mode of the wire DM mode.

In addition, when the third resonance and the fourth resonance may be generated in the three-half wavelength mode, an operating mode of the second feed member 222 may be a half-wavelength mode, and an electrical length of the second feed member 222 is one third of an electrical length of the radiator 210. This may further reduce a size of the second feed member 222. In an embodiment, a physical length L1 of the radiator 210 and a physical length L3 of the second feed member 222 satisfy: L1×20%≤L3≤L1×50%.

In an embodiment, in the first antenna, the radiator 210 forms a radiator structure that conforms to a wire antenna, and an electrical signal is fed through the first feed element. The radiator 210 may generate a first resonance, a second resonance, a fifth resonance, and a sixth resonance in the wire CM mode. The first resonance and the second resonance are used to jointly support a first operating frequency band of the electronic device 10, and the fifth resonance and the sixth resonance may be used to jointly support a third operating frequency band of the electronic device 10. In an embodiment, the first resonance and the second resonance may be generated in the half-wavelength mode of the wire CM mode. In an embodiment, the fifth resonance and the sixth resonance may be generated in a one-fold wavelength mode of the wire CM mode.

In the second antenna, the radiator 210 forms a radiator structure that conforms to a wire antenna, and an electrical signal is fed through a second feed element. The radiator 210 may generate the third resonance and the fourth resonance in the wire DM mode, and the third resonance and the fourth resonance are used to jointly support a second operating frequency band of the electronic device 10. In an embodiment, the third resonance and the fourth resonance may be generated in the three-half wavelength mode of the wire DM mode.

In an embodiment, the third operating frequency band and the second operating frequency band may be the same, and the first antenna and the second antenna may be used as sub-antennas in a MIMO system, to improve communication performance of the electronic device. In an embodiment, the third operating frequency band and the second operating frequency band may be different.

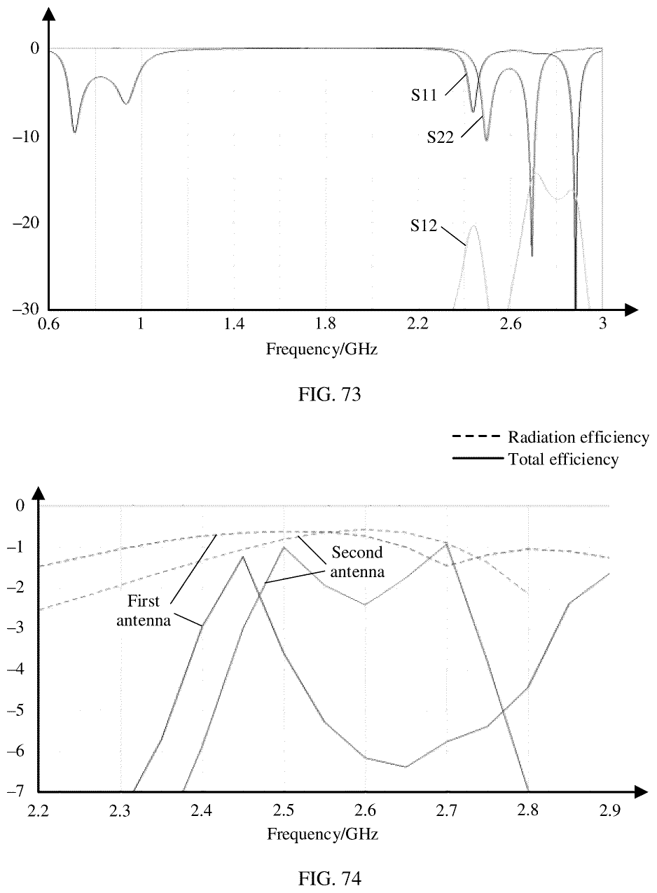

FIG. 73 and FIG. 74 show simulation results of the antenna 200 in the electronic device 10 shown in FIG. 72. FIG. 73 shows a simulation result of an S parameter of the antenna 200 in the electronic device 10 shown in FIG. 72. FIG. 74 shows simulation results of total efficiency and radiation efficiency of the antenna 200 in the electronic device 10 shown in FIG. 72.

As shown in FIG. 73, the first antenna (S11) may generate a resonance near 0.7 GHz, a resonance near 0.95 GHz, a resonance near 2.45 GHz, and a resonance near 2.9 GHz, which may correspond to the first resonance and the second resonance, and the fifth resonance and the sixth resonance in the foregoing embodiments. The second antenna (S22) may generate a resonance near 2.5 GHz and a resonance near 2.7 GHz, which may respectively correspond to the third resonance and the fourth resonance in the foregoing embodiments.

The first resonance and the second resonance are generated in the half-wavelength mode of the wire CM mode, the fifth resonance and the sixth resonance are generated in the one-fold wavelength mode of the wire CM mode, and the third resonance and the fourth resonance may be generated in the three-half wavelength mode of the wire DM mode. Therefore, when resonance point frequencies of the fifth resonance and the sixth resonance are approximately the same as those of the third resonance and the fourth resonance, the first antenna and the second antenna also have good isolation. In a case of using a boundary that S11/S22 is less than −4 dB, in respective resonance frequency bands, isolation (S12) between the first antenna and the second antenna is less than −14 dB.

As shown in FIG. 74, in a resonance frequency band of the fifth resonance and the sixth resonance and a resonance frequency band of the third resonance and the fourth resonance, the first antenna and the second antenna have good radiation efficiency and total efficiency.

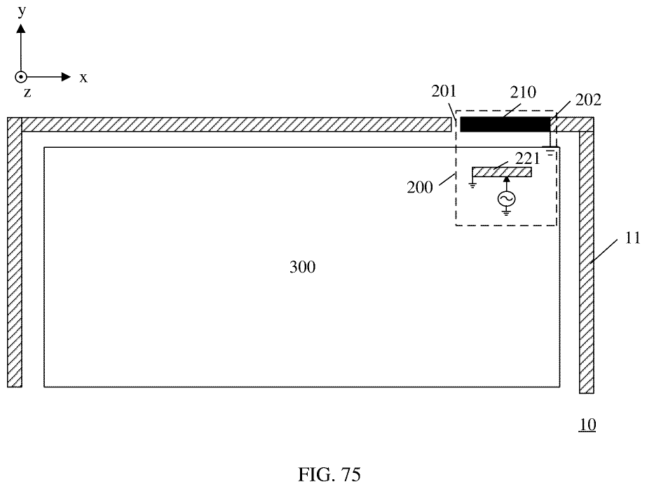

FIG. 75 is a diagram of an electronic device 10 according to an embodiment of this application.

As shown in FIG. 75, a side frame 11 is provided with a first slot at a first position 201, and is coupled to a ground plane 300 at a second position 202. A first end of a radiator 210 is an open end, and a second end of the radiator 210 is a ground end. The first end and the second end of the radiator 210 respectively correspond to the first position 201 and the second position 202 of the side frame 11. A first end of the feed member 221 is a ground end, and a second end of the feed member 221 is an open end.

A proportion of a length of an overlapping part between the radiator 210 and a projection of the feed member 221 on the side frame 11 to a length of the feed member 221 is greater than or equal to 25%. In an embodiment, a projection of the feed member 221 on the side frame 11 completely overlaps the radiator 210.

It should be understood that, in the foregoing embodiment, the following cases are listed: (1) The first end and the second end of the radiator 210 are ground ends, and the first end and the second end of the feed member 221 are open ends. (2) The first end and the second end of the radiator 210 are ground ends, the first end of the feed member 221 is a ground end, and the second end of the feed member 221 is an open end. (3) The first end of the radiator 210 is a ground end, the second end of the radiator 210 is an open end, and the first end and the second end of the feed member 221 are open ends. (4) The first end and the second end of the radiator 210 are open ends, and the first end and the second end of the feed member 221 are ground ends. (5) The first end and the second end of the radiator 210 are open ends, the first end of the feed member 221 is a ground end, and the second end of the feed member 221 is an open end. (6) The first end of the radiator 210 is an open end, the second end of the radiator 210 is a ground end, and the first end and the second end of the feed member 221 are ground ends.

A difference between the antenna 200 shown in FIG. 75 and the antenna 200 shown in the foregoing embodiment includes that the first end of the radiator 210 is an open end, and the second end is a ground end. The first end of the feed member 221 is a ground end, and the second end of the feed member 221 is an open end. When an electrical signal is fed at the feed point, the radiator 210 may also be excited to generate a first resonance and a second resonance. In addition, because the first end of the radiator 210 is an open end, the second end of the radiator 210 is a ground end, and the first end and the second end of the feed member 221 are ground ends, a size of the radiator 210 and a size of the feed member 221 can be further reduced (for example, the size can be considered as being reduced from a half-wavelength structure to a quarter-wavelength structure), to implement miniaturization.

In an embodiment, an electrical length of the radiator 210 is a quarter of a first wavelength, an electrical length of the feed member 221 is a quarter of the first wavelength, and the first wavelength is a wavelength corresponding to a center frequency between a resonance point of the first resonance and a resonance point of the second resonance.

In an embodiment, the electrical length of the radiator 210 and the electrical length of the feed member 221 are the same. Correspondingly, a physical length of the radiator 210 and a physical length of the feed member 221 are approximately the same. Because an electronic element coupled to the feed member 221/radiator 210 may increase or decrease the physical length when the electrical length remains unchanged, the physical length L1 of the radiator 210 and the physical length L2 of the feed member 221 satisfy: L1×50%≤L2≤L1. In an embodiment, a physical length L1 of the radiator 210 and a physical length L2 of the feed member 221 satisfy: L1≤L2≤L1×150%.

In an embodiment, a capacitor may be disposed between a feed circuit and the feed member. In an embodiment, a capacitance value of the capacitor is less than or equal to 1.5 pF. In an embodiment, a distance between the feed point and the first end (the ground end) of the feed member 221 is greater than a distance between the feed point and the second end (the open end) of the feed member 221. The feed member 221 may form a structure similar to a monopole or a left-handed antenna, to further reduce a size of the feed member 221.

For brevity of description, similar parts between the antenna 200 shown in FIG. 75 and the antenna 200 shown in the foregoing embodiment are not described one by one again. For example, the similar parts include: a position of the radiator 210 and a position relationship between the radiator 210 and the feed member 221; the radiator 210 is configured to generate the first resonance and the second resonance; the first resonance and the second resonance may be used to jointly support one operating frequency band; a width of the first slot provided; a shape of the feed member 221, for example, a bar shape; a position at which the feed member 221 is disposed; and the like.

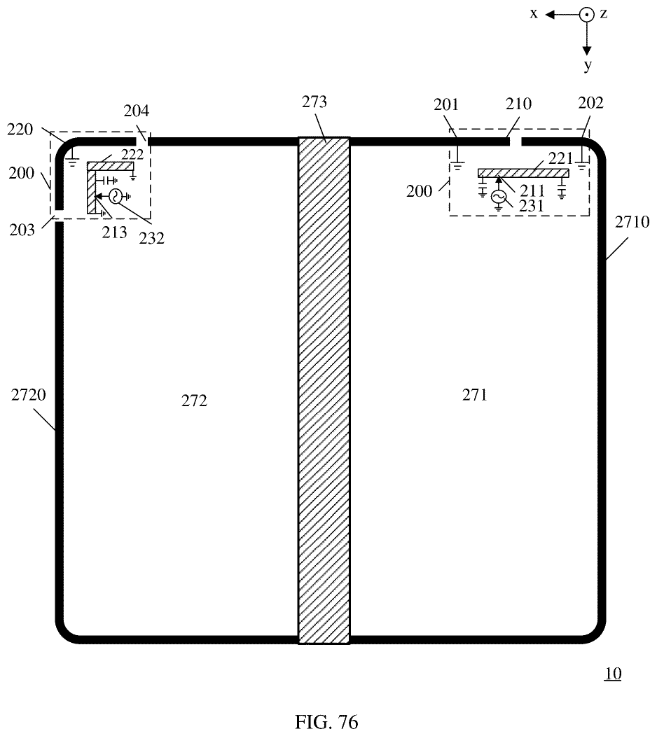

FIG. 76 is a diagram of an electronic device 10 according to an embodiment of this application.

It should be understood that, in the foregoing embodiment, only an example in which the electronic device 10 includes a single housing (for example, the middle frame 19 shown in FIG. 1) is used for description. The technical solutions provided in embodiments of this application may also be applied to a foldable electronic device including a plurality of housings. The plurality of housings may be close to each other or away from each other through rotating shafts that are rotatably connected, to implement an unfolding and folding function (switching between an unfolded state and a folded state) of the foldable electronic device 10. In the unfolded state, an angle between the plurality of housings may be approximately 180°. In the folded state, the foldable electronic device 10 is currently bent, and a bending degree of the foldable electronic device 10 reaches a maximum.

As shown in FIG. 76, the electronic device 10 may include a first housing 271, a second housing 272, and a first rotating shaft 273.

The first rotating shaft 273 is located between the first housing 271 and the second housing 272, and the first rotating shaft 273 is rotatably connected to the first housing 271 and the second housing 272, so that the first housing 271 and the second housing 272 can rotate relative to each other.

The first housing 271 includes a first side frame 2710, and the second housing 272 includes a second side frame 2720.

The first side frame 2710 includes a first position 201 and a second position 202. The second side frame 2720 includes a third position 203 and a fourth position 204. The first side frame 2710 is coupled to a ground plane at the first position 201 and the second position 202. The second side frame 2720 is provided with a first slot and a second slot respectively at the third position 203 and the fourth position 204.

The first side frame 2710 is provided with a third slot between the first position 201 and the second position 202. In an embodiment, the third slot is located in a central area between the first position 201 and the second position 202.

The second side frame 2720 includes a ground point between the third position 203 and the fourth position 204, and the second side frame 2720 is coupled to the ground plane at the ground point. In an embodiment, the ground point is located in a central area between the third position 203 and the fourth position 204.

The antenna 200 may include a first feed member 221, a second feed member 222, a first radiator 210, and a second radiator 220. The first radiator 210 is a conductive part between the first position 201 and the second position 202. The second radiator 220 is a conductive part between the third position 203 and the fourth position 204. The first radiator 210 and the first feed member 221 are spaced from each other, and the first radiator 210 and the first feed member 221 at least partially overlap in a first direction. The first direction is perpendicular to an extension direction (for example, a y direction) of the first radiator 210. The extension direction of the first radiator 210 is the same as an extension direction of the first feed member 221. The second radiator 220 and the second feed member 222 are spaced from each other, and the second radiator 220 and the second feed member 222 at least partially overlap in a second direction. The second direction is perpendicular to an extension direction (for example, an x direction) of the second radiator 220. The extension direction of the second radiator 220 is the same as an extension direction of the second feed member 222. The first direction and the second direction may be the same or different. A first end and a second end of the first feed member 221 are open ends. A first end and a second end of the second feed member 222 are ground ends.

The antenna 200 further includes a first feed circuit 231 and a second feed circuit 232. The first feed member 221 includes a first feed point 211, and the first feed circuit 231 is coupled to the first feed point 211. The second feed member 222 includes a second feed point 213, and the second feed circuit 232 is coupled to the second feed point 213.

It should be understood that the antenna 200 may include a first antenna and a second antenna. The first radiator 210 may form the first antenna. The second radiator 220 may form the second antenna.

The first radiator 210 may form a radiator structure that conforms to a slot antenna. The first radiator 210 may generate a first resonance and a second resonance in a slot CM mode through the first feed circuit 231, and the first resonance and the second resonance are used to jointly support a first operating frequency band of the electronic device 10.

The second radiator 220 may form a radiator structure that conforms to a wire antenna. The second radiator 220 may generate a third resonance and a fourth resonance in a wire CM mode through the second feed element 232, and the third resonance and the fourth resonance are used to jointly support a second operating frequency band of the electronic device 10.

Because there is good isolation between the slot CM mode and the wire CM mode, mutual interference between the first antenna and the second antenna is small. In an embodiment, the first operating frequency band and the second operating frequency band may be the same or adjacent. In an embodiment, the first antenna and the second antenna may be used as sub-antennas in a MIMO system, to improve communication performance of the electronic device. In an embodiment, the first operating frequency band and the second operating frequency band may be different.

In an embodiment, the first antenna may be any one of the antennas 200 described in FIG. 9 to FIG. 40 or an antenna obtained by combining any plurality of antenna structures in FIG. 9 to FIG. 40, and the second antenna may be any one of the antennas 200 described in FIG. 52 to FIG. 60 or an antenna obtained by combining any plurality of antenna structures in FIG. 52 to FIG. 60, and may be selected based on actual production or design. For brevity of description, similar parts between the antenna 200 shown in FIG. 76 and the antenna 200 shown in the foregoing embodiments are not described one by one again. For example, the similar parts include: a position relationship between the radiator and the corresponding feed member; a width of a slot provided in a side frame; a shape of the feed member, for example, a bar shape; a position at which the feed member is disposed; an operating frequency band formed by two resonances; and the like.

In addition, for brevity of description, in the antenna 200 shown in FIG. 76, only an example in which both the first end and the second end of the first feed member 221 are open ends, and both the first end and the second end of the second feed member 222 are ground ends is used for description. In actual production or design, for the first feed member 221 and the second feed member 222 shown in FIG. 76, refer to the foregoing embodiments. The first end and the second end may alternatively be an open end and a ground end, respectively.

It should be understood that when the first end and the second end of the first radiator 210 are ground ends, the first end and the second end of the first feed member 221 are open ends, the first end and the second end of the second radiator 220 are open ends, and the first end and the second end of the second feed member 222 are ground ends, isolation between the first antenna and the second antenna is better.

In an embodiment, a length of the first radiator 210 and a length of the second radiator 220 are approximately the same. In an embodiment, a proportion of the length of the first radiator 210 to the length of the second radiator 220 is greater than or equal to 90% and less than or equal to 110%.

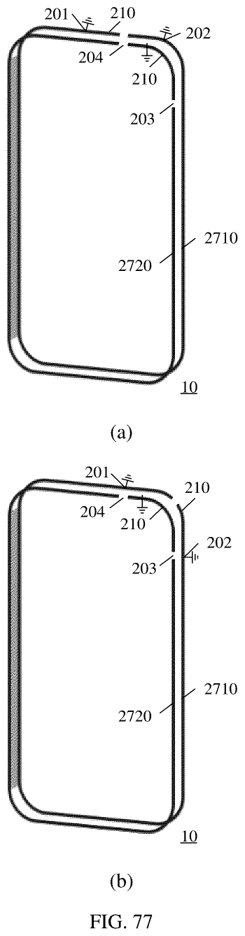

In an embodiment, when the electronic device 10 is in the folded state, the first slot or the second slot is aligned with the third slot, as shown in (a) in FIG. 77. Alignment may be understood as that the first slot or the second slot and the third slot at least partially overlap in a third direction. The third direction is a thickness direction of the electronic device 10, for example, a z direction.

It should be understood that alignment of the first slot or the second slot with the third slot may make a housing of the electronic device 10 more attractive, and improve user experience. When the first slot or the second slot is aligned with the third slot, correspondingly, the first radiator 210 and the second radiator 220 at least partially overlap in the third direction.

In an embodiment, when the electronic device 10 is in the folded state, the first slot or the second slot is not aligned with the third slot, as shown in (b) in FIG. 77.

In an embodiment, a proportion of a length of an overlapping part between the second radiator 220 and a projection of the first radiator 210 on the second side frame 2720 to a length of the second radiator 220 is greater than or equal to 50%. In an embodiment, the projection of the first radiator 210 on the second side frame 2720 completely overlaps the second radiator 220.

In an embodiment, a proportion of a length of an overlapping part between the first radiator 210 and a projection of the second radiator 220 on the first side frame 2710 to a length of the first radiator 210 is greater than or equal to 50%. In an embodiment, the projection of the second radiator 220 on the first side frame 2710 completely overlaps the first radiator 210.

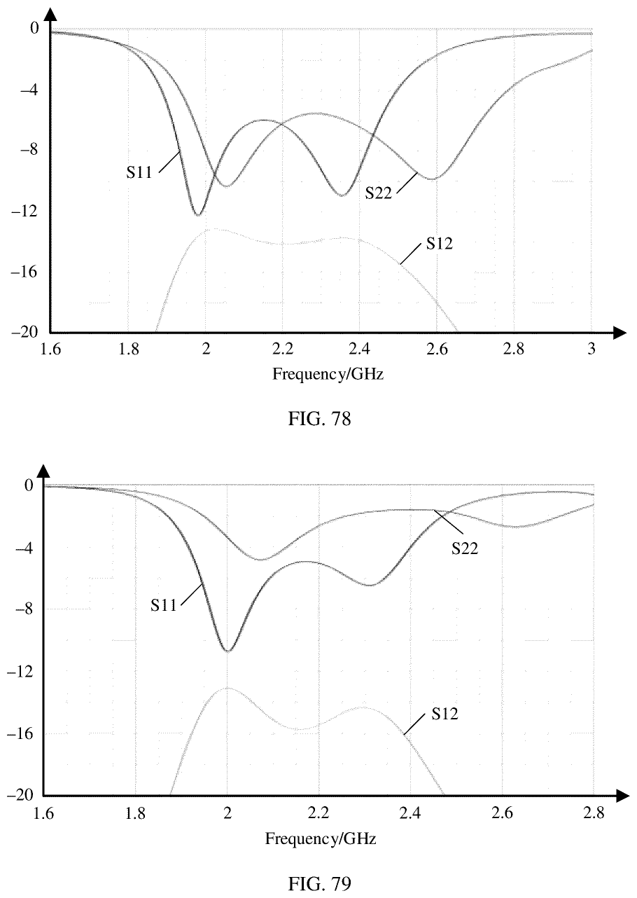

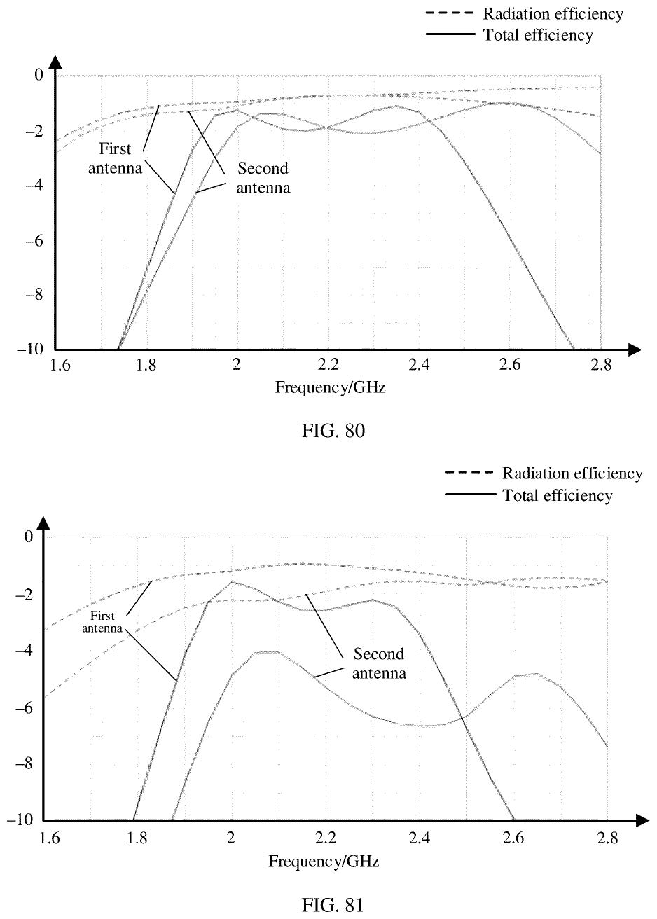

FIG. 78 to FIG. 81 show simulation results of the antenna 200 in the electronic device 10 shown in FIG. 76. FIG. 78 shows a simulation result of an S parameter of the antenna 200 when the electronic device 10 shown in FIG. 76 is in the unfolded state. FIG. 79 shows a simulation result of an S parameter of the antenna 200 when the electronic device 10 shown in FIG. 76 is in the folded state. FIG. 80 shows simulation results of total efficiency and radiation efficiency of the antenna 200 when the electronic device 10 shown in FIG. 76 is in the unfolded state. FIG. 81 shows simulation results of total efficiency and radiation efficiency of the antenna 200 when the electronic device 10 shown in FIG. 76 is in the folded state.

As shown in FIG. 78, when the electronic device 10 is in the unfolded state, the first antenna (S11) may generate a resonance near 2 GHz and a resonance near 2.35 GHz, which may respectively correspond to the first resonance and the second resonance in the foregoing embodiments. The second antenna (S22) may generate a resonance near 2 GHz and a resonance near 2.6 GHz, which may respectively correspond to the third resonance and the fourth resonance in the foregoing embodiments.

As shown in FIG. 79, when the electronic device 10 is in the folded state, the first antenna (S11) may generate a resonance near 2 GHz and a resonance near 2.3 GHz, and the second antenna (S22) may generate a resonance near 2.1 GHz and a resonance near 2.6 GHz. Resonance point frequencies at which the first antenna and the second antenna generate resonances when the electronic device 10 is in the folded state are approximately the same as resonance point frequencies at which the first antenna and the second antenna generate resonances when the electronic device 10 is in the unfolded state.

In addition, when the electronic device 10 is in the folded state, the first resonance and the second resonance are generated in the slot CM mode, and the third resonance and the fourth resonance are generated in the wire CM mode. Compared with the electronic device 10 in the unfolded state (when a distance between the first antenna and the second antenna is large), the electronic device 10 in the folded state also has good isolation between the first antenna and the second antenna. Therefore, when the electronic device 10 is in the folded state or the unfolded state, in a case of using a boundary that S11/S22 is less than −4 dB, isolation (S12) between the first antenna and the second antenna is less than −13 dB in a resonance frequency band. The first antenna and the second antenna may be used as sub-antennas in a MIMO system.

It should be understood that, for brevity of description, in the foregoing embodiments, an example in which the first antenna and the second antenna may be used as sub-antennas in the MIMO system is used for description. In actual production or design, the first antenna and the second antenna may alternatively operate in different operating frequency bands.

As shown in FIG. 80 and FIG. 81, both the first resonance and the second resonance may be generated in the slot CM mode, and both the third resonance and the fourth resonance may be generated in the wire CM mode. Because the slot CM mode/the wire CM mode has high radiation efficiency and total efficiency, when the electronic device 10 is in the folded state or the unfolded state, the antenna has good radiation efficiency and total efficiency in an operating frequency band formed by the first resonance and the second resonance/the third resonance and the fourth resonance.

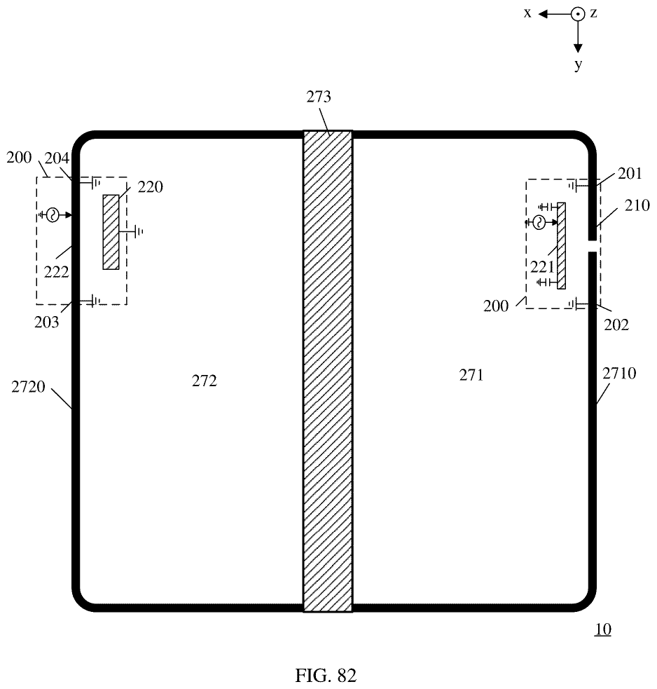

FIG. 82 is a diagram of an electronic device 10 according to an embodiment of this application.

As shown in FIG. 82, a structure of a first antenna in an antenna 200 is the same as that of the first antenna in the antenna 200 shown in FIG. 76, and a first radiator 210 is a conductive part between a first position 201 and a second position 202. A difference between the antenna 200 shown in FIG. 82 and the antenna 200 shown in FIG. 76 includes that a conductive part of a second side frame 2720 between a third position 203 and a fourth position 204 is used as a second feed member 222, a second radiator 220 is disposed on a surface of a bracket, and the second side frame 2720 is coupled to a ground plane at a third position 203 and a fourth position 204.

It should be understood that, in the electronic device 10 shown in FIG. 82, no slot needs to be provided at the third position 203 and the fourth position 204 of the second side frame 2720, thereby ensuring integrity of the second side frame 2720 and improving an aesthetic degree.

For brevity of description, only the second radiator 220 and the second feed member 222 in the second antenna are used as an example for description. In actual production or design, the first radiator 210 and the first feed member 221 in the first antenna may also use a same design solution, and the conductive part between the first position 201 and the second position 202 is used as the first feed member 221.

In an embodiment, the first radiator 210 and the second feed member 221 at least partially overlap in a third direction. In an embodiment, the first radiator 210 and the second feed member 221 completely overlap in the third direction.

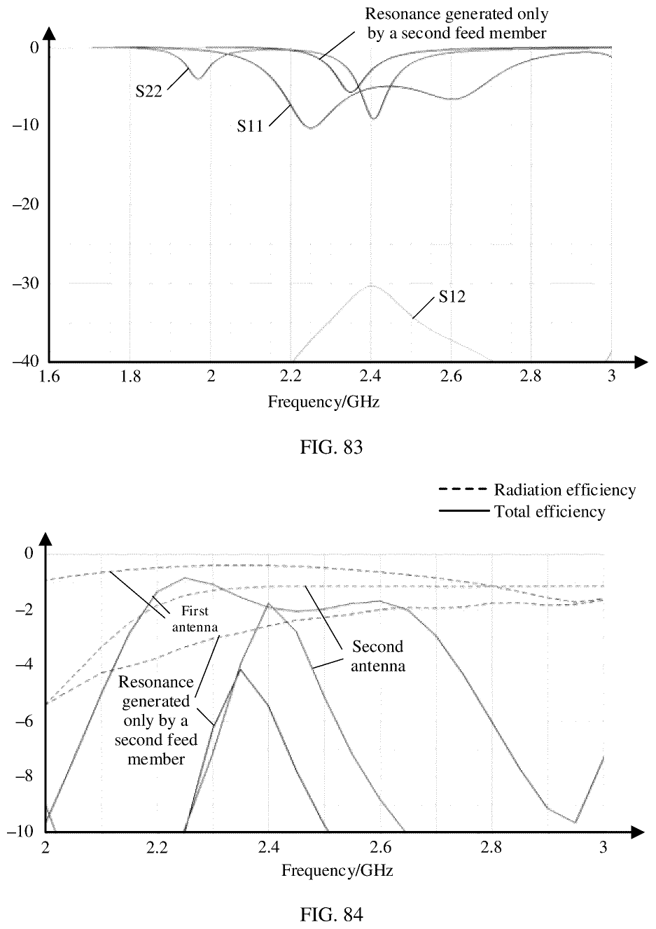

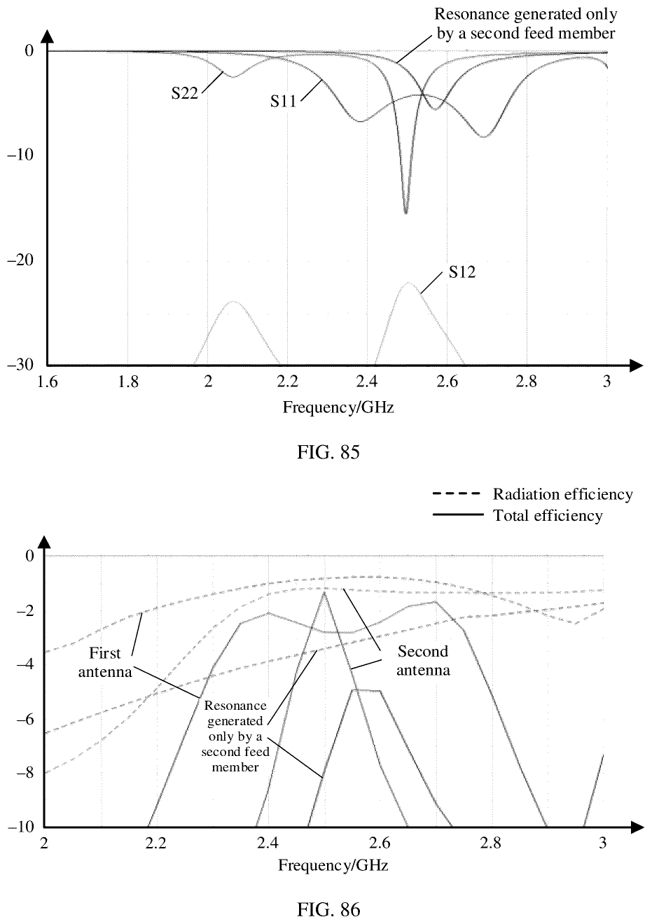

FIG. 83 to FIG. 86 show simulation results of the antenna 200 in the electronic device 10 shown in FIG. 82. FIG. 83 shows a simulation result of an S parameter of the antenna 200 when the electronic device 10 shown in FIG. 82 is in the unfolded state. FIG. 84 shows a simulation result of an S parameter of the antenna 200 when the electronic device 10 shown in FIG. 82 is in the folded state. FIG. 85 shows simulation results of total efficiency and radiation efficiency of the antenna 200 when the electronic device 10 shown in FIG. 82 is in the unfolded state. FIG. 86 shows simulation results of total efficiency and radiation efficiency of the antenna 200 when the electronic device 10 shown in FIG. 82 is in the folded state.

As shown in FIG. 83, when the electronic device 10 is in the unfolded state, the first antenna (S11) may generate a resonance near 2.25 GHz and a resonance near 2.6 GHz, which may respectively correspond to the first resonance and the second resonance in the foregoing embodiments. The second antenna (S22) may generate a resonance near 1.95 GHz and a resonance near 2.4 GHz, which may respectively correspond to the third resonance and the fourth resonance in the foregoing embodiments.

When the electronic device 10 is in the unfolded state, for the second antenna, when the second radiator is not disposed, the second antenna generates a resonance near 2.35 GHz through a radiator structure (in a slot DM mode) that includes the second feed member and that conforms to a slot antenna.

As shown in FIG. 84, when the electronic device 10 is in the folded state, the first antenna (S11) may generate a resonance near 2.35 GHz and a resonance near 2.7 GHz, and the second antenna (S22) may generate a resonance near 2.05 GHz and a resonance near 2.5 GHz. Resonance point frequencies at which the first antenna and the second antenna generate resonances when the electronic device 10 is in the folded state are approximately the same as resonance point frequencies at which the first antenna and the second antenna generate resonances when the electronic device 10 is in the unfolded state.

When the electronic device 10 is in the folded state, no second radiator is disposed, and the second antenna only generates a resonance near 2.55 GHz through a radiator structure (in a slot DM mode) that includes the second feed member and that conforms to a slot antenna.

In addition, when the electronic device 10 is in the folded state, the first resonance and the second resonance are generated in the slot CM mode, and the third resonance and the fourth resonance are generated in the wire CM mode. Compared with the electronic device 10 in the unfolded state (when a distance between the first antenna and the second antenna is large), the electronic device 10 in the folded state also has good isolation between the first antenna and the second antenna. Therefore, when the electronic device 10 is in the folded state or the unfolded state, in a case of using a boundary that S11/S22 is less than −4 dB, isolation (S12) between the first antenna and the second antenna is less than −20 dB in a resonance frequency band. The first antenna and the second antenna may be used as sub-antennas in a MIMO system.

It should be understood that, for brevity of description, in the foregoing embodiments, an example in which the first antenna and the second antenna may be used as sub-antennas in the MIMO system is used for description. In actual production or design, the first antenna and the second antenna may alternatively operate in different operating frequency bands.

As shown in FIG. 85 and FIG. 86, both the first resonance and the second resonance may be generated in the slot CM mode, and both the third resonance and the fourth resonance may be generated in the wire CM mode. Because the slot CM mode/the wire CM mode has high radiation efficiency and total efficiency, when the electronic device 10 is in the folded state or the unfolded state, the antenna has good radiation efficiency and total efficiency in an operating frequency band formed by the first resonance and the second resonance/the third resonance and the fourth resonance.

It should be understood that, in the antenna 200 shown in FIG. 82, the conductive part of the second side frame between the third position and the fourth position is used as the second feed member. Therefore, a radiation environment (for example, a clearance and an electronic element disposed around the radiator) of the second radiator is poor, and an efficiency bandwidth (for example, a bandwidth corresponding to total efficiency>−2 dB) of the second antenna is narrow. However, compared with a case in which no second radiator is disposed, in a case in which the second radiator is disposed, when the electronic device 10 is in the unfolded state, radiation efficiency of the second antenna is improved by 1.5 dB, and total efficiency is improved by 2 dB. When the electronic device 10 is in the folded state, radiation efficiency of the second antenna is improved by 2 dB, and total efficiency is improved by 2 dB.

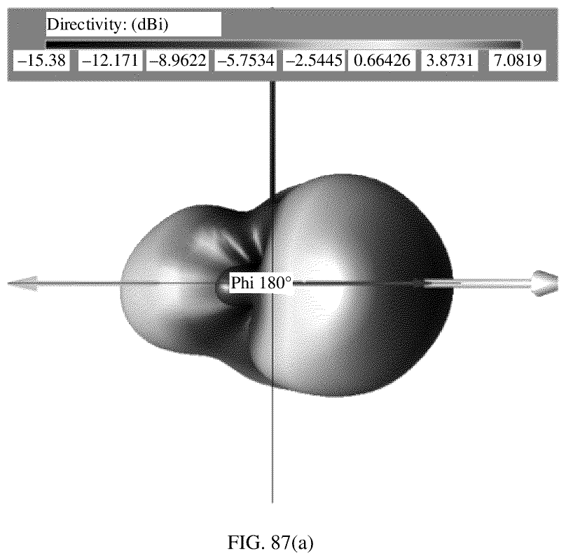

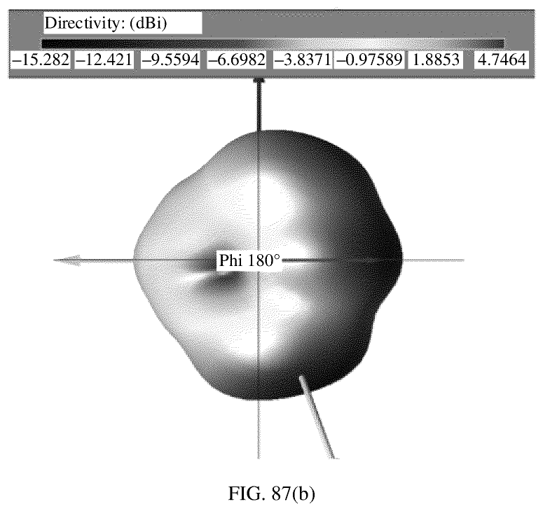

FIG. 87(a) and FIG. 87(b) show a simulation result of a directivity of the antenna 200 when the electronic device 10 shown in FIG. 82 is in the unfolded state.

Herein, FIG. 87(a) shows a simulation result of the second antenna at 2.57 GHz, and a corresponding directivity of 7 dBi in a case in which no second radiator is disposed.

Herein, FIG. 87(b) shows a simulation result of the second antenna at 2.57 GHz, and a corresponding directivity of 4.7 dBi in a case in which the second radiator is disposed. Compared with the case in which no second radiator is disposed, in the case in which the second radiator is disposed, energy radiated by the second antenna is more dispersed and is not concentrated at an angle, so that communication performance of the electronic device is improved.

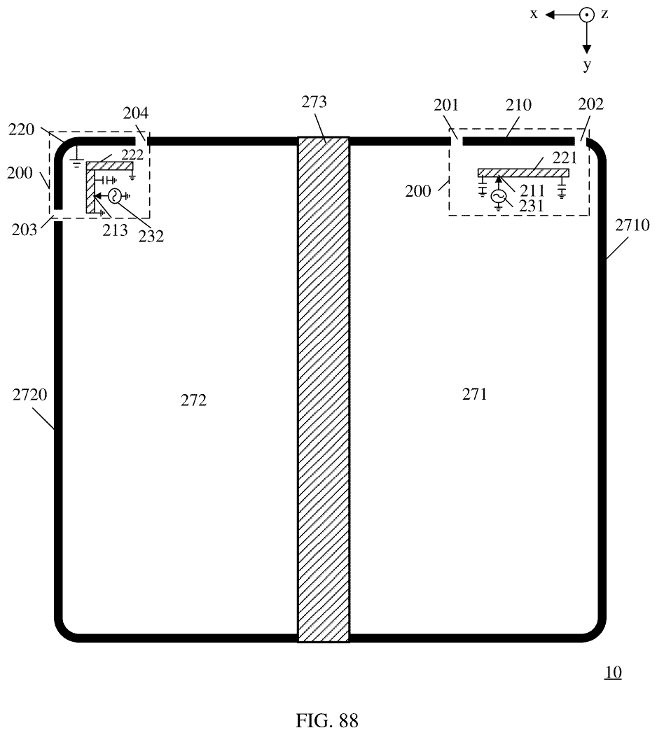

FIG. 88 is a diagram of an electronic device 10 according to an embodiment of this application.

As shown in FIG. 88, a first side frame 2710 is separately provided with a slot at a first position 201 and a second position 202. The second side frame 2720 is separately provided with a slot at a third position 203 and a fourth position 204.

It should be understood that a difference between the electronic device 10 shown in FIG. 88 and the electronic device 10 shown in FIG. 76 and FIG. 82 lies only in that boundary conditions of the first radiator 210 are different.

In the electronic device 10 shown in FIG. 76 and FIG. 82, two ends of the first radiator 210 are ground ends, and the first radiator 210 may form a radiator structure that conforms to a slot antenna. The first radiator 210 may generate a first resonance and a second resonance in a slot CM mode through a first feed circuit 231, and the first resonance and the second resonance are used to jointly support a first operating frequency band of the electronic device 10.

However, in the electronic device 10 shown in FIG. 88, two ends of the first radiator 210 are open ends, and the first radiator 210 may form a radiator structure that conforms to a wire antenna. The first radiator 210 may generate a first resonance and a second resonance in a wire DM mode through a first feed circuit 231, and the first resonance and the second resonance are used to jointly support a first operating frequency band of the electronic device 10.

Because there is good isolation between the wire DM mode and the wire CM mode, mutual interference between the first antenna and the second antenna is small. In an embodiment, the first operating frequency band and the second operating frequency band may be the same or adjacent. In an embodiment, the first antenna and the second antenna may be used as sub-antennas in a MIMO system, to improve communication performance of the electronic device. In an embodiment, the first operating frequency band and the second operating frequency band may be different.

For brevity of description, in the antenna 200 shown in FIG. 88, only an example in which two ends of the first radiator 210 are open ends and two ends of the second radiator 220 are open ends is used for description. In actual production or design, two ends of the first radiator 210 shown in FIG. 88 may alternatively be ground ends, and two ends of the second radiator 220 may alternatively be ground ends. For brevity of description, details are not described again.

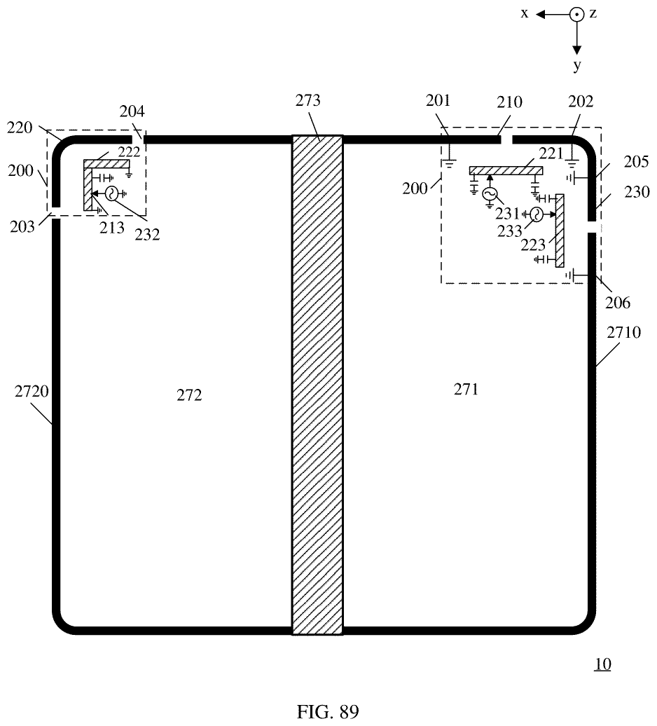

FIG. 89 is a diagram of an electronic device 10 according to an embodiment of this application.

It should be understood that, in the foregoing embodiment, an example in which the antenna 200 includes the first antenna and the second antenna is merely used for description. In actual production or design, the antenna 200 may further include a third antenna including a third radiator 230.

As shown in FIG. 89, a first side frame 2710 further includes a fifth position 205 and a sixth position 206. The first side frame 2710 is coupled to a ground plane at the fifth position 205 and the sixth position 206. A first position 201, a second position 202, the fifth position 205, and the sixth position 206 are sequentially disposed on the first side frame 2710.

The first side frame 2710 is provided with a fourth slot between the fifth position 205 and the sixth position 206. In an embodiment, the fourth slot is located in a central area between the fifth position 205 and the sixth position 206. In an embodiment, when the electronic device 10 is in a folded state, a third slot, the fourth slot, a first slot, and a second slot are aligned.

The antenna 200 further includes the third radiator 230, a third feed member 223, and a third feed circuit 233.

The third radiator 230 is a conductor part between the fifth position 205 and the sixth position 206. The third radiator 230 and the third feed member 223 are spaced from each other, and the third radiator 230 and the third feed member 223 at least partially overlap in a fourth direction. The fourth direction is perpendicular to an extension direction (for example, an x direction) of the third radiator 230. The extension direction of the third radiator 230 is the same as an extension direction of the third feed member 223.

An extension direction of the first radiator 210 is perpendicular to the extension direction of the third radiator 230. The fourth direction is perpendicular to a first direction. In an embodiment, the fourth direction and a second direction may be the same or different. In an embodiment, the extension direction of the third feed member 223 is perpendicular to an extension direction of the first feed member 221.

A ratio of a length of the first radiator 210 in the extension direction (for example, the fourth direction) of the first radiator 210 to a length of the first radiator 210 is greater than or equal to three quarters. A ratio of a length of the third radiator 230 in the extension direction (for example, the first direction) of the third radiator 230 to a length of the third radiator 210 is greater than or equal to three quarters.

The third feed member 223 includes a third feed point, and the third feed circuit 233 is coupled to the third feed point 211.

A first end and a second end of the third feed member 223 are open ends.

It should be understood that the first radiator 210 may form a radiator structure that conforms to a slot antenna. The first radiator 210 may generate a first resonance and a second resonance in a slot CM mode through the first feed circuit 231, and the first resonance and the second resonance are used to jointly support a first operating frequency band of the electronic device 10.

The second radiator 220 may form a radiator structure that conforms to a wire antenna. The second radiator 220 may generate a third resonance and a fourth resonance in a wire CM mode through the second feed element 232, and the third resonance and the fourth resonance are used to jointly support a second operating frequency band of the electronic device 10.

The third radiator 230 may form a radiator structure that conforms to a slot antenna. The third radiator 230 may generate a seventh resonance and an eighth resonance in the slot CM mode through the third feed element 233, and the seventh resonance and the eighth resonance are used to jointly support a third operating frequency band of the electronic device 10.

Because there is good isolation between the slot CM mode and the wire CM mode, mutual interference between the first antenna and the second antenna, and mutual interference between the third antenna and the second antenna are small. In addition, because the extension direction of the first radiator 210 is perpendicular to the extension direction of the third radiator 230, the first radiator 210 and the third radiator 230 are orthogonal in space. Therefore, a resonance generated by the first radiator 210 in the slot CM mode is orthogonal to a resonance generated by the third radiator 230 in the slot CM mode. Mutual interference between the first antenna and the third antenna is small.

In an embodiment, because there is good isolation between the first antenna and the third antenna, the electronic device 10 may include only the first antenna and the third antenna. In an embodiment, the electronic device 10 may include only one housing. Alternatively, the electronic device 10 may include a plurality of housings, and the first antenna and the third antenna may be disposed on a same housing.

In an embodiment, the first operating frequency band, the second operating frequency band, and the third operating frequency band may be the same or adjacent. In an embodiment, the first antenna, the second antenna, and the third antenna may be used as sub-antennas in a MIMO system, to improve communication performance of the electronic device. In an embodiment, the first operating frequency band, the second operating frequency band, and the third operating frequency band may be different.

In an embodiment, the first antenna and the third antenna may be any antenna 200 described in FIG. 9 to FIG. 40, and the second antenna may be any antenna 200 described in FIG. 52 to FIG. 60, and may be selected based on actual production or design. For brevity of description, similar parts between the antenna 200 shown in FIG. 89 and the antenna 200 shown in the foregoing embodiments are not described one by one again. For example, the similar parts include: a position relationship between the radiator and the corresponding feed member; a width of a slot provided in a side frame; a shape of the feed member, for example, a bar shape; a position at which the feed member is disposed; an operating frequency band formed by two resonances; and the like.

In addition, for brevity of description, in the antenna 200 shown in FIG. 89, only an example in which both the first end and the second end of each of the first feed member 221 and third feed member 223 are open ends, and both the first end and the second end of the second feed member 222 are ground ends is used for description. In actual production or design, for the first feed member 221, the second feed member 222, and the third feed member 223 shown in FIG. 89, refer to the foregoing embodiments. The first end and the second end may alternatively be an open end and a ground end, respectively.

In an embodiment, a length of the first radiator 210, a length of the second radiator 220, and a length of the third radiator 230 are approximately the same (a difference is within 10%).

In an embodiment, a proportion of a length of an overlapping part between the second radiator 220 and a projection of the first radiator 210 on the second side frame 2720 to a length of the second radiator 220 is greater than or equal to 30%. In an embodiment, a proportion of a length of an overlapping part between the second radiator 220 and a projection of the third radiator 230 on the second side frame 2720 to a length of the second radiator 220 is greater than or equal to 30%.

In an embodiment, the second position 202 coincides (is the same as) the fifth position 205. A ground structure between the second position 202 and the ground plane may be used to improve isolation between the first antenna and the third antenna. In an embodiment, the ground plane may be electrically connected through a ground member (for example, a spring or a connecting rib) at the second position 202. As a width of a joint between the ground member and the first side frame 2710 increases, isolation between the first antenna and the third antenna increases. In an embodiment, the second position 202 is electrically connected to the ground plane through a spring (a width of a joint between the ground member and the first side frame 2710 is approximately 1 mm), and isolation between the first antenna and the third antenna is approximately 10 dB. In an embodiment, the second position 202 is electrically connected to the ground plane through a connecting rib (a width of a joint between the ground member and the first side frame 2710 is greater than or equal to 3 mm), and isolation between the first antenna and the third antenna is greater than 13 dB.

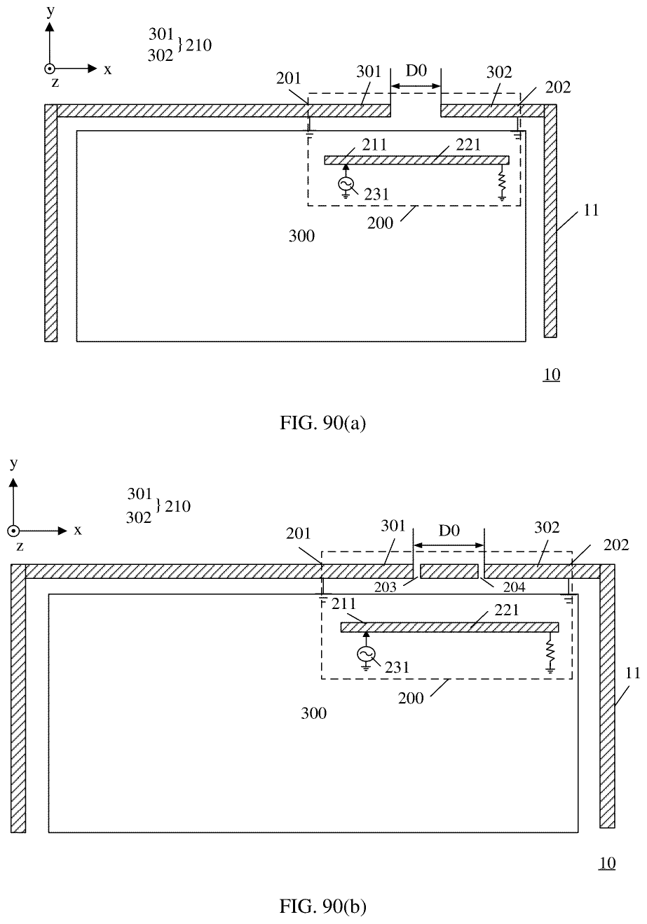

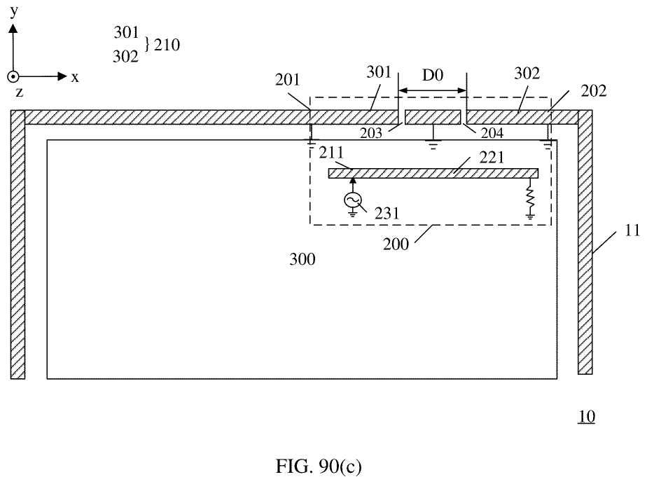

FIG. 90(a) to FIG. 90(c) are a diagram of an electronic device 10 according to an embodiment of this application.

As shown in FIG. 90(c), a side frame 11 is coupled to a ground plane 300 at a first position 201 and a second position 202. The side frame 11 is provided with a slot (for example, a distance between conductors on two sides of the slot is greater than or equal to 5 mm) between the first position 201 and the second position 202. A radiator 210 is a conductive part of the side frame 11 between the first position 201 and the second position 202.

The radiator 210 is divided into a first part 301 and a second part 302 by a slot. The first part 301 and a feed member 221 at least partially overlap in a first direction, and the second part 302 and the feed member 221 at partially overlap in the first direction. The first direction is perpendicular to an extension direction (for example, a y direction) of the radiator 210.

In an embodiment, a minimum distance Do between the first part 301 and the second part 302 is less than or equal to a length of the first part 301. In an embodiment, a minimum distance Do between the first part 301 and the second part 302 is less than or equal to a length of the second part 302. In an embodiment, a minimum distance Do between the first part 301 and the second part 302 is less than or equal to a half of a sum of a length of the first part 301 and a length of the second part 302.

It should be understood that, in the foregoing embodiment, an example in which the radiator is a continuous conductor part is merely used for description. In actual production or design, the radiator may alternatively be a discontinuous conductor part.

In an embodiment, the side frame 11 may further include a third position 203 and a fourth position 204. The third position 203 and the fourth position 204 are located between the first position 201 and the second position 202. The first position 201, the third position 203, the fourth position 204, and the second position 202 are sequentially arranged. The side frame 11 is separately provided with a slot at the third position 203 and the fourth position 204, as shown in FIG. 90(b).

In an embodiment, the first part 301 is a conductive part of the side frame 11 between the first position 201 and the third position 203. The second part 302 is a conductive part of the side frame 11 between the fourth position 204 and the second position 202. The radiator 210 includes the first part 301 and the second part 302.

In an embodiment, the conductive part between the third position 203 and the fourth position 204 may be a floating stub (excluding a ground point), as shown in FIG. 90(b). In an embodiment, the conductive part between the third position 203 and the fourth position 204 may alternatively include a ground point, as shown in FIG. 90(c).

In an embodiment, the antenna 200 may further include an inductor. The inductor may be connected between the feed member 221 and the ground plane 300. The inductor may be configured to increase a physical length of the feed member 221 when an electrical length of the feed member 221 remains unchanged, so that when the minimum distance Do between the first part 301 and the second part 302 is large, the feed member 221 still at least partially overlaps the first part 301 and the second part 302 in the first direction.

It should be understood that, in the electronic device 10 shown in FIG. 90(a) to FIG. 90(c), the antenna 200 may be any antenna 200 described in FIG. 9 to FIG. 40. For brevity of description, details are not described again.

Similarly, in the electronic device 10 shown in FIG. 90(a) to FIG. 90(c), or an antenna obtained by combining any plurality of antenna structures in FIG. 9 to FIG. 40, the second antenna may be any antenna 200 described in FIG. 52 to FIG. 60.

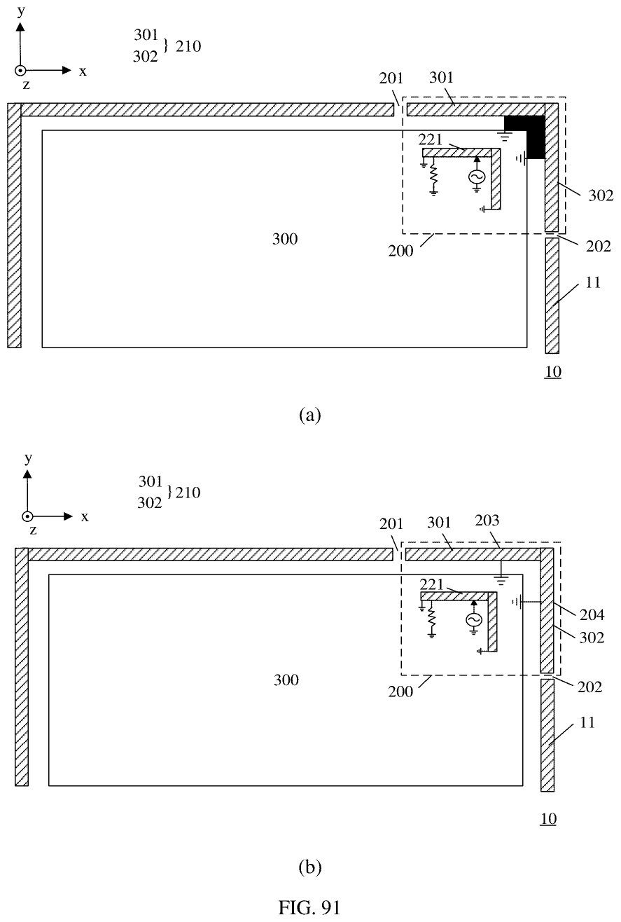

In an embodiment, when the side frame 11 is separately provided with a slot at the first position 201 and the second position 202, the first position 201 and the second position 202 may be coupled to the ground plane 300 through the ground point. The ground point may divide the radiator 210 into the first part 301 and the second part 302, as shown in FIG. 91.

In an embodiment, a minimum distance between the first part 301 and the second part 302 is less than or equal to a length of the first part 301. In an embodiment, a minimum distance between the first part 301 and the second part 302 is less than or equal to a length of the second part 302. In an embodiment, a minimum distance between the first part 301 and the second part 302 is less than or equal to a half of a sum of a length of the first part 301 and a length of the second part 302.

In an embodiment, when the radiator 210 is coupled to the ground plane 300 through a ground connecting rib at the ground point, a width of the ground connecting rib may be less than or equal to the length of the first part 301, or less than or equal to the length of the second part 302, or less than or equal to a half of the sum of the length of the first part 301 and the length of the second part 302, as shown in (a) in FIG. 91.

In an embodiment, there may be a plurality of ground points, as shown in (b) in FIG. 91. For example, the side frame 11 may include the third position 203 and the fourth position 204, and the third position 203 and the fourth position 204 are located between the first position 201 and the second position 202. The side frame 11 is coupled to the ground plane 300 at the third position 203 and the fourth position 204. The third position 203 and the fourth position 204 may be used as the foregoing ground points.

In an embodiment, a width of the ground point may be understood as a distance between two ground points that are farthest from each other in the plurality of ground points.

In an embodiment, a width of the ground point may be less than or equal to the length of the first part 301, or less than or equal to the length of the second part 302, or less than or equal to a half of the sum of the length of the first part 301 and the length of the second part 302, as shown in (b) in FIG. 91.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An antenna structure, comprising:
a ground plane;
a side frame, wherein at least a part of the side frame and the ground plane are spaced from each other, the side frame comprises a first position and a second position, the side frame is coupled to the ground plane at the first position and the second position, a first slot extends in the side frame between the first position and the second position, and the first slot is located in a central area between the first position and the second position;
a radiator, wherein the radiator is a conductive part of the side frame between the first position and the second position;
a first feed member, wherein a first end of the first feed member is an open end, the radiator and the first feed member are spaced from each other, the radiator and the first feed member at least partially overlap in a first direction, the first direction is perpendicular to an extension direction of the radiator, and an extension direction of the first feed member is the same as the extension direction of the radiator; and
a first feed circuit, wherein the first feed member comprises a first feed point, and the first feed circuit is coupled to the first feed point, and wherein:
the first feed member and the radiator are configured to generate a first resonance and a second resonance, and the first resonance and the second resonance are used to jointly support a first operating frequency band; and
the first feed circuit is configured to feed a radio frequency signal on the first operating frequency band into the first feed member.

2. The antenna structure according to claim 1, wherein:
at a resonance point of the first resonance, currents on the radiator are co-directional; and
at a resonance point of the second resonance, the currents on the radiator are co-directional.

3. The antenna structure according to claim 1, wherein:
at a resonance point of the first resonance, currents on the first feed member are co-directional; and
at a resonance point of the second resonance, the currents on the first feed member are co-directional.

4. The antenna structure according to claim 1, wherein:
a second end of the first feed member is an open end, and the second end of the first feed member is spaced from the ground plane or is coupled to the ground plane through a capacitive component; and
a proportion of a length of an overlapping part between the radiator and a projection of the first feed member on the side frame to a length of the radiator is greater than or equal to 25%.

5. The antenna structure according to claim 1, wherein:
a second end of the first feed member is an open end, and the second end of the first feed member is spaced from the ground plane or is coupled to the ground plane through a capacitive component; and
a physical length L1 of the radiator and a physical length L2 of the first feed member satisfy: L1×50%≤L2≤L1.

6. The antenna structure according to claim 1, wherein:
a second end of the first feed member is an open end, and the second end of the first feed member is spaced from the ground plane or is coupled to the ground plane through a capacitive component; and
a distance between a center of the first feed member and a projection of the first slot on the first feed member is less than or equal to a quarter of a length of the first feed member.

7. The antenna structure according to claim 1, wherein the first feed member further comprises a ground point, the ground point is coupled to the ground plane, and lengths of first feed member on two sides of the ground point are different.

8. The antenna structure according to claim 1, wherein:
a second end of the first feed member is a ground end, and the second end of the first feed member is directly electrically connected to the ground plane or is grounded through an inductive component; and
a proportion of a length of an overlapping part between the radiator and a projection of the first feed member on the side frame to a length of the first feed member is greater than or equal to 50%.

9. The antenna structure according to claim 1, wherein:
a second end of the first feed member is a ground end, and the second end of the first feed member is directly electrically connected to the ground plane or is grounded through an inductive component; and
a physical length L1 of the radiator and a physical length L2 of the first feed member satisfy: L1×25%≤L2≤L1×50%.

10. The antenna structure according to claim 1, wherein:
a second end of the first feed member is a ground end, and the first feed member is directly connected to the ground plane electrically at a ground point or is grounded through an inductive component; and
a distance between the first slot and a projection of the ground point on the radiator is less than or equal to a half of a length of the first feed member.

11. The antenna structure according to claim 1, wherein a distance D between the first feed member and the radiator is less than or equal to 5 mm.

12. The antenna structure according to claim 1, wherein a frequency difference between a resonance point frequency of the first resonance and a resonance point frequency of the second resonance is within a range of 5% to 20% of a first frequency, and the first frequency is the resonance point frequency of the first resonance or the resonance point frequency of the second resonance.

13. The antenna structure according to claim 1, wherein:
based on a resonance point frequency of the first resonance or a resonance point frequency of the second resonance being less than or equal to 1 GHz, a frequency difference between the resonance point frequency of the first resonance and the resonance point frequency of the second resonance is greater than or equal to 50 MHz and less than or equal to 160 MHz; or
based on a resonance point frequency of the first resonance or a resonance point frequency of the second resonance being greater than 1 GHz and less than or equal to 2 GHz, a frequency difference between the resonance point frequency of the first resonance and the resonance point frequency of the second resonance is greater than or equal to 120 MHz and less than or equal to 300 MHz; or
based on a resonance point frequency of the first resonance or a resonance point frequency of the second resonance being greater than 2 GHz and less than or equal to 3 GHz, a frequency difference between the resonance point frequency of the first resonance and the resonance point frequency of the second resonance is greater than or equal to 160 MHz and less than or equal to 500 MHz.

14. An antenna structure, comprising:
a ground plane;
a side frame, wherein at least a part of the side frame and the ground plane are spaced from each other, the side frame comprises a ground point, a first position, and a second position, a first slot and a second slot extent in the side frame respectively at the first position and the second position, the ground point is located in a central area between the first position and the second position, and the side frame is coupled to the ground plane at the ground point;
a radiator, wherein the radiator is a conductive part of the side frame between the first position and the second position;
a first feed member, wherein a first end of the first feed member is a ground end, the radiator and the first feed member are spaced from each other, the radiator and the first feed member at least partially overlap in a first direction, the first direction is perpendicular to an extension direction of the radiator, and an extension direction of the first feed member is the same as the extension direction of the radiator; and
a first feed circuit, wherein the first feed member comprises a first feed point, and the first feed circuit is coupled to the first feed point, and wherein:
the first feed member and the radiator are configured to generate a first resonance and a second resonance, and the first resonance and the second resonance are used to jointly support a first operating frequency band; and
the first feed circuit is configured to feed a radio frequency signal on the first operating frequency band into the first feed member.

15. The antenna structure according to claim 14, wherein:
at a resonance point of the first resonance, currents on radiators on two sides of the ground point are reverse in direction; and
at a resonance point of the second resonance, the currents on the radiators on the two sides of the ground point are reverse in direction.

16. The antenna structure according to claim 15, wherein:
at a resonance point of the first resonance, currents on two sides of a center of the first feed member are reverse in direction; and
at a resonance point of the second resonance, the currents on the two sides of the center of the first feed member are reverse in direction.

17. The antenna structure according to claim 14, wherein:
a second end of the first feed member is an open end;
the second end of the first feed member is spaced from the ground plane or coupled to the ground plane through a capacitive component; and
a proportion of a length of an overlapping part between the radiator and a projection of the first feed member on the side frame to a length of the first feed member is greater than or equal to 50%.

18. The antenna structure according to claim 14, wherein:
a second end of the first feed member is an open end, and the second end of the first feed member is spaced from the ground plane or is coupled to the ground plane through a capacitive component; and
a physical length L1 of the radiator and a physical length L2 of the first feed member satisfy: L1×25%≤L2≤L1×50%.

19. The antenna structure according to claim 14, wherein:
a second end of the first feed member is an open end, and the second end of the first feed member is spaced from the ground plane or is coupled to the ground plane through a capacitive component; and
a distance between the ground point and a projection of the second end of the first feed member on the radiator is less than or equal to a quarter of a length of the radiator.

20. An antenna structure, comprising:
a ground plane;
a side frame, wherein at least a part of the side frame and the ground plane are spaced from each other, the side frame comprises a first position and a second position, a first slot extends in the side frame at the first position, and the side frame is coupled to the ground plane at the second position;
a radiator, wherein the radiator comprises a conductive part of the side frame between the first position and the second position;
a feed member, wherein a first end of the feed member is an open end, a second end of the feed member is a ground end, the radiator and the feed member are spaced from each other, the radiator and the feed member at least partially overlap in a first direction, the direction is perpendicular to an extension direction of the radiator, and an extension direction of the feed member is the same as the extension direction of the radiator; and
a feed circuit and a first capacitive component, wherein the feed member comprises a feed point, the first capacitive component is coupled between the feed circuit and the feed point, and a capacitance value of the first capacitive component is less than or equal to 1.5 pF, and wherein:
the feed member and the radiator are configured to generate a first resonance and a second resonance, and the first resonance and the second resonance are used to jointly support a first operating frequency band; and
the feed circuit is configured to feed a radio frequency signal on the first operating frequency band into the feed member.

21. The antenna structure according to claim 20, wherein
a physical length L1 of the radiator and a physical length L2 of the feed member satisfy:
L1×50%≤L2≤L1.

22. The antenna structure according to claim 20, wherein
the first end of the feed member is coupled to the ground plane through a second capacitive component; and
wherein:
when a center frequency of the first operating frequency band is less than or equal to 1 GHz, a capacitance value of the second capacitive component is less than or equal to 10 pF; or
when a center frequency of the first operating frequency band is greater than 1 GHz and less than or equal to 2 GHz, a capacitance value of the second capacitive component is less than or equal to 5 pF; or
when a center frequency of the first operating frequency band is greater than 2 GHz and less than or equal to 3 GHz, a capacitance value of the second capacitive component is less than or equal to 3 pF; or
when a center frequency of the first operating frequency band is greater than 3 GHz, a capacitance value of the second capacitive component is less than or equal to 2 pF.

23. The antenna structure according to claim 20, wherein:
the first end of the feed member is coupled to the ground plane through a second capacitive component; and
a proportion of a length of an overlapping part between the radiator and a projection of the feed member on the side frame to a length of the radiator is greater than or equal to 25%, and less than or equal to 75%.
